(19) United States
(12) Patent Application Publication
(10) Pub. No.: US 2025/0008494 A1
(43) Pub. Date: Jan. 2, 2025

(54) METHOD AND APPARATUS FOR MULTIPLEXING CHANNEL STATE INFORMATION FOR FULL DUPLEX IN WIRELESS COMMUNICATION SYSTEMS

(71) Applicant: SAMSUNG ELECTRONICS CO., LTD., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR); Hyemin CHOI, Suwon-si (KR)

(21) Appl. No.: 18/755,480

(22) Filed: Jun. 26, 2024

(30) Foreign Application Priority Data
Jun. 26, 2023 (KR) 10-2023-0082173

(51) Int. Cl. H04W 72/0446; H04B 7/06; H04L 1/18; H04L 5/00

(52) U.S. Cl. CPC H04W 72/0446; H04B 7/0626; H04L 5/0007; H04L 1/18

(57) ABSTRACT

The disclosure relates to 5G or 6G communication systems to support higher data rates. The disclosure relates to operations of a UE and a base station in a wireless communication system, and specifically, the disclosure proposes a method and device for transmitting and receiving channel state information in a full-duplex communication system.

### CROSS-REFERENCE TO RELATED APPLICATION

This application is based on and claims priority under 35 U.S.C. § 119 to Korean Patent Application No. 10-2023-0082173, filed on Jun. 26, 2023, in the Korean Intellectual Property Office, the disclosure of which is herein incorporated by reference in its entirety.

### BACKGROUND

### 1. Field

The disclosure relates to operations of a terminal and a base station in a wireless communication system. Specifically, the disclosure relates to a method for multiplexing channel state information for full duplex communication in a wireless communication system, and an apparatus capable of performing the method.

### 2. Description of Related Art

5^{th} generation (5G) mobile communication technologies define broad frequency bands to provide higher transmission rates and new services, and can be implemented in “Sub 6 GHz” bands such as 3.5 GHz, and also in “above 6 GHz” bands, which may be referred to as mmWave bands including 28 GHz and 39 GHz. In addition, the implementation of 6^{th} generation 6G mobile communication technologies (e.g., beyond 5G systems) in terahertz bands (e.g., 95 GHz to 3 THz bands) has been proposed in order to achieve transmission rates fifty times faster than 5G mobile communication technologies and ultra-low latencies one-tenth of 5G mobile communication technologies.

Since the beginning of the development of 5G mobile communication technologies, in order to support various services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio (NR)-Unlicensed (U) aimed at system operations conforming to various regulation-related requirements in unlicensed bands, NR UE power saving, non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also full-duplex technologies for increasing frequency efficiency of 6G mobile communication technologies and improving system networks, AI-based communication technologies for implementing system optimization by utilizing satellites and AI from the design stage and internalizing end-to-end AI support functions, and next-generation distributed computing technologies for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An embodiment disclosed herein is to provide an apparatus and a method capable of effectively providing a service in a mobile communication system. Specifically, an embodiment is to provide a method and an apparatus capable of effectively reporting a channel state in a full duplex communication system.

In accordance with an aspect of the disclosure, a method performed by a terminal in a communication system is provided. The method includes receiving, from a base station, uplink subband configuration information including resource information indicating uplink resources in a downlink slot; receiving, from the base station, physical uplink shared channel (PUSCH) configuration information including information on a PUSCH repetition; receiving, from the base station, downlink control information (DCI) for scheduling the PUSCH repetition, the DCI including aperiodic channel state information (CSI) request indicator; identifying two PUSCH repetitions for multiplexing aperiodic CSI; and transmitting, to the base station, uplink data multiplexed with the aperiodic CSI on the two PUSCH repetitions on at least one of the uplink resources in the downlink slot or an uplink slot.

In accordance with another aspect of the disclosure, a method performed by a base station in a communication system is provided. The method includes transmitting, to a terminal, uplink subband configuration information including resource information indicating uplink resources in a downlink slot; transmitting, to the terminal, physical uplink shared channel (PUSCH) configuration information including information on a PUSCH repetition; transmitting, to the terminal, downlink control information (DCI) for scheduling the PUSCH repetition, the DCI including aperiodic channel state information (CSI) request indicator; and receiving, from the terminal, uplink data multiplexed with aperiodic CSI on two PUSCH repetitions on at least one of the uplink resources in the downlink slot or an uplink slot.

In accordance with another aspect of the disclosure, a terminal in a communication system is provided. The terminal includes transceivers; and a controller, including processors, configured to receive, from a base station, uplink subband configuration information including resource information indicating uplink resources in a downlink slot, receive, from the base station, physical uplink shared channel (PUSCH) configuration information including information on a PUSCH repetition, receive, from the base station, downlink control information (DCI) for scheduling the PUSCH repetition, the DCI including aperiodic channel state information (CSI) request indicator, identify two PUSCH repetitions for multiplexing aperiodic CSI, and transmit, to the base station, uplink data multiplexed with the aperiodic CSI on the two PUSCH repetitions on at least one of the uplink resources in the downlink slot or an uplink slot.

In accordance with another aspect of the disclosure, a base station in a communication system is provided. The base station includes transceivers; and a controller, including processors, configured to transmit, to a terminal, uplink subband configuration information including resource information indicating uplink resources in a downlink slot, transmit, to the terminal, physical uplink shared channel (PUSCH) configuration information including information on a PUSCH repetition, transmit, to the terminal, downlink control information (DCI) for scheduling the PUSCH repetition, the DCI including aperiodic channel state information (CSI) request indicator, and receive, from the terminal, uplink data multiplexed with aperiodic CSI on two PUSCH repetitions on at least one of the uplink resources in the downlink slot or an uplink slot.

An embodiment disclosed herein provides an apparatus and a method capable of effectively providing a service in a mobile communication system. Specifically, an embodiment provides a method and an apparatus capable of effectively reporting a channel state in a full duplex communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of bandwidth part configuration in a wireless communication system according to an embodiment of the disclosure;

FIG. 4 illustrates an example of a non-periodic CSI reporting method;

FIG. 5 illustrates an example of control resource set configuration of a downlink control channel in a wireless communication system;

FIG. 6 illustrates a structure of a downlink control channel in a wireless communication system according to an embodiment of the disclosure;

FIG. 7 illustrates an example of frequency domain resource allocation with regard to a PDSCH or PUSCH in a wireless communication system;

FIG. 8 illustrates an example of time domain resource allocation with regard to a PDSCH in a wireless communication system;

FIG. 9 illustrates an example of a method for determining an available slot at the time of transmission according to PUSCH repetition type A by a UE in a 5G system;

FIG. 10 illustrates an example of PUSCH repetitive transmission type B in a wireless communication system according to an embodiment of the disclosure;

FIG. 11 illustrates an uplink-downlink resource configuration of an XDD system in which resources of uplink and downlink are flexibly divided in the time domain and frequency domain, according to an embodiment of the disclosure;

FIG. 12 illustrates an example of an uplink-downlink resource configuration in a full duplex communication system in which uplink and downlink resources are flexibly divided in the time domain and frequency domain;

FIG. 13 illustrates an example of a transmission/reception structure for a duplex method according to an embodiment of the disclosure;

FIG. 14 is a graph for describing an example of downlink and uplink resource configurations in an XDD system;

FIG. 15 illustrates an example of SBFD being operated in the TDD band of a wireless communication system to which the disclosure is applied;

FIG. 16 illustrates an example of SBFD configuration according to an embodiment of the disclosure;

FIG. 17 illustrates an operation of a UE according to an embodiment of the disclosure; and

FIG. 18 illustrates an operation of a base station according to an embodiment of the disclosure.

FIG. 19 illustrates a structure of a UE in a wireless communication system according to an embodiment of the disclosure; and

FIG. 20 illustrates a structure of a base station in a wireless communication system according to an embodiment of the disclosure.

### DETAILED DESCRIPTION

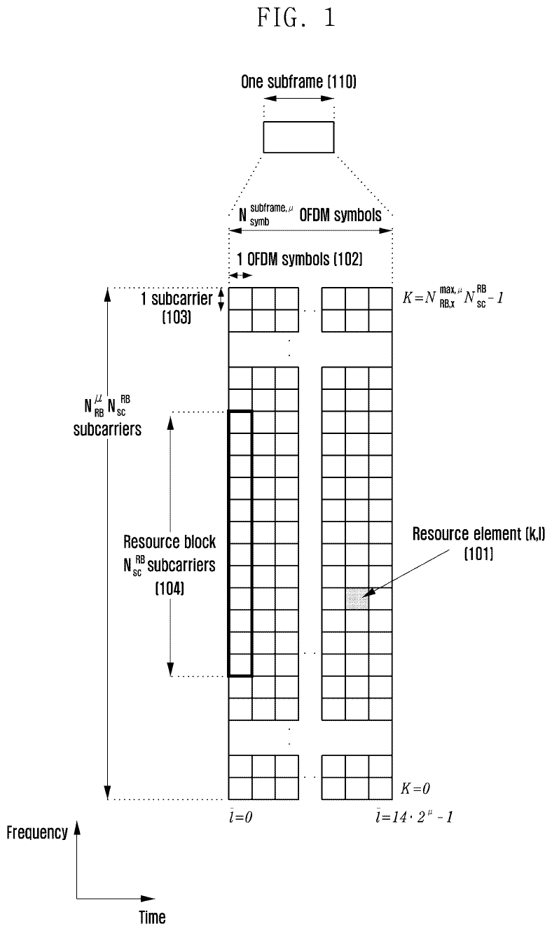

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink and employs a single carrier frequency division multiple access (SC-FDMA) scheme in an uplink. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

Hereinafter, a time-frequency domain resource and a frame structure of a 5G system will be described in more detail with reference to the accompanying drawings.

FIG. 1 illustrates a basic structure of a time-frequency domain, which is a radio resource domain used to transmit data or control channels, in a 5G system.

The horizontal axis in FIG. 1 represents a time domain, and the vertical axis in FIG. 1 represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

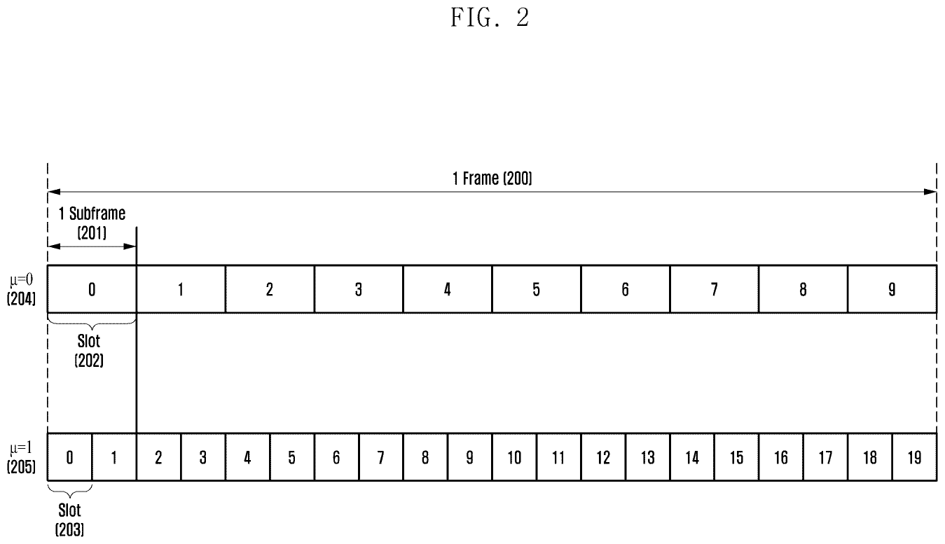

FIG. 2 illustrates a structure of a frame, a subframe, and a slot in a wireless communication system.

FIG. 2 illustrates an example of a structure of a frame 200, a subframe 201, and a slot 202. One frame 200 may be defined as 10 ms. One subframe 201 may be defined as 1 millisecond (ms), and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values 204 or 205 for the subcarrier spacing. The example of FIG. 2 shows the case of =0 (204) and the case of =1 (205) as a configuration value for a subcarrier spacing. In the case of =0 (204), one subframe 201 may include one slot 202, and in the case of =1 (205), one subframe 201 may include two slots 203. That is, the number of slots per one subframe Nₛₗₒₜ^{subframe,μ} may differ depending on the subcarrier spacing configuration value p, and the number of slots per one frame Nₛₗₒₜ^{frame,μ}, may differ accordingly. Nₛₗₒₜ^{sunframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Hereinafter, bandwidth part (BWP) configuration in a 5G communication system will be described in detail with reference to the accompanying drawings.

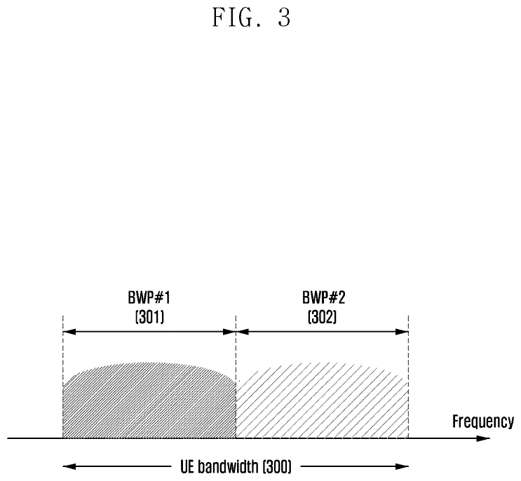

FIG. 3 illustrates an example of bandwidth part configuration in a wireless communication system.

FIG. 3 illustrates an example in which a UE bandwidth 300 is configured to include two bandwidth parts, that is, bandwidth part #1 (BWP #1) 301 and bandwidth part #2 (BWP #2) 302. Abase station may configure one or multiple bandwidth parts for a UE, and may configure the following pieces of information with regard to each bandwidth part as given in Table 2 below.

TABLE 2

| | |
|---|---|
| BWP ::= | SEQUENCE { |

| | |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, n3, n4, n5}, |
| (subcarrier spacing) | |
| cyclicPrefix | ENUMERATED { extended } |
| (cyclic prefix) | |
| } | |

Of course, the information configured for the UE is not limited to the above example, and in addition to the configuration information in Table 2, various parameters related to the bandwidth part may be configured for the UE. The base station may transfer the configuration information to the UE through higher layer signaling, for example, radio resource control (RRC) signaling. One configured bandwidth part or at least one bandwidth part among multiple configured bandwidth parts may be activated. Whether or not to activate a configured bandwidth part may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

The bandwidth part-related configuration supported by the 5G system may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

Hereinafter, BWP change will be described. If a UE has one or more bandwidth parts configured therefor, the base station may indicate, to the UE, to change (or switch or transition) the bandwidth parts by using a bandwidth part indicator field inside DCI. For example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside the received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (TBWP) required during a bandwidth part change are specified in standards, and may be defined as given in Table 3 below, for example.

TABLE 3

| | NR Slot | BWP switch delay T_{BWP} (slots) | |
|---|---|---|---|
| μ | length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
^{Note 2}
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+TBWP, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (TBWP).

If the UE has received DCI (for example, DCI format 11 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

Hereinafter, a channel state information (CSI) resource configuration is described.

In NR, a base station has a CSI framework for indicating CSI measurement and report of a UE. A CSI framework of the NR may be configured by at least two elements including resource setting and report setting, wherein the report setting refers to at least one ID of the resource setting and thus they have correlation.

According to an embodiment of the disclosure, the resource setting may include information related to a reference signal (RS) for measuring channel state information by the UE. The base station may configure at least one resource setting for the UE. For example, the base station and the UE may exchange signaling information as shown in Table 4 in order to transmit information on the resource setting.

TABLE 4

-- ASN1START
-- TAG-CSI-RESOURCECONFIG-START

| | |
|---|---|
| CSI-ResourceConfig ::= | SEQUENCE { |

| | |
|---|---|
| csi-ResourceConfigId | CSI-ResourceConfigId, |

| | |
|---|---|
| csi-RS-ResourceSetList | CHOICE { |

| | |
|---|---|
| nzp-CSI-RS-SSB | SEQUENCE { |

| | |
|---|---|
| nzp-CSI-RS-ResourceSetList | SEQUENCE (SIZE (1..maxNrofNZP-CSI-RS- |

ResourceSetsPerConfig)) OF NZP-CSI-RS-ResourceSetId

OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId

OPTIONAL -- Need R

},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |

| | |
|---|---|
| resource Type | ENUMERATED { aperiodic, semiPersistent, periodic }, |

...
}
-- TAG-CSI-RESOURCECONFIG-STOP
-- ASN1STOP

In Table 4, signaling information CSI-ResourceConfig includes information on each resource setting. According to the signaling information, each resource setting may include a resource setting index (csi-ResourceConfigId), a BWP index (bwp-ID), a time domain transmission configuration (resourceType) of a resource, or a resource set list (csi-RS-ResourceSetList) including at least one resource set. The time domain transmission configuration of the resource may be configured to be aperiodic transmission, semi-persistent transmission, or periodic transmission. The resource set list may be a set including resource sets for channel measurement or a set including resource sets for interference measurement. When the resource set list is a set including resource sets for channel measurement, each resource set may include at least one resource, and the at least one resource may correspond to an index of a channel state information reference signal (CSI-RS) resource or a synchronization/broadcast channel block (synchronization signal/physical broadcast channel block (SS/PBCH block) or synchronization signal block (SSB)). When the resource set list is a set including resource sets for interference measurement, each resource set may include at least one interference measurement resource (CSI interference measurement (CSI-IM)).

For example, when a resource set includes a CSI-RS, the base station and the UE may exchange signaling information as shown in Table 5 in order to transmit information on the resource set.

TABLE 5

```
-- ASN1START
-- TAG-NZP-CSI-RS-RESOURCESET-START
NZP-CSI-RS-ResourceSet ::=  SEQUENCE {
  nzp-CSI-ResourceSetId  NZP-CSI-RS-ResourceSetId,
  nzp-CSI-RS-Resources  SEQUENCE
  (SIZE (1..maxNrofNZP-CSI-RS-
ResourcesPerSet)) OF NZP-CSI-RS-ResourceId,
  repetition  ENUMERATED { on, off }
OPTIONAL, -- Need S
  aperiodicTriggeringOffset  INTEGER(0..6)
OPTIONAL, -- Need S
  trs-Info  ENUMERATED {true}
OPTIONAL, -- Need R
  ...
}
-- TAG-NZP-CSI-RS-RESOURCESET-STOP
-- ASN1STOP
```

In Table 5, signaling information NZP-CSI-RS-ResourceSet includes information on each resource set. According to the signaling information, each resource set may include at least information on a resource set index (nzp-CSI-ResourceSetId) or an index set (nzp-CSI-RS-Resources) of an included CSI-RS, and may include a part of information (repetition) on a spatial domain transmission filter of the included CSI-RS resource or information (trs-Info) on whether the included CSI-RS resource has a tracking purpose.

The CSI-RS may be the most representative reference signal included in the resource set. The base station and the UE may exchange signaling information as shown in Table 6 in order to transmit information on the CSI-RS resource.

TABLE 6

```
-- ASN1START
-- TAG-NZP-CSI-RS-RESOURCE-START
NZP-CSI-RS-Resource ::=  SEQUENCE {
  nzp-CSI-RS-ResourceId  NZP-CSI-RS-ResourceId,
  resourceMapping  CSI-RS-ResourceMapping,
  powerControlOffset  INTEGER (−8..15),
  powerControlOffsetSS  ENUMERATED{db-3, db0, db3, db6}
OPTIONAL, -- Need R
  scramblingID  ScramblingId,
  periodicityAndOffset  CSI-ResourcePeriodicityAndOffset  OPTIONAL, --
Cond PeriodicOrSemiPersistent
  qcl-InfoPeriodicCSI-RS  TCI-StateId  OPTIONAL, -- Cond
Periodic
  ...
}
-- TAG-NZP-CSI-RS-RESOURCE-STOP
-- ASN1STOP
```

In Table 6, signaling information NZP-CSI-RS-Resource includes information on each CSI-RS. The information included in the signaling information NZP-CSI-RS-Resource may have the following meanings.
nzp-CSI-RS-ResourceId: a CSI-RS resource index
resourceMapping: resource mapping information of a CSI-RS resource
powerControlOffset: a ratio between PDSCH EPRE (Energy Per RE) and CSI-RS EPRE
powerControlOffsetSS: a ratio between SS/PBCH block EPRE and CS-RS EPRE
scramblingID: a scrambling index of a CS-RS sequence
periodicityAndOffset: a transmission period and slot offset of a CSI-RS resource
qcl-InfoPeriodicCSI-RS: TCI-state information when a corresponding CSI-RS is a periodic CSI-RS

The “resourceMapping” included in the signaling information NZP-CSI-RS-Resource may represent resource mapping information of the CSI-RS resource, and may include resource element (RE) mapping for a frequency resource, the number of ports, symbol mapping, CDM type, frequency resource density, and frequency band mapping information. Each of the number of ports, frequency resource density, CDM type, and time-frequency domain RE mapping, which may be configured through the resource mapping information, may have a value determined in one of the rows shown in Table 7 below.

TABLE 7

| | | Den- | | | CDM | | |
|---|---|---|---|---|---|---|---|
| | Ports | sity | | | group | | |
| Row | (X) | (ρ) | cdm-Type | (k̅, l̅) | index (j) | k′ | l′ |
| 1 | 1 | 3 | No CDM | (k₀, l₀), (k₀ + 4, | 0, 0, 0 | 0 | 0 |
| | | | | l₀), (k₀ + 8, l₀) | | | |
| 2 | 1 | 1, 0.5 | No CDM | (k₀, l₀) | 0 | 0 | 0 |
| 3 | 2 | 1, 0.5 | FD-CDM2 | (k₀, l₀) | 0 | 0, 1 | 0 |
| 4 | 4 | 1 | FD-CDM2 | (k₀, l₀), | 0, 1 | 0, 1 | 0 |
| | | | | (k₀ + ₂, l₀) | | | |
| 5 | 4 | 1 | FD-CDM2 | (k₀, l₀), | 0, 1 | 0, 1 | 0 |
| | | | | (k₀, l₀ + 1) | | | |
| 6 | 8 | 1 | FD-CDM2 | (k₀, l₀), (k₁, l₀), | 0, 1, 2, 3 | 0, 1 | 0 |
| | | | | (k₂, l₀), | | | |
| | | | | (k₃, l₀) | | | |
| 7 | 8 | 1 | FD-CDM2 | (k₀, l₀), (k₁, l₀), | 0, 1, 2, 3 | 0, 1 | 0 |
| | | | | (k₀, l₀ + 1), | | | |
| | | | | (k₁, l₀ + 1) | | | |
| 8 | 8 | 1 | CDM4 | (k₀, l₀), (k₁, l₀) | 0,1 | 0, 1 | 0, 1 |
| | | | (FD2, TD2) | | | | |
| 9 | 12 | 1 | FD-CDM2 | (k₀, l₀), (k₁, l₀), | 0, 1, 2, | 0, 1 | 0 |
| | | | | (k₂, l₀), (k₃, l₀), | 3, 4, | | |
| | | | | (k₄, l₀), (k₅, l₀) | 5 | | |
| 10 | 12 | 1 | CDM4 | (k₀, l₀), (k₁, l₀), | 0, 1, 2 | 0, 1 | 0, 1 |
| | | | (FD2,TD2) | (k₂, l₀) | | | |
| 11 | 16 | 1, 0.5 | FD-CDM2 | (k₀, l₀), (k₁, l₀), | 0, 1, 2, | 0, 1 | 0 |
| | | | | (k₂, l₀), (k₃, l₀), | 3, 4, | | |
| | | | | (k₀, l₀ + 1), | 5, 6, 7 | | |
| | | | | (k₁, l₀ + 1), | | | |
| | | | | (k₂, l₀ + 1), | | | |
| | | | | (k₃, l₀ + 1) | | | |
| 12 | 16 | 1, 0.5 | CDM4 | (k₀, l₀), (k₁, l₀), | 0, 1, 2, 3 | 0, 1 | 0, 1 |
| | | | (FD2, TD2) | (k₂, l₀), (k₃, l₀) | | | |
| 13 | 24 | 1, 0.5 | FD-CDM2 | (k₀, l₀), (k₁, l₀), | 0, 1, 2, | 0, 1 | 0 |
| | | | | (k₂, l₀), | 3, 4, | | |
| | | | | (k₀, l₀ + 1), | 5, 6, 7, | | |
| | | | | (k₁, l₀ + 1), | 8, 9, | | |
| | | | | (k₂, l₀ + 1), | 10, 11 | | |
| | | | | (k₀, l₁), | | | |
| | | | | (k₁, l₁), (k₂, l₁), | | | |
| | | | | (k₀, l₁ + 1), | | | |
| | | | | (k₁, l₁ + 1), | | | |
| | | | | (k₂, l₁ + 1) | | | |
| 14 | 24 | 1, 0.5 | CDM4 | (k₀, l₀), (k₁, l₀), | 0, 1, 2, | 0, 1 | 0, 1 |
| | | | (FD2,TD2) | (k₂, l₀), (kg, l₁), | 3, 4, | | |
| | | | | (k₁, l₁), (k₂, l₁) | 5 | | |
| 15 | 24 | 1, 0.5 | CDM8 | (k₀, l₀), (k₁, l₀), | 0, 1, 2 | 0, 1 | 0, 1, |
| | | | (FD2, TD4) | (k₂, l₀) | | | 2, 3 |
| 16 | 32 | 1, 0.5 | FD-CDM2 | (k₀, l₀), (k₁, l₀), | 0, 1, 2, | 0, 1 | 0 |
| | | | | (k₂, l₀), (k₃, l₀), | 3, 4, | | |
| | | | | (k₀, l₀ + 1), | 5, 6, 7, | | |
| | | | | (k₁, l₀ + ₁), | 8, 9, | | |
| | | | | (k₂, l₀ + 1), | 10, 11, | | |
| | | | | (k₃, l₀ + ₁), | 12, 13, | | |
| | | | | (k₀, l₁), | 14, 15 | | |
| | | | | (k₁, l₁), (k₂, l₁), | | | |
| | | | | (k₃,l₁) | | | |
| | | | | (k₀, l₁ + 1), | | | |
| | | | | (k₁, l₁ + 1), | | | |
| | | | | (k₂, l₁ + 1), | | | |
| | | | | (k₃, l₁ + 1) | | | |
| 17 | 32 | 1, 0.5 | CDM4 | (k₀, l₀), (k₁, l₀), | 0, 1, 2, | 0, 1 | 0, 1 |
| | | | (FD2, TD2) | (k₂, l₀), (k₃, l₀), | 3, 4, | | |
| | | | | (k₀, l₁), (k₁, l₁), | 5, 6, 7 | | |
| | | | | (k₂, l₁), (k₃, l₀) | | | |
| 18 | 32 | 1, 0.5 | CDM8 | (k₀, l₀), (k₁, l₀), | 0, 1, 2, 3 | 0, 1 | 0, 1, |
| | | | (FD2, TD4) | (k₂, l₀), (k₃, l₀) | | | 2, 3 |

Table 7 shows a frequency resource density, a CDM type, frequency and time domain starting positions (k̅, l̅) of a CSI-RS component RE pattern, and the number (k′) of frequency domain REs and the number (l′) of time domain REs of a CSI-RS component RE pattern, which are configurable according to the number (X) of CSI-RS ports. The above-described CSI-RS component RE pattern may be a basic unit for configuring a CSI-RS resource. Through Y=1+max(k′) number of frequency domain REs and Z=1+max(l′) number of time domain REs, the CSI-RS component RE pattern may include YZ number of REs. When the number of CSI-RS ports is 1, the position of a CSI-RS RE may be designated in a physical resource block (PRB) without restriction on subcarriers, and may be designated by a bitmap having 12 bits. When the number of CSI-RS ports is {2, 4, 8, 12, 16, 24, 32} and Y=2, the position of a CSI-RS RE may be designated for every two subcarriers in a PRB, and may be designated by a bitmap having 6 bits. When the number of CSI-RS ports is 4 and Y=4, the position of a CSI-RS RE may be designated for every four subcarriers in a PRB, and may be designated by a bitmap having 3 bits. Similarly, the position of a time domain RE may be designated by a bitmap having a total of 14 bits.

Hereinafter, a CSI report configuration is described.

According to an embodiment of the disclosure, report setting refers to at least one ID of resource setting and thus the report setting and resource setting have correlation, and resource setting(s) having correlation with report setting provides configuration information including information on a reference signal for measuring channel information. When the resource setting(s) having correlation with the report setting is used for measuring channel information, the measured channel information may be used for reporting channel information according to a reporting method configured in the report setting having correlation.

According to an embodiment of the disclosure, the report setting may include configuration information related to a CSI reporting method. For example, the base station and the UE may exchange signaling information as shown in Table 8 in order to transmit information on the report setting.

TABLE 8

```
-- ASN1START
-- TAG-CSI-REPORTCONFIG-START
CSI-ReportConfig ::= SEQUENCE {
  reportConfigId  CSI-ReportConfigId,
  carrier  ServCellIndex  OPTIONAL, -- Need S
  resourcesForChannelMeasurement  CSI-ResourceConfigId,
  csi-IM-ResourcesForInterference  CSI-ResourceConfigId  OPTIONAL, -- Need R
  nzp-CSI-RS-ResourcesForInterference CSI-ResourceConfigId  OPTIONAL, --
Need R
  reportConfigType  CHOICE {
    periodic  SEQUENCE {
      reportSlotConfig  CSI-ReportPeriodicityAndOffset,
      pucch-CSI-ResourceList  SEQUENCE (SIZE (1..maxNrofBWPs)) OF
PUCCH-CSI-Resource
    },
    semiPersistentOnPUCCH  SEQUENCE {
      reportSlotConfig  CSI-ReportPeriodicityAndOffset,
      pucch-CSI-ResourceList  SEQUENCE (SIZE (1..maxNrofBWPs)) OF
PUCCH-CSI-Resource
    },
    semiPersistentOnPUSCH  SEQUENCE {
      reportSlotConfig  ENUMERATED {sl5, sl10, sl20, sl40, sl80, sl160,
sl320},
      reportSlotOffsetList  SEQUENCE (SIZE (1..maxNrofUL-Allocations)) OF
INTEGER(0..32),
      p0alpha  P0-PUSCH-AlphaSetId
    },
    aperiodic  SEQUENCE {
      reportSlotOffsetList SEQUENCE (SIZE (1..maxNrofUL-Allocations)) OF
INTEGER(0..32)
    }
  },
  reportQuantity CHOICE {
    none NULL,
    cri-RI-PMI-CQI NULL,
    cri-RI-i1 NULL,
    cri-RI-i1-CQI SEQUENCE {
      pdsch-BundleSizeForCSI ENUMERATED {n2, n4}
OPTIONAL -- Need S
    },
    cri-RI-CQI NULL,
    cri-RSRP  NULL,
    ssb-Index-RSRP  NULL,
    cri-RI-LI-PMI-CQI  NULL
  },
  reportFreqConfiguration  SEQUENCE {
    cqi-FormatIndicator  ENUMERATED { widebandCQI, subbandCQI }
OPTIONAL, -- Need R
    pmi-FormatIndicator  ENUMERATED { widebandPMI, subbandPMI }
OPTIONAL, -- Need R
    csi-ReportingBand  CHOICE {
      subbands3  BIT STRING(SIZE(3)),
      subbands4  BIT STRING(SIZE(4)),
      subbands5  BIT STRING(SIZE(5)),
      subbands6  BIT STRING(SIZE(6)),
      subbands7  BIT STRING(SIZE(7)),
      subbands8  BIT STRING(SIZE(8)),
      subbands9  BIT STRING(SIZE(9)),
      subbands10  BIT STRING(SIZE(10)),
      subbands11  BIT STRING(SIZE(11)),
      subbands12  BIT STRING(SIZE(12)),
      subbands13  BIT STRING(SIZE(13)),
      subbands14  BIT STRING(SIZE(14)),
      subbands15  BIT STRING(SIZE(15)),
      subbands16  BIT STRING(SIZE(16)),
      subbands17  BIT STRING(SIZE(17)),
      subbands18  BIT STRING(SIZE(18)),
      ...,
      subbands19-v1530  BIT STRING(SIZE(19))
    } OPTIONAL -- Need S
  } OPTIONAL, -- Need R
  timeRestrictionForChannelMeasurements  ENUMERATED {configured,
notConfigured},
  timeRestrictionForInterferenceMeasurements  ENUMERATED {configured,
notConfigured},
  codebookConfig  CodebookConfig
OPTIONAL, -- Need R
  dummy  ENUMERATED {n1, n2}
OPTIONAL, -- Need R
  groupBasedBeamReporting  CHOICE {
    enabled NULL,
    disabled  SEQUENCE {
      nrofReportedRS  ENUMERATED {n1, n2, n3, n4}
OPTIONAL -- Need S
    }
  },
  cqi-Table  ENUMERATED {table1, table2, table3, spare1}
OPTIONAL, -- Need R
  subbandSize  ENUMERATED {value1, value2},
  non-PMI-PortIndication SEQUENCE (SIZE (1..maxNrofNZP-CSI-RS-
ResourcesPerConfig)) OF PortIndexFor8Ranks OPTIONAL, -- Need R
  ...,
  [[
  semiPersistentOnPUSCH-v1530 SEQUENCE {
    reportSlotConfig-v1530 ENUMERATED {sl4, sl8, sl16}
  } OPTIONAL -- Need R
  ]]
}
```

In Table 8, signaling information CSI-ReportConfig includes information on each report setting. The information included in the signaling information CSI-ReportConfig may have the following meanings.
reportConfigId: a report setting index
carrier: a serving cell index
resourcesForChannelMeasurement: a resource setting index for channel measurement having correlation with report setting
csi-IM-ResourcesForlnterference: a resource setting index having a CSI-IM resource for interference measurement having correlation with report setting
nzp-CSI-RS-ResourcesForlnterference: a resource setting index having a CSI-RS resource for interference measurement having correlation with report setting
reportConfigType: it may indicate a time domain transmission configuration and transmission channel of a channel report and may have an aperiodic transmission, semi-persistent physical uplink control channel (PUCCH) transmission, semi-periodic PUSCH transmission, or periodic transmission configuration
reportQuantity: it may indicate the type of channel information to be reported and may have the type of channel information (“cri-RI-PMI-CQI”, “cri-RI-i1”, “cri-RI-i1-CQI”, “cri-RI-CQI”, “cri-RSRP”, “ssb-Index-RSRP”, and “cri-RI-LI-PMI-CQI”) when a channel report is not transmitted (“none”) and when a channel report is transmitted. Herein, elements included in the type of the channel information may mean a channel quality indicator (CQI), a precoding matric indicator (PMI), a CSI-RS resource indicator (CRI), an SS/PBCH block resource indicator (SSBRI), a layer indicator (LI), a rank indicator (RI), and/or L1-reference signal received power (RSRP).
reportFreqConfiguration: it may indicate whether channel information to be reported includes only information on the entire band (wideband) or includes information on each subband, and may have configuration information for a subband including the channel information when information on each subband is included.
timeRestrictionForChannelMeasurements: whether the time domain is restricted for a reference signal for channel measurement among reference signals referred to by channel information to be reported
timeRestrictionForInterferenceMeasurements: whether the time domain is restricted for a reference signal for interference measurement among reference signals referred to by channel information to be reported
codebookConfig: codebook information referred to by channel information to be reported
groupBasedBeamReporting: whether to perform beam-grouping of a channel report
cqi-Table: a CQI table index referred to by channel information to be reported
subbandSize: an index indicating the subband size of channel information
non-PMI-PortIndication: port mapping information referred to when non-PMI channel information is reported

When the base station indicates channel information reporting through higher layer signaling or L1 signaling, the UE may perform channel information reporting by referring to the above configuration information included in the indicated report setting.

The base station may indicate a channel state report to the UE through higher layer signaling including RRC signaling or medium access control (MAC) control element (CE) signaling, or L1 signaling (e.g., common DCI, group-common DCI, and UE-specific DCI).

For example, the base station may indicate an aperiodic channel information report (CSI report) to the UE through higher layer signaling or DCI using DCI format 0_1. The base station configures multiple CSI report trigger states including a parameter for a CSI report or a parameter for an aperiodic CSI report of the UE through higher layer signaling. The parameter for the CSI report or the CSI report trigger state may include a set including a slot interval or a possible slot interval between a PDCCH including DCI and a PUSCH including a CSI report, a reference signal ID for channel state measurement, the type of included channel information, and the like. When the base station indicates some of the multiple CSI report trigger states to the UE through DCI, the UE reports channel information according to a CSI report configuration of report setting configured in the indicated CSI report trigger state. The channel information reporting may be performed through a PUSCH scheduled in DCI format 0_1. The time domain resource allocation of the PUSCH including the CSI report of the UE may be indicated through a slot interval with the PDCCH indicated through the DCI, a start symbol and symbol length indication within a slot for the time domain resource allocation of the PUSCH, and the like. For example, the position of the slot in which the PUSCH including the CSI report of the UE is transmitted may be indicated through the slot interval with the PDCCH indicated through the DCI, and the start symbol and the symbol length within the slot may be indicated through a time domain resource assignment field of the above-described DCI.

For example, the base station may indicate a semi-persistent CSI report transmitted on a PUSCH to the UE through DCI using DCI format 0_1. The base station may activate or deactivate the semi-persistent CSI report transmitted on the PUSCH through DCI scrambled by an SP-CSI-RNTI. When the semi-persistent CSI report is activated, the UE may periodically report channel information according to a configured slot interval. When the semi-persistent CSI report is deactivated, the UE may stop the activated periodic channel information reporting. The base station configures a parameter for a semi-persistent CSI report of the UE or multiple CSI report trigger states including the parameter for the semi-persistent CSI report through higher layer signaling. The parameter for the CSI report or the CSI report trigger state may include a set including a slot interval or a possible slot interval between a PDCCH including DCI indicating a CSI report and a PUSCH including a CSI report, a slot interval between a slot in which higher layer signaling indicating a CSI report is activated and a PUSCH including a CSI report, a slot interval period of a CSI report, the type of included channel information, and the like. When the base station activates some of the multiple CSI report trigger states or some of multiple report settings to the UE through higher layer signaling or DCI, the UE may report channel information according to report setting included in the indicated CSI report trigger state or a CSI report configuration configured in the activated report setting. The channel information reporting may be performed through a PUSCH semi-persistently scheduled in DCI format 0_1 scrambled by an SP-CSI-RNTI. The time domain resource allocation of the PUSCH including the CSI report of the UE may be indicated through a slot interval period of the CSI report, a slot interval with a slot in which higher layer signaling is activated or a slot interval with a PDCCH indicated through DCI, a start symbol and symbol length indication within a slot for the time domain resource allocation of the PUSCH, and the like. For example, the position of the slot in which the PUSCH including the CSI report of the UE is transmitted may be indicated through the slot interval with the PDCCH indicated through the DCI, and the start symbol and the symbol length within the slot may be indicated through a time domain resource assignment field of DCI format 0_1.

For example, the base station may indicate a semi-persistent CSI report transmitted on a PUCCH to the UE through higher layer signaling such as MAC-CE. Through the MAC-CE signaling, the base station may activate or deactivate the semi-persistent CSI report transmitted on the PUCCH. When the semi-persistent CSI report is activated, the UE may periodically report channel information according to a configured slot interval. When the semi-persistent CSI report is deactivated, the UE may stop the activated periodic channel information reporting. The base station configures a parameter for a semi-persistent CSI report of the UE through higher layer signaling. The parameter for the CSI report may include a PUCCH resource in which the CSI report is transmitted, a slot interval period of the CSI report, the type of included channel information, and the like. The UE may transmit the CSI report through the PUCCH. Alternatively, when the PUCCH for the CSI report overlaps a PUSCH, the UE may transmit the CSI report through the PUSCH. The position of the slot in which the PUCCH including the CSI report is transmitted may be indicated through a slot interval period of the CSI report configured through higher layer signaling and a slot interval between a slot in which higher layer signaling is activated and the PUCCH including the CSI report, and a start symbol and a symbol length within the slot may be indicated through a start symbol and a symbol length for allocation of a PUCCH resource configured through higher layer signaling.

For example, the base station may indicate a periodic CSI report to the UE through higher layer signaling. The base station may activate or deactivate the periodic CSI report through higher layer signaling including RRC signaling. When the periodic CSI report is activated, the UE may periodically report channel information according to a configured slot interval. When the periodic CSI report is deactivated, the UE may stop the activated periodic channel information reporting. The base station configures report setting including a parameter for a periodic CSI report of the UE through higher layer signaling. The parameter for the CSI report may include a PUCCH resource configuration for a CSI report, a slot interval between a slot in which higher layer signaling indicating a CSI report is activated and a PUCCH including a CSI report, a slot interval period of the CSI report, a reference signal ID for channel state measurement, the type of included channel information, and the like. The UE may transmit the CSI report through the PUCCH. Alternatively, when the PUCCH for the CSI report overlaps a PUSCH, the UE may transmit the CSI report through the PUSCH. The position of the slot in which the PUCCH including the CSI report is transmitted may be indicated through a slot interval period of the CSI report configured through higher layer signaling and a slot interval between a slot in which higher layer signaling is activated and the PUCCH including the CSI report, and a start symbol and a symbol length within the slot may be indicated through a start symbol and a symbol length for allocation of a PUCCH resource configured through higher layer signaling.

Regarding the above-described CSI report setting (CSI-ReportConfig), each CSI report setting (CSI-ReportConfig) may be associated with one downlink bandwidth part identified by a higher layer parameter bandwidth part identifier (bwp-id) provided via CSI resource setting (CSI-ResourceConfig) associated with the corresponding report setting. Aperiodic, semi-persistent, and periodic types are supported for a time domain reporting operation regarding each report setting CSI-ReportConfig, and may be configured by the base station for the UE through a parameter reportConfigType configured from a higher layer. A semi-persistent CSI reporting method supports “semi-PersistentOnPUCCH” and “semi-PersistentOnPUSCH”. In the case of a periodic or semi-persistent CSI reporting method, the UE may receive a configuration of a PUCCH or PUSCH resource for transmitting CSI from the base station through higher layer signaling. A period and slot offset of the PUCCH or PUSCH resource for transmitting the CSI may be given as a numerology of an uplink bandwidth part in which a CSI report is configured to be transmitted. In the case of an aperiodic CSI reporting method, the UE may receive, from the base station, scheduling of the PUSCH resource for transmitting the CSI through L1 signaling (DCI format 0_1 described above).

Regarding the above-described CSI resource setting (CSI-ResourceConfig), each CSI resource setting (CSI-ReportConfig) may include S (≥1) number of CSI resource sets (given by a higher layer parameter, csi-RS-ResourceSetList). A CSI resource set list may include a non-zero power (NZP) CSI-RS resource set and an SS/PBCH block set or may include a CSI-interference measurement (CSI-IM) resource set. Each CSI resource setting may be located in a downlink bandwidth part identified by a higher layer parameter, bwp-id, and the CSI resource settings may be connected to CSI report setting of the same downlink bandwidth part. A time domain operation of a CSI-RS resource in CSI resource setting may be configured as one of “aperiodic”, “periodic”, or “semi-persistent” based on a higher layer parameter, resourceType. For periodic or semi-persistent CSI resource setting, the number of CSI-RS resource sets may be limited to S=1, and a configured period and slot offset may be given by a numerology of the downlink bandwidth part identified by bwp-id. The UE may receive, from the base station, a configuration of one or more CSI resource settings for channel or interference measurement through higher layer signaling, and for example, the following CSI resources may be included.
CSI-IM resource for interference measurement
NZP CSI-RS resource for interference measurement
NZP CSI-RS resource for channel measurement

For CSI-RS resource sets associated with resource setting in which a higher layer parameter resourceType is configured as “aperiodic”, “periodic”, or “semi-persistent”, a trigger state for CSI report setting in which reportType is configured as “aperiodic” and resource setting for channel or interference measurement on one or more component cells (CCs) may be configured by a higher layer parameter, CSI-AperiodicTriggerStateList.

Aperiodic CSI reporting of the UE may be performed by using a PUSCH, periodic CSI reporting may be performed by using a PUCCH, and semi-persistent CSI reporting may be performed by using a PUSCH when triggered or activated by DCI and may be performed by using a PUCCH after being activated by MAC CE. As described above, CSI resource setting may also be configured as “aperiodic”, “periodic”, or “semi-persistent”. A combination of CSI report setting and a CSI resource configuration may be supported based on Table 9 below. Table 9 shows a triggering and activation method for CSI Reporting for the possible CSI-RS Configurations.

TABLE 9

| CSI-RS | Periodic CSI | Semi-Persistent CSI | Aperiodic CSI |
|---|---|---|---|
| Configuration | Reporting | Reporting | Reporting |
| Periodic CSI- | No dynamic | For reporting on PUCCH, | Triggered by DCI; |
| RS | triggering/activation | the UE receives an | additionally, activation |
| | | activation command [10, | command [10, TS |
| | | TS 38.321]; for reporting | 38.321] possible as |
| | | on PUSCH, the UE | defined in Subclause |
| | | receives triggering on | 5.2.1.5.1. |
| | | DCI | |
| Semi-Persistent | Not Supported | For reporting on PUCCH, | Triggered by DCI; |
| CSI-RS | | the UE receives an | additionally, activation |
| | | activation command [10, | command [10, TS |
| | | TS 38.321]; for reporting | 38.321] possible as |
| | | on PUSCH, the UE | defined in Subclause |
| | | receives triggering on | 5.2.1.5.1. |
| | | DCI | |
| Aperiodic CSI- | Not Supported | Not Supported | Triggered by DCI; |
| RS | | | additionally, activation |
| | | | command [10, TS |
| | | | 38.321] possible as |
| | | | defined in Subclause |
| | | | 5.2.1.5.1. |

Aperiodic CSI reporting may be triggered by a “CSI request” field of DCI format 0_1 corresponding to scheduling DCI for a PUSCH. The UE may monitor a PDCCH, obtain DCI format 0_1, and obtain scheduling information for the PUSCH and a CSI request indicator. The CSI request indicator may be configured in NTS(=0, 1, 2, 3, 4, 5, or 6) bits, and may be determined by higher layer signaling (reportTriggerSize). One trigger state among one or more aperiodic CSI report trigger states which may be configured through higher layer signaling (CSI-AperiodicTriggerStateList) may be triggered by the CSI request indicator.
When all bits of the CSI request field are 0, this may mean that CSI reporting is not requested.
If the number (M) of CSI trigger states in configured CSI-AperiodicTriggerStateList is greater than 2NTs−1, M number of CSI trigger states may be mapped to 2NTs−1 according to a pre-defined mapping relationship, and one of the 2NTs−1 trigger states may be indicated by the CSI request field.
If the number (M) of CSI trigger states in configured CSI-AperiodicTriggerStateList is equal to or less than 2NTs−1, one of M number of CSI trigger states may be indicated by the CSI request field.

Table 10 shows an example of a relationship between a CSI request indicator and a CSI trigger state indicatable by the corresponding indicator.

TABLE 10

| CSI | | CSI- | CSI- |
|---|---|---|---|
| request field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may perform measurement on a CSI resource in a CSI trigger state triggered by a CSI request field, and may generate CSI (including at least one of the above-described CQI, PMI, CRI, SSBRI, LI, RI, or L1-RSRP) therefrom. The UE may transmit the obtained CSI by using a PUSCH scheduled by DCI format 0_1. When 1 bit corresponding to an uplink data indicator (UL-SCH indicator) in DCI format 0_1 indicates “1”, the UE may multiplex uplink data (UL-SCH) and the obtained CSI and transmit the same to a PUSCH resource scheduled by DCI format 0_1. When the 1 bit corresponding to the uplink data indicator (UL-SCH indicator) in DCI format 0_1 indicates “0”, the UE may map and transmit only the CSI to the PUSCH resource scheduled by DCI format 01, without the uplink data (UL-SCH).

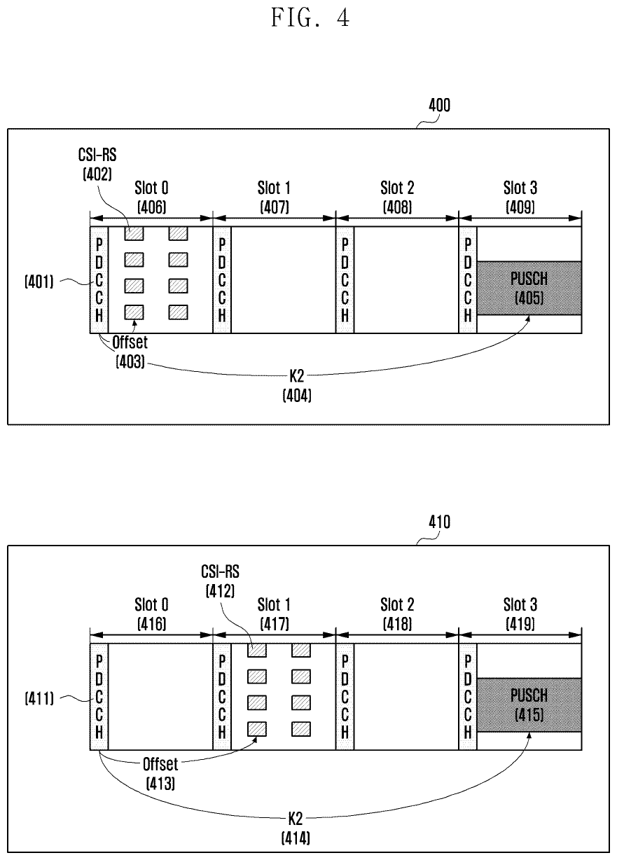

FIG. 4 illustrates an example of an aperiodic CSI reporting method.

In reference numeral 400 of FIG. 4, a UE may obtain DCI format 0_1 by monitoring a PDCCH 401, and may obtain scheduling information and CSI request information for a PUSCH 405 therefrom. The UE may obtain resource information for a CSI-RS 402 to be measured from a received CSI request indicator. The UE may determine a time point at which the UE should measure the transmitted CSI-RS resource 402, based on a time point at which DCI format 0_1 is received and a parameter (aperiodicTriggeringOffset) for an offset within a CSI resource set configuration (e.g., an NZP CSI-RS resource set configuration (NZP-CSI-RS-ResourceSet)). In detail, the UE may receive, from a base station, through higher layer signaling, a configuration of an offset value X of the parameter aperiodicTriggeringOffset in the NZP-CSI-RS resource set configuration, and the configured offset value X may refer to an offset between a slot where a CSI-RS resource is transmitted and a slot where DCI triggering an aperiodic CSI report is received. For example, a value of the parameter aperiodicTriggeringOffset and the offset value X may have a mapping relationship shown in Table 11 below.

TABLE 11

| aperiodic TriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

Reference numeral 400 shows an example in which the above-described offset value is configured as X=0. In this case, the UE may receive the CSI-RS 402 in a slot (corresponding to slot 0 406 of FIG. 4) in which DCI format 0_1 triggering an aperiodic CSI report is received, and may report, to the base station, CSI information measured by the received CSI-RS through the PUSCH 405. The UE may obtain, from DCI format 0_1, scheduling information (information corresponding to each field of DCI format 01) for the PUSCH 405 for the CSI report. For example, the UE may obtain information on a slot in which the PUSCH 405 is to be transmitted from the above-described time domain resource allocation information for the PUSCH 405 in DCI format 0_1. In reference numeral 400, the UE has obtained 3 as a K2 value corresponding to a slot offset value for PDCCH-to-PUSCH, and accordingly, the PUSCH 405 may be transmitted from slot 3 409 that is 3 slots away from slot 0 406, i.e., a time point when the PDCCH 401 is received.

In reference numeral 410 of FIG. 4, the UE may obtain DCI format 0_1 by monitoring a PDCCH 411, and may obtain scheduling information and CSI request information for a PUSCH 415 therefrom. The UE may obtain resource information for a CSI-RS 412 to be measured from a received CSI request indicator. Reference numeral 410 of FIG. 4 shows an example in which the above-described offset value for the CSI-RS is configured as X=1. In this case, the UE may receive the CSI-RS 412 in a slot (corresponding to slot 0 416 of FIG. 4) in which DCI format 0_1 triggering an aperiodic CSI report is received, and may report, to the base station, CSI information measured by the received CSI-RS through the PUSCH 415.

An aperiodic CSI report may include at least one or both of CSI part 1 and CSI part 2, and when the aperiodic CSI report is transmitted through a PUSCH, the aperiodic CSI report may be multiplexed with a transport block. For multiplexing, a CRC may be inserted into input bits of aperiodic CSI, may undergo encoding and rate matching, and then may be mapped to a resource element in the PUSCH in a specific pattern to be transmitted. The CRC insertion may be omitted according to a coding method or the length of the input bits. When CSI part 1 or CSI part 2 included in the aperiodic CSI report is multiplexed, the number of modulation symbols calculated for rate matching may be calculated as shown in Table 12 below.

```
TABLE 12
For CSI part 1 transmission on PUSCH not using repetition type B with UL-SCH,
the number of coded modulation symbols per layer for CSI part 1 transmission,
denoted as Q_{CSI-part1}^{′}, is determined as follows:
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} \}$
. . .
For CSI part 1 transmission on an actual repetition of a PUSCH with repetition Type B with
UL-SCH, the number of coded modulation symbols per layer for CSI part 1 transmission,
denoted as Q_{CSI-part1}^{′}, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} , {\sum }_{l = 0}^{{N}_{symb , actual}^{PUSCH} - 1} {M}_{sc , actual}^{UCI} ( l ) - {Q}_{\frac{ACK}{CG} - UCI}^{′} \}$
. . .
For CSI part 1 transmission on PUSCH without UL-SCH, the number of coded modulation
symbols per layer for CSI part 1 transmission, denoted as Q_{CSI-part1}^{′}, is determined as follows:
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
else
${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
. . .
For CSI part 2 transmission on PUSCH not using repetition type B with UL-SCH, the
number of coded modulation symbols per layer for CSI part 2 transmission, denoted as
Q_{CSI-part2}^{′}, is determined as follows:
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} - {Q}_{CSI - 1}^{′} \}$
For CSI part 2 transmission on an actual repetition of a PUSCH with repetition Type B with
UL-SCH, the number of coded modulation symbols per layer for CSI part 2 transmission,
denoted asQ_{CSI-part2}^{′}, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{\frac{ACK}{CG} - UCI}^{′} - {Q}_{CSI - 1}^{′} \}$
. . .
For CSI part 2 transmission on PUSCH without UL-SCH, the number of coded modulation
symbols per layer for CSI part 2 transmission, denoted as Q_{CSI-part2}^{′}, is determined as follows:
${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

In particular, in the case of PUSCH repetitive transmission types A and B, the UE may multiplex and transmit an aperiodic CSI report only on a first repetitive transmission among PUSCH repetitive transmissions. This is because aperiodic CSI report information that is multiplexed is encoded in a polar code scheme, and in this case, to perform multiplexing on several PUSCH repetitions, each PUSCH repetition is required to have the same frequency and time resource allocation. In particular, in the case of PUSCH repetition type B, since each actual repetition may have a different OFDM symbol length, the aperiodic CSI report may be multiplexed and transmitted only on a first PUSCH repetition.

In addition, in PUSCH repetitive transmission type B, when the UE receives DCI that schedules an aperiodic CSI report or activates a semi-persistent CSI report without scheduling of a transport block, even when the number of PUSCH repetitive transmissions configured through higher layer signaling is greater than 1, a value of nominal repetition may be assumed to be 1. In addition, when the UE schedules or activates an aperiodic or semi-persistent CSI report without scheduling of a transport block based on PUSCH repetitive transmission type B, the UE may expect that a first nominal repetition is the same as a first actual repetition. For a PUSCH transmitted with semi-persistent CSI based on PUSCH repetitive transmission type B without scheduling of DCI after a semi-persistent CSI report is activated by the DCI, if the first nominal repetition is different from the first actual repetition, transmission for the first nominal repetition may be ignored.

Hereinafter, a CSI computation time is described.

When the base station indicates an aperiodic CSI report or a semi-persistent CSI report to the UE through DCI, the UE may determine whether valid channel reporting may be performed through the indicated CSI report, by considering a channel computation time (CSI computation time) required for the CSI report. For the aperiodic CSI report or the semi-persistent CSI report indicated through the DCI, the UE may perform valid CSI reporting from an uplink symbol after a Z symbol following the end of the last symbol included in a PDCCH including the DCI indicating the CSI report. The Z symbol may vary according to a numerology of a downlink bandwidth part corresponding to the PDCCH including the DCI indicating the CSI report, a numerology of an uplink bandwidth part corresponding to a PUSCH in which the CSI report is transmitted, or the type or characteristics (report quantity, frequency band granularity, the number of ports of reference signals, a codebook type, and the like) of channel information reported in the CSI report. In other words, in order to determine a certain CSI report as a valid CSI report (to determine a corresponding CSI report as a valid CSI report), uplink transmission of the corresponding CSI report should not be performed prior to a Zref symbol including a timing advance. In this case, the Zref symbol is an uplink symbol in which a cyclic prefix (CP) starts after a time T_{proc,CSI}=(Z)(2048+144)·κ2^{-μ}·T_{C} from the end of the last symbol of a triggering PDCCH. A detailed value of Z may follow the description below, and

$${T}_{c} = \frac{1}{Δ {f}_{max} \cdot {N}_{f}} f\_max = 480 \cdot {10}^{\hat{}} 3 Hz , {N}_{f} = 4096 , κ = 64 ,$$

and μ are numerologies. In this case, μ may be agreed to use one of (μ_{PDCCH}, μ_{CSI-RS}, μ_{UL}), which causes the greatest T_{proc,CSI} value, and μ_{PDCCH} may refer to a subcarrier spacing used for PDCCH transmission, μ_{CSI-RS} may refer to a subcarrier spacing used for CSI-RS transmission, and μ_{UL} may refer to a subcarrier spacing of an uplink channel used for uplink control information (UCI) transmission for CSI reporting. In another example, p may be agreed to use one of (μ_{PDCCH}, μ_{UL}), which causes the greatest T_{proc,CSI} value. The definitions of μ_{PDCCH} and μ_{UL} refer to the above description. For convenience of the following description, satisfying the above condition may be referred to as satisfying CSI reporting validity condition 1.

In addition, when a reference signal for channel measurement for an aperiodic CSI report indicated to the UE through DCI is an aperiodic RS, the UE may perform valid CSI reporting from an uplink symbol after a Z′ symbol following the end of the last symbol including the reference signal, and the Z′ symbol may vary according to a numerology of a downlink bandwidth part corresponding to a PDCCH including the DCI indicating the CSI report, a numerology of a bandwidth corresponding to the reference signal for channel measurement for the CSI report, a numerology of an uplink bandwidth part corresponding to a PUSCH in which the CSI report is transmitted, or the type or characteristics (report quantity, frequency band granularity, the number of ports of reference signals, a codebook type, and the like) of channel information reported in the CSI report. In other words, in order to determine a certain CSI report as a valid CSI report (to determine a corresponding CSI report as a valid CSI report), uplink transmission of the corresponding CSI report should not be performed prior to a Zref′ symbol including a timing advance. In this case, the Zref symbol is an uplink symbol in which a cyclic prefix (CP) starts after a time T_{proc,CSI}′=(Z′)(2048+144)·κ2^{-μ}·T_{C} from the end of the last symbol of an aperiodic CSI-RS or an aperiodic CSI-IM triggered by a triggering PDCCH. A detailed value of Z′ may follow the description below, and

$${T}_{c} = \frac{1}{Δ {f}_{max} \cdot {N}_{f}} f\_max = 480 \cdot {10}^{\hat{}} 3 Hz , {N}_{f} = 4096 , κ = 64 ,$$

and μ are numerologies. In this case, μ may be agreed to use one of (μ_{PDCCH}, μ_{CSI-RS}, μ_{UL}), which causes the greatest T_{proc,CSI} value, and μ_{PDCCH} may refer to a subcarrier spacing used for triggering PDCCH transmission, μ_{CSI-RS} may refer to a subcarrier spacing used for CSI-RS transmission, and μ_{UL} may refer to a subcarrier spacing of an uplink channel used for uplink control information (UCI) transmission for CSI reporting. In another example, μ may be agreed to use one of (μ_{PDCCH}, μ_{UL}), which causes the greatest T_{proc,csi} value. In this case, the definitions of μ_{PDCCH} and μ_{UL} refer to the above description. For convenience of the following description, satisfying the above condition may be referred to as satisfying CSI reporting validity condition 2.

When the base station indicates an aperiodic CSI report for an aperiodic reference signal to the UE through DCI, the UE may perform valid CSI reporting from a first uplink symbol which satisfies both a time point after a Z symbol following the end of the last symbol included in a PDCCH including the DCI indicating the CSI report and a time point after a Z′ symbol following the end of the last symbol including the reference signal. That is, in the case of aperiodic CSI reporting based on the aperiodic reference signal, the CSI report is determined as a valid CSI report when both CSI reporting validity conditions 1 and 2 are satisfied.

When a CSI reporting time point indicated by the base station does not satisfy a CSI computation time requirement, the UE may determine that the corresponding CSI report is not valid and may not consider updating of a channel information state for the CSI report.

The above-described Z and Z′ symbols for calculation of the CSI computation time follow Table 13 and Table 14. For example, when channel information reported in the CSI report includes only wideband information, the number of ports of the reference signal is 4 or less, the number of RS resources is 1, and a codebook type is “typeI-SinglePanel” or the type (report quantity) of channel information to be reported is “cri-RI-CQI”, the Z and Z′ symbols follow value Z₁, Z₁′ of Table 14. This will be referred to as delay requirement 2. In addition, when a PUSCH including the CSI report does not include a TB or a HACK-ACK and a CPU occupation of the UE is 0, the Z and Z′ symbols follow value Z₁, Z′ of Table 13, which is referred to as delay requirement 1. The CPU occupation is described below in detail. In addition, when the report quantity is “cri-RSRP” or “ssb-Index-RSRP”, the Z and Z′ symbols follow value Z₃, Z₃′ of Table 14. X1, X2, X3, and X4 of Table 14 denote UE capability for a beam reporting time, and KB1 and KB2 of Table 14 denote UE capability for a beam changing time. In a case which does not correspond to the type or characteristics of the channel information reported in the CSI report, the Z and Z′ symbols follow value Z₂, Z₂′ in Table 14.

TABLE 13

| | Z₁ [symbols] | |
|---|---|---|
| μ | Z₁ | Z₁′ |
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃ [symbols] | |
|---|---|---|---|---|---|---|
| μ | Z₁ | Z₁′ | Z₂ | Z₂′ | Z₃ | Z₃′ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

Hereinafter, a CSI reference resource is described.

When the base station indicates an aperiodic/semi-persistent/periodic CSI report to the UE, the base station may configure a CSI reference resource to determine a reference time and frequency for a channel to be reported in the CSI report. A frequency of the CSI reference resource may be carrier and subband information for measuring CSI, indicated in a CSI report configuration, and the carrier and subband information may correspond to a carrier and reportFreqConfiguration in CSI-ReportConfig which is higher layer signaling, respectively. A time of the CSI reference resource may be defined based on a time at which the CSI report is transmitted. For example, when CSI report #X is indicated to be transmitted in uplink slot n′ of a BWP and a carrier for transmitting a CSI report, a time of a CSI reference resource of CSI report #X may be defined as downlink slot n-n_{CSI-ref} of a BWP and a carrier for measuring CSI. Downlink slot n is calculated as n=└n′ ·2^{μ}^{_{DL}}/2^{μ}^{_{UL}}┘, when a numerology of the BWP and carrier for measuring the CSI is referred to as μ_{UL} and a numerology of the BWP and carrier for transmitting CSI report #X is referred to as μ_{UL}. When CSI report #X transmitted in uplink slot n′ is a semi-persistent or periodic CSI report, n_{CSI-ref} which is a slot interval between the downlink slot n and a CSI reference signal follows n_{CSI-ref}=4·2^{DL} when a single CSI-RS resource is connected to the corresponding CSI report and follows n_{CSI-ref}=5·2^{μ}^{_{DL}} when multiple CSI-RS resources are connected to the corresponding CSI report, according to the number of CSI-RS/SSB resources for channel measurement. When CSI report #X transmitted in uplink slot n′ is an aperiodic CSI report, n_{CSI-ref} may be calculated as

$${n}_{CSI - ref} = ⌊ \frac{{Z}^{′}}{{N}_{symb}^{slot}} ⌋$$

by considering CSI computation time Z′ for channel measurement. N_{symb} may be the number of symbols included in one slot, and N_{symb} 14 is assumed in NR.

When the base station indicates the UE to transmit a certain CSI report in uplink slot n′ through higher layer signaling or DCI, the UE may report CSI by performing channel measurement or interference measurement with respect to a CSI-RS resource, a CSI-IM resource, and an SSB resource transmitted not later than a CSI reference resource slot of the CSI report transmitted in uplink slot n′ from among the CSI-RS resource, the CSI-IM resource, and the SSB resource associated with the corresponding CSI report. The CSI-RS resource, the CSI-IM resource, or the SSB resource associated with the corresponding CSI report may refer to a CSI-RS resource, a CSI-IM resource, or an SSB resource included in a resource set configured in resource setting referred to by report setting for the CSI report of the UE configured through higher layer signaling, a CSI-RS resource, a CSI-IM resource, or an SSB resource referred to by a CSI report trigger state including a parameter for the corresponding CSI report, or a CSI-RS resource, a CSI-IM resource, or an SSB resource indicated by an ID of a reference signal (RS) set.

In embodiments of the disclosure, CSI-RS/CSI-IMI/SSB occasions may be transmission time points of CSI-RS/CSI-IMI/SSB resource(s) determined by a higher layer configuration or a combination of the higher layer configuration and DCI triggering. For example, a slot in which a semi-persistent or periodic CSI-RS resource is transmitted is determined according to a slot period and a slot offset configured through higher layer signaling, and transmission symbol(s) in the slot is determined according to resource mapping information (resourceMapping). In another example, a slot in which an aperiodic CSI-RS resource is transmitted is determined according to a slot offset with a PDCCH including DCI indicating a channel report configured through higher layer signaling, and transmission symbol(s) in the slot is determined according to resource mapping information (resourceMapping).

The above-described CSI-RS occasion may be determined by independently considering a transmission time point of each CSI-RS resource or by collectively considering transmission time points of one or more CSI-RS resource(s) included in a resource set, and accordingly, the following two interpretations may be possible for a CSI-RS occasion according to each resource set configuration.
Interpretation 1-1: from a start time point of the earliest symbol to an end time point of the latest symbol in which one specific resource among one or more CSI-RS resources included in resource set(s) configured in resource setting referred to by report setting configured for a CSI report is transmitted
Interpretation 1-2: from a start time point of the earliest symbol in which a CSI-RS resource transmitted at the earliest time point is transmitted to an end time point of the latest symbol in which a CSI-RS resource transmitted at the latest time point is transmitted among all CSI-RS resources included in resource set(s) configured in resource setting referred to by report setting configured for a CSI report

Hereinafter, in embodiments of the disclosure, the individual application is possible in consideration of both the two interpretations for the CSI-RS occasion. Further, both the two interpretations for the CSI-IM occasion and the SSB occasion can be considered as in the CSI-RS occasion, but the principle thereof is similar to the above description, and thus an overlapping description is omitted hereinafter.

In embodiments of the disclosure, “the CSI-RS/CSI-IM/SSB occasions for CSI report #X transmitted in uplink slot n′″ refer to a set of CSI-RS occasions, CSI-IM occasions, and SSB occasions which are not later than a CSI reference resource of CSI report #X transmitted in uplink slot n′ among a CSI-RS occasion, a CSI-IM occasion, and an SSB occasion of a CSI-RS resource, a CSI-IM resource, and an SSB resource included in a resource set configured in resource setting referred to by report setting configured for CSI report #X.

In embodiments of the disclosure, “the latest CSI-RS/CSI-IM/SSB occasions among the CSI-RS/CSI-IM/SSB occasions for CSI report #X transmitted in uplink slot n′″ may have two interpretations below.
Interpretation 2-1: a set of occasions including the latest CSI-RS occasion among CSI-RS occasions for CSI report #X transmitted in uplink slot n′, the latest CSI-IM occasion among CSI-IM occasions for CSI report #X transmitted in uplink slot n′, and the latest SSB occasion among SSB occasions for CSI report #0 transmitted in uplink slot n′
Interpretation 2-2: the latest occasion among all of CSI-RS occasions, CSI-IM occasions, and SSB occasions for CSI report #X transmitted in uplink slot n′

Hereinafter, in embodiments of the disclosure, the individual application is possible in consideration of both the two interpretations for “the latest CSI-RS/CSI-IM/SSB occasions among the CSI-RS/CSI-IM/SSB occasions for CSI report #X transmitted in uplink slot n′″. When the above-described two interpretations (interpretation 1-1 and interpretation 1-2) are considered for the CSI-RS occasion, the CSI-IM occasion, and the SSB occasion, “the latest CSI-RS/CSI-IM/SSB occasions among the CSI-RS/CSI-IMI/SSB occasions for CSI report #X transmitted in uplink slot n′″ can be individually applied in consideration of all of four different interpretations (the application of interpretation 1-1 and interpretation 2-1, the application of interpretation 1-1 and interpretation 2-2, and the application of interpretation 1-2 and interpretation 2-1, and the application of interpretation 1-2 and interpretation 2-2) in embodiments of the disclosure.

The base station may indicate a CSI report by considering the amount of channel information that may be simultaneously computed by the UE for a CSI report, that is, the number of channel information computation units (CSI processing units, CPUs) of the UE. When the number of channel information computation units that may be simultaneously computed by the UE is N_{CPU}, the UE may not expect a CSI report indication of the base station, which requires channel information computations more than N_{CPU}, or may not consider updating of channel information which requires channel information computations more than N_{CPU}. N_{CPU} may be reported by the UE to the base station through higher layer signaling or may be configured by the base station through higher layer signaling.

It is assumed that the CSI report indicated to the UE by the base station occupies some or all of the CPUs for channel information computation among the total number N_{CPU} of pieces of channel information that may be simultaneously computed by the UE. If the number of channel information computation units required for each CSI report, for example, CSI report n (n=0, 1, . . . , N− 1) is O_{CPU}⁽ⁿ⁾, the number of channel information computation units required for a total of N CSI reports may be Σₙ₌₀^{N-}1O_{CP}⁽ⁿ⁾. The channel information computation unit required for each reportQuantity configured in the CSI report may be configured as shown in Table 15 below.

TABLE 15

```
- O_{CPU}⁽ⁿ⁾ = 0 : case where reportQuantity configured in CSI report is configured as “none”, and
trs-Info is configured in CSI-RS resource set connected to CSI report
- O_{CPU}⁽ⁿ⁾ = 1 : case where reportQuantity configured in CSI report is configured as “none”, “cri-
RSRP”, or “ssb-Index-RSRP”, and trs-Info is not configured in CSI-RS resource set connected
to CSI report
- case where reportQuantity configured in CSI report is configured as “cri-RI-PMI-CQI”, “cri-
RI-i1”, “cri-RI-i1-CQI”, “cri-RI-CQI”, or “cri-RI-LI-PMI-CQI”
  >> O_{CPU}⁽ⁿ⁾ = N_{CPU} : case where aperiodic CSI report is triggered and corresponding CSI
report is not multiplexed with one or all of TB/HARQ-ACK. Case where corresponding CSI
report is wideband CSI, corresponds to up to 4 CSI-RS ports, and corresponds to a single
resource with no CRI report, and codebookType corresponds to “typeI-SinglePanel” or
reportQuantity corresponds to “cri-RI-CQI”
(this case is a case corresponding to the above-described delay requirement 1 and may be
regarded as a case where a UE rapidly computes and reports CSI by using all available CPUs)
  >> O_{CPU}⁽ⁿ⁾ = Kₛ : all cases except the above cases. Kₛ indicates the number of CSI-RS
resources in CSI-RS resource set for channel measurement
```

When the number of channel information computations required by the UE for multiple CSI reports at a specific time point is greater than the number N_{CPU} of channel information computation units that may be simultaneously computed by the UE, the UE may not consider updating of channel information for some CSI reports. Among the indicated multiple CSI reports, a CSI report for which updating of channel information is not considered may be determined by at least considering a time for which channel information computation required for the CSI report occupies CPUs and a priority of channel information to be reported. For example, regarding the time for which the channel information computation required for the CSI report occupies the CPUs, updating of channel information for a CSI report starting at the latest time point may not be considered, and updating of channel information for a CSI report having a low priority of channel information may not be preferentially considered.

The priority of the channel information may be determined with reference to Table 16 below.

TABLE 16

CSI priority value Pri_{iCS1}(y, k, c, s) = 2 · N_{cells} · Mₛ · y + N_{cells} · Mₛ · k + Mₛ · c + s,
- y = 0 case of aperiodic CSI report transmitted through PUSCH, y = 1 case of semi-
persistent CSI report transmitted through PUSCH, y = 2 case of semi-persistent CSI report
transmitted through PUCCH, y = 3 case of periodic CSI report transmitted through PUCCH;
- k = 0 case where CSI report includes L1-RSRP, k = 1 case where CSI report does not
include L1-RSRP;
- c : serving cell index, N_{cells}: maximum number of serving cells configured through higher
layer signaling (maxNrofServingCells);
- s : CSI report configuration index (reportConfigID), Mₛ: maximum number of CSI report
configurations configured through higher layer signalling (maxNrofCSI-
ReportConfigurations).

A CSI priority for a CSI report is determined through priority values Pri_{iCSI}(y, k, c, s) of Table 16. Referring to Table 16, a CSI priority value is determined through the type of channel information included in the CSI report, time domain report characteristics (aperiodic, semi-persistent, and periodic) of the CSI report, a channel (PUSCH or PUCCH) through which the CSI report is transmitted, a serving-cell index, and a CSI report configuration index. The CSI priority for the CSI report is determined by comparing the priority values Pri_{iCSI}(y, k, c, s) such that a CSI report having a lower priority value has a higher CSI priority.

If a time for which channel information computation required for a CSI report indicated by the base station to the UE occupies CPUs is a CPU occupation time, the CPU occupation time is determined by considering the type (report quantity) of channel information included in the CSI report, time domain characteristics (aperiodic, semi-persistent, and periodic) of the CSI report, a slot or a symbol occupied by higher layer signaling or DCI indicating the CSI report, and a part or all of a slot or a symbol occupied by a reference signal for channel state measurement.

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

According to an embodiment, the DCI may be subjected to channel coding and modulation processes and then transmitted through a physical downlink control channel (PDCCH). A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message (for example, UE-specific data transmission, power control command, or random access response, or the like). The RNTI is not explicitly transmitted, but is transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 17 below, for example.

TABLE 17

| | |
|---|---|
| - | Identifier for DCI formats - [1] bit |
| - | $Frequency domain resource assignment - [ ⌈ {log}_{2} ( \frac{{N}_{RB}^{UL , BWP} ( {N}_{RB}^{UL , BWP} + 1 )}{2} ) ⌉ ] bits$ |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH - [2] bits |
| - | Uplink/supplementary uplink (UL/SUL) indicator - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 18 below, for example.

TABLE 18

| | |
|---|---|
| - | Carrier indicator - 0 or 3 bits |
| - | UL/SUL indicator - 0 or 1 bit |
| - | Identifier for DCI formats - [1] bits |
| - | Bandwidth part indicator - 0, 1 or 2 bits |
| - | Frequency domain resource assignment |
| | ${}^{*} For resource allocation type 0 , ⌈ \frac{{N}_{RB}^{UL , BWP}}{P} ⌉ bits$ |
| | ${}^{*} For resource allocation type 1 , ⌈ {log}_{2} ( \frac{{N}_{RB}^{UL , BWP} ( {N}_{RB}^{UL , BWP} + 1 )}{2} ) ⌉ bits$ |
| - | Time domain resource assignment -1, 2, 3, or 4 bits |
| - | Virtual resource block (VRB)-to-physical resource block (PRB) mapping - |
| - | 0 or 1 bit, only for resource allocation type 1. |
| | * 0 bit if only resource allocation type 0 is configured; |
| | * 1 bit otherwise. |
| - | Frequency hopping flag - 0 or 1 bit, only for resource allocation type 1. |
| | * 0 bit if only resource allocation type 0 is configured; |
| | * 1 bit otherwise. |
| - | Modulation and coding scheme - 5 bits |
| - | New data indicator - 1 bit |
| - | Redundancy version - 2 bits |
| - | HARQ process number - 4 bits |
| - | 1 st downlink assignment index- 1 or 2 bits |
| | * 1 bit for semi-static HARQ-ACK codebook; |
| | * 2 bits for dynamic HARQ-ACK codebook with single HARQ-ACK |
| | codebook. |
| - | 2nd downlink assignment index - 0 or 2 bits |
| | * 2 bits for dynamic HARQ-ACK codebook with two HARQ-ACK |
| | sub-codebooks; |
| | * 0 bit otherwise. |
| - | TPC command for scheduled PUSCH - 2 bits |
| - | $SRS resource indicator - ⌈ {log}_{2} ( {\sum }_{k = 1}^{{L}_{max}} ( \begin{matrix}{N}_{SRS} \\ k\end{matrix} ) ) ⌉ ⌈ {log}_{2} ( {N}_{SRS} ) ⌉ bits$ |
| | $* ⌈ {log}_{2} ( {\sum }_{k = 1}^{{L}_{max}} ( \begin{matrix}{N}_{SRS} \\ k\end{matrix} ) ) ⌉ s$ |
| | for non-codebook based PUSCH transmission; |
| | *┌log₂(N_{SRS})┐ bits for codebook based PUSCH transmission. |
| - | Precoding information and number of layers - up to 6 bits |
| - | Antenna ports - up to 5 bits |
| - | SRS request - 2 bits |
| - | Channel state information (CSI) request - 0, 1, 2, 3, 4, 5, or 6 bits |
| - | Code block group (CBG) transmission information - 0, 2, 4, 6, or 8 bits |
| - | Phase tracking reference signal (PTRS)-demodulation reference signal |
| | (DDMRS) association - 0 or 2 bits. |
| - | beta_offset indicator - 0 or 2 bits |
| - | DMRS sequence initialization - 0 or 1 bit |

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 19 below, for example.

TABLE 19

| | |
|---|---|
| - | Identifier for DCI formats - [1] bit |
| - | $Frequency domain resource assignment - [ ⌈ {log}_{2} ( \frac{{N}_{RB}^{DL , BWP} ( {N}_{RB}^{DL , BWP} + 1 )}{2} ) ⌉ ] bits$ |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Pysical uplink control channel (PUCCH) resource indicator - 3 bits |
| | PDSCH-to-HARQ feedback timing indicator - [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 20 below, for example.

TABLE 20

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |
| | ${}^{*} For resource allocation type 0 , ⌈ \frac{{N}_{RB}^{DL , BWP}}{P} ⌉ bits$ |
| | ${}^{*} For resource allocation type 1 , ⌈ {log}_{2} ( \frac{{N}_{RB}^{DL , BWP} ( {N}_{RB}^{DL , BWP} + 1 )}{2} ) ⌉ bits$ |
| - | Time domain resource assignment -1, 2, 3, or 4 bits |
| - | VRB-to-PRB mapping - 0 or 1 bit, only for resource allocation |
| | type 1. |
| | *0 bit if only resource allocation type 0 is configured; |
| | *1 bit otherwise. |
| - | Physical resource block (PRB) bundling size indicator - 0 or 1 bit |
| - | Rate matching indicator - 0, 1, or 2 bits |
| - | Zero power (ZP) channel state information (CSI)-reference signal |
| | (RS) trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

Hereinafter, a downlink control channel in a 5G communication system will be described in more detail with reference to the accompanying drawings.

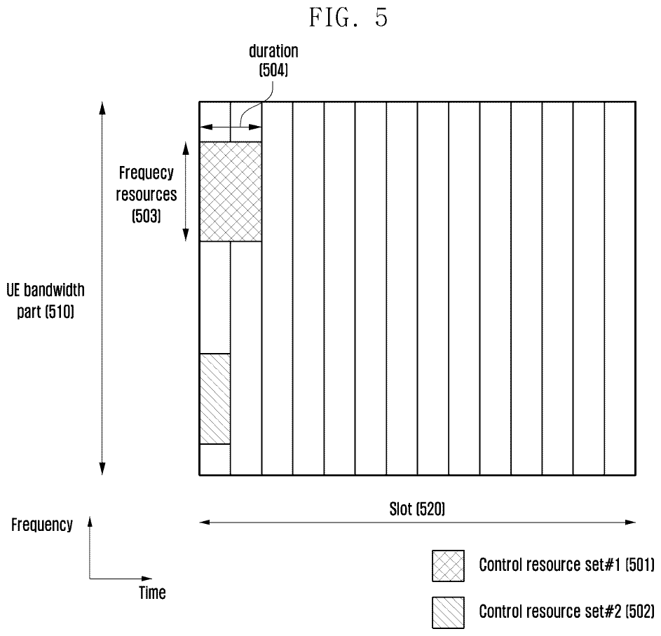

FIG. 5 illustrates an example of a control resource set (CORESET) used to transmit a downlink control channel in a 5G wireless communication system. FIG. 5 illustrates an example in which a UE bandwidth part 510 is configured along the frequency axis, and two control resource sets (control resource set #1 501 and control resource set #2 502) are configured within one slot 520 along the time axis. The control resource sets 501 and 502 may be configured in a specific frequency resource 503 within the entire UE bandwidth part 510 along the frequency axis. One or multiple OFDM symbols may be configured along the time axis, and this may be defined as a control resource set duration 504. In the example illustrated in FIG. 5, control resource set #1 501 is configured to have a control resource set duration corresponding to two symbols, and control resource set #2 502 is configured to have a control resource set duration corresponding to one symbol.

A control resource set in 5G described above may be configured for a UE by a base station through higher layer signaling (for example, system information, MIB, RRC signaling, etc.). The description that a control resource set is configured for a UE means that information such as a control resource set identity, the control resource set's frequency location, and the control resource set's symbol duration is provided. For example, the control resource set may include the following pieces of information given in Table 21 below:

TABLE 21

```
ControlResourceSet ::= SEQUENCE {
  -- Corresponds to L1 parameter ‘CORESET-ID’
  controlResourceSetId  ControlResourceSetId,
  (control resource set identity)
  frequencyDomainResources  BIT STRING (SIZE (45)),
  (frequency domain resource assignment information)
  duration  INTEGER (1..maxCoReSetDuration),
  (time domain resource assignment information)
  cce-REG-MappingType  CHOICE {
  (CCE-to-REG mapping type)
    interleaved  SEQUENCE {
      reg-BundleSize  ENUMERATED {n2, n3, n6},
    (REG bundle size)
      precoderGranularity  ENUMERATED {sameAsREG-
    bundle, allContiguousRBs},
      interleaverSize  ENUMERATED {n2, n3, n6}
      (interleaver size)
      shiftIndex
      INTEGER(0..maxNrofPhysicalResourceBlocks-1)
      OPTIONAL
      (interleaver shift)
    },
    nonInterleaved  NULL
  },
  tci-StatesPDCCH  SEQUENCE(SIZE (1..maxNrofTCI-
    StatesPDCCH)) OF TCI-StateId  OPTIONAL,
  (QCL configuration information)
  tci-PresentInDCI  ENUMERATED {enabled}
                              OPTIONAL, -- Need S
}
```

In Table 21, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

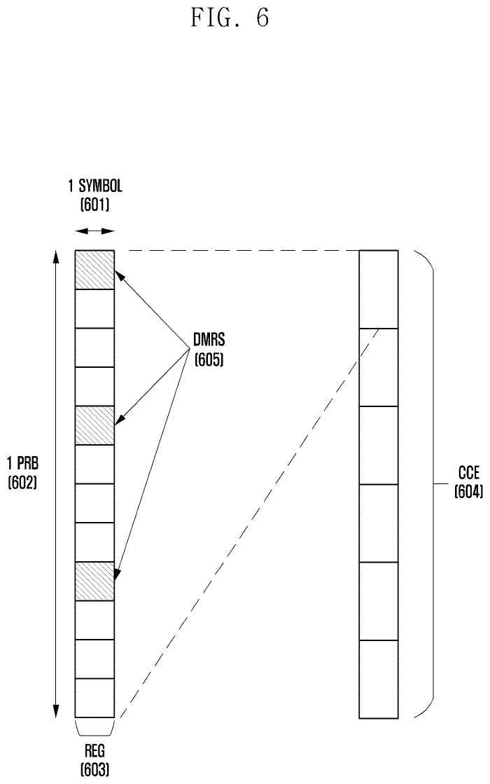

FIG. 6 illustrates an example of a basic unit of time and frequency resources constituting a downlink control channel available in a 5G system.

According to FIG. 6, the basic unit of time and frequency resources constituting a control channel may be referred to as a resource element group (REG) 603, and the REG 603 may be defined by one OFDM symbol 601 along the time axis and one physical resource block (PRB) 602 (that is, 12 subcarriers) along the frequency axis. The base station may configure a downlink control channel allocation unit by concatenating the REGs 603.

Provided that the basic unit of downlink control channel allocation is a control channel element 604, one CCE 604 may include multiple REGs 603. To describe the REG 603, for example, the REG 603 may include 12 REs, and if one CCE 604 includes six REGs 603, one CCE 604 may then include 72 REs. A downlink control resource set, once configured, may include multiple CCEs 604, and a specific downlink control channel may be mapped to one or multiple CCEs 604 and then transmitted according to the aggregation level (AL) in the control resource set. The CCEs 604 in the control resource set are distinguished by numbers, and the numbers of CCEs 604 may be allocated according to a logical mapping scheme.

The REG 603 may include both REs to which DCI is mapped, and an area to which a reference signal (DMRS 605) for decoding the same is mapped. As in FIG. 6, three DRMSs 605 may be transmitted inside one REG 603. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to perform dynamic scheduling regarding system information. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a predetermined set of CCEs. Scheduling allocation information regarding a UE-specific PDSCH or PUSCH may be received by scanning the UE-specific search space of the PDCCH. The UE-specific search space may be defined UE-specifically as a function of various system parameters and the identity of the UE.

In a 5G system, parameters for a search space regarding a PDCCH may be configured for the UE by the base station through higher layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the configuration information may include the following pieces of information given in Table 22.

TABLE 22

```
SearchSpace ::=  SEQUENCE {
  -- Identity of the search space. SearchSpaceId = 0 identifies the SearchSpace
    configured via PBCH (MIB) or ServingCellConfigCommon.
  searchSpaceId  SearchSpaceId,
  (search space identity)
  controlResourceSetId  ControlResourceSetId,
  (control resource set identity)
  monitoringSlotPeriodicityAndOffset  CHOICE {
  (monitoring slot level periodicity)
    sl1  NULL,
    sl2  INTEGER (0..1),
    sl4  INTEGER (0..3),
    sl5  INTEGER (0..4),
    sl8  INTEGER (0..7),
    sl10 INTEGER (0..9),
    sl16 INTEGER (0..15),
    sl20 INTEGER (0..19)
  }
                        OPTIONAL,
  duration (monitoring duration)  INTEGER (2..2559)
  monitoringSymbolsWithinSlot  BIT STRING (SIZE (14))
                                  OPTIONAL,
  (monitoring symbols within slot)
  nrofCandidates  SEQUENCE {
  (number of PDCCH candidates for each aggregation level)
  aggregationLevel1  ENUMERATED {n0, n1, n2, n3, n4, n5,
  n6, n8},
  aggregationLevel2  ENUMERATED {n0, n1, n2, n3, n4, n5,
  n6, n8},
  aggregationLevel4  ENUMERATED {n0, n1, n2, n3, n4, n5,
  n6, n8},
  aggregationLevel8  ENUMERATED {n0, n1, n2, n3, n4, n5,
  n6, n8},
  aggregationLevel16  ENUMERATED {n0, n1, n2, n3, n4, n5,
  n6, n8}
},
searchSpaceType CHOICE {
(search space type)
  -- Configures this search space as common search space (CSS) and DCI formats to
  monitor.
  common  SEQUENCE {
(common search space)
}
  ue-Specific  SEQUENCE {
(UE-specific search space)
  -- Indicates whether the UE monitors in this USS for DCI formats 0-0 and 1-0 or
for formats 0-1 and 1-1.
  formats  ENUMERATED {formats0-0-And-1-0,
formats0-1-And-1-1},
  ...
}
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI) for indicating power control command for PUCCH

Transmit power control for SRS RNTI (TPC-SRS-RNTI): used to indicate a power control command regarding an SRS

The DCI formats enumerated above may follow the definitions given in Table 23 below.

TABLE 23

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In a 5G system, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + iL : aggregation level \qquad [ Equation 1 ]$$

$${n}_{CI} : carrier index \\ {N}_{CCE , p} : total number of CCE s existing in control resource set p \\ {n}_{s , f}^{μ} : slot index \\ {M}_{s , max}^{( L )} umber of PDCCH candidates at aggregation level L \\ {m}_{s , {n}_{CI}} = 0 , … , {M}_{s , max}^{( L )} : PDCCH candidate index at aggregation level L \\ i = 0 , … , L - 1 \\ {Y}_{p , {n}_{s , f}^{μ}} = ( {A}_{p} \cdot {Y}_{p , {n}_{s , f}^{μ}} ) mod D , {Y}_{p , - 1} = {n}_{RNTI} \neq 0 , {A}_{p} = 39827 for pmod 3 = 0 , {A}_{p} = 39829 for pmod 3 = 1 , {A}_{p} = 29839 for pmod 3 = 2 , D = 65537 \\ {n}_{RNTI} : UE identity$$

The Y_{p,n}_{_{s,f}}_{^{μ}} value may correspond to 0 in the case of a common search space.

The Y_{P,n}_{_{s,f}}_{^{μ}} value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 22), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

Next, frequency domain resource assignment (FDRA) for a PDSCH and a PUSCH in NR is described.

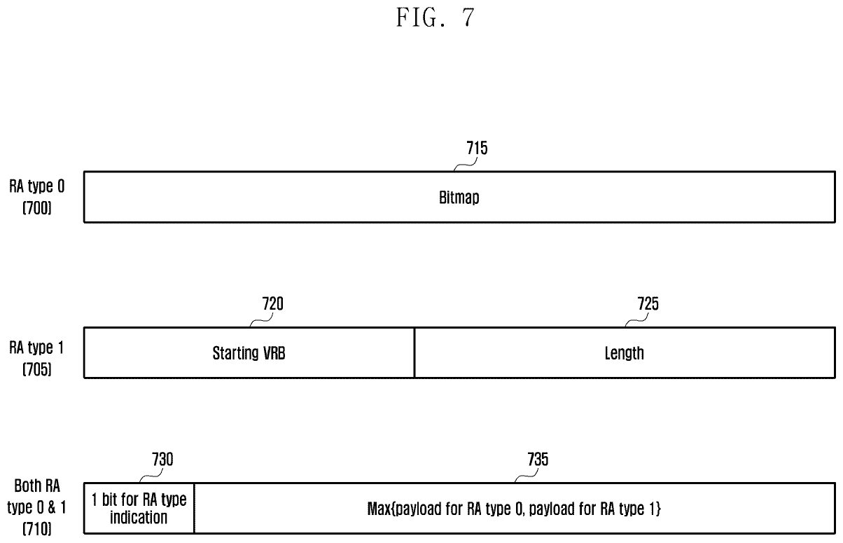

FIG. 7 illustrates an example of frequency domain resource assignment for a PDSCH and a PUSCH in a wireless communication system according to an embodiment of the disclosure.

FIG. 7 illustrates three methods for frequency domain resource assignment, including FDRA type-0 700, FDRA type-1 705, and dynamic switch 710, which are configurable through an higher layer in an NR wireless communication system.

Referring to FIG. 7, in the case of configuration 700 made through higher layer signaling where the UE is allowed to use only FDRA type-0, a part of downlink control information (DCI) for scheduling a PDSCH or PUSCH for a corresponding UE includes a bitmap configured by N_{RBG} bits. Conditions for this configuration will be described later again. In the configuration, N_{RBG} refers to the number of resource block groups (RBGs), which is determined as in Table 24 below according to the higher layer parameter rbg-Size and the size of a bandwidth part allocated by a bandwidth part indicator, and data is transmitted through an RBG indicated as 1 by the bitmap.

TABLE 24

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The size of a frequency resource of a bandwidth part may be defined as the number of RBs included in the bandwidth part. Specifically, if resource allocation of FDRA type-0 for a UE is indicated, the length of an FDRA field if DCI received by the UE is equal to the number N_{RBG} of RBs within the bandwidth part, wherein

$${N}_{RBG} = ⌈ \frac{{N}_{BWP}^{size} + ( {N}_{BWP}^{start} mod P )}{P} ⌉ .$$

Herein, the first RBG within the bandwidth part includes (RBG₀^{size}=P−N_{BWP}^{size} mod P) RBs. If (N_{BWP}^{start}+N_{BWP}^{size})mod P>0, the final RBG within the bandwidth part includes (RBGₗₐₛₜ^{size}=(N_{BWP}^{start}+N_{BWP}^{size})mod P) RBs, and if not, includes (RBGₗₐₛₜ^{size}=P) RBs. The remaining RBGs within the bandwidth part include P RBs, wherein P indicates the number of nominal RBGs determined according to Table 24.

If the UE is configured through the higher layer signaling to use only FDRA type-1 (705), DCI for allocation of a PDSCH or PUSCH for the UE includes frequency domain resource assignment (FDRA) information configured by

$$( ⌈ {log}_{2} 〚 ( {N}_{RB}^{BWP} * \frac{{N}_{RB}^{BWP} + 1}{2} 〛 ⌉ ⌉ )$$

bits wherein N_{RB}^{BWP} indicates the number of RBs included in the bandwidth part. The base station may configure the starting BRB 720 and the frequency domain resource length 725 consecutively allocated thereafter.

If the UE is configured through the higher layer signaling to use both FDRA type-0 and FDRA type-1 (710), DCI for allocation of a PDSCH or PUSCH for the UE includes frequency domain resource assignment (FDRA) information configured by bits, the number of which corresponds to the larger value among a payload 715 for configuration of FDRA type-0 resource allocation and payloads 720 and 725 for configuration of FDRA type-1 resource allocation. Conditions for this configuration will be described later again. In the configuration, one bit may be added to the foremost portion (MSB) of the frequency domain resource assignment information within the DCI, and the added bit may indicate use of FDRA type-0 resource allocation when the bit has a value of “0” and may indicate use of FDRA type-1 resource allocation when the bit has a value of “1”.

If the UE is configured through the higher layer signaling to use FDRA type-2, the UE may receive an indication about an FDRA type-2 resource allocation method from a base station according to the following method.

The UE may receive, from the base station, an indication of an interlace index set including M pieces of RB allocation information.

The interlace index m∈{0, 1, . . . , M− 1} may be configured by common RBs{m, M+m, 2M+m, 3M+m, . . . }, and M may be defined as in Table 25.

TABLE 25

| μ | M |
|---|---|
| 0 | 10 |
| 1 | 5 |

The relation between the common RB n_{CRB}^{μ} and the RB n_{IRB,m}^{μ}∈{0, 1, . . . } in the bandwidth part i and the interlace m may be defined as below.

$${n}_{CRB}^{μ} = {Mn}_{IRB , m}^{μ} + {N}_{BWP , i}^{start , μ} + ( ( m - {N}_{BWP , i}^{start , μ} ) mod M )$$

where N_{BWP}^{start,μ} is the common resource block where bandwidth part starts relative to common resource block 0. u is subcarrier spacing index

When the subcarrier spacing is 15 kHz (u=0), the UE may be notified of RB allocation information for an interlace set by the base station by using (m0+1) indexes. Further, a resource allocation field may be configured by a resource indication value (RIV). When the resource indication value satisfies a condition that

$$0 \leq RIV < \frac{M ( M + 1 )}{2}$$

and l=0, 1, . . . L−1, the resource indication value may be configured by the start interlace m0 and the consecutive interlace number L (L≥1) which has the following value.

$$if ( L - 1 ) \leq ⌊ \frac{M}{2} ⌋ then \\ RIV = M ( L - 1 ) + {m}_{0} \\ else \\ RIV = M ( M - L + 1 ) + ( M - 1 - {m}_{0} )$$

When the resource indication value satisfies a condition that

$$RIV \geq \frac{M ( M + 1 )}{2} ,$$

the resource indication value may be configured by the start interlace m0 and values of 1 as defined in Table 26 below.

TABLE 26

| $RIV - \frac{M ( M + 1 )}{2}$ | m0 | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

When the subcarrier spacing is 30 kHz (u=1), the UE may be notified of RB allocation information by the base station in the form of a bitmap indicating interlaces allocated to the UE. The size of the bitmap is M, and one bit of the bitmap corresponds to each interlace. In the interlace bitmap, mapping to the bits from the MSB to the LSB may be performed according to a sequence from interlace index 0 to interlace index (M−1).

Further, the least significant bit (LSB)

$$( Y = ⌈ log 2 \frac{{N}_{RB - set}^{BWP} ( {N}_{RB - set}^{BWP} + 1 )}{2} ⌉ ay$$

refer to consecutive RB sets of PUSCHs scheduled by DCI format 0_1, and Y bits may be configured by a resource indication value (RIV_{RBset}). In a case where

$$0 \leq {RIV}_{RBset} < \frac{{N}_{RB - set}^{BWP} ( {N}_{RB - set}^{BWP} + 1 )}{2}$$

and l=0, 1, . . . L_{RBset}−1, the RIV_{RBset} value may be defined by the start RB set (RBset_{START}) and the number (L_{RBset} (L_{RBset}≥1)) of consecutive RB sets. The RIV_{RBset} value may be defined as below.

$$if ( {L}_{RBset} - 1 ) \leq ⌊ \frac{{N}_{RB - set}^{BWP}}{2} ⌋ then \\ {RIV}_{RBset} = {N}_{RB - set}^{BWP} ( {L}_{RBset} - 1 ) + {RBset}_{START} \\ else \\ {RIV}_{RBset} = {N}_{RB - set}^{BWP} ( {N}_{RB - set}^{BWP} - {L}_{RBset} + 1 ) + ( {N}_{RB - set}^{BWP} - 1 - {RBset}_{START} )$$

Here, N_{RB-set}^{BWP} refers to the number of RBs included in the bandwidth part, and may be defined by the number of guard gaps (or bands) within a carrier configured through higher layer signaling (or pre-configured).

Hereinafter, a time domain resource allocation method regarding a data channel in a 5G system will be described.

A base station may configure a table for time domain resource allocation information regarding a physical downlink shared channel (PDSCH) and a physical uplink shared channel (PUSCH) for a UE through higher layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 27 or Table 28 below may be transmitted from the base station to the UE.

TABLE 27

```
PDSCH-TimeDomainResourceAllocationList information element
  PDSCH-TimeDomainResourceAllocationList ::= SEQUENCE (SIZE(1..maxNrofDL-
Allocations)) OF
  PDSCH-TimeDomainResourceAllocation
  PDSCH-TimeDomainResourceAllocation ::= SEQUENCE {
      k0
INTEGER(0..32)
  OPTIONAL, -- Need S
    (PDCCH-to-PDSCH timing, slot unit)
    mappingType  ENUMERATED {typeA, typeB},
    (PDSCH mapping type)
    startSymbolAndLength  INTEGER (0..127)
    (start symbol and length of PDSCH)
}
```

TABLE 28

```
PUSCH-TimeDomainResourceAllocationList information element
  PUSCH-TimeDomainResourceAllocationList ::= SEQUENCE (SIZE(1..maxNrofUL-
Allocations)) OF
  PUSCH-TimeDomainResourceAllocation
  PUSCH-TimeDomainResourceAllocation ::=  SEQUENCE {
    k2  INTEGER(0..32)  OPTIONAL, --
Need S
      (PDCCH-to-PUSCH timing, slot unit)
      mappingType  ENUMERATED {typeA, typeB},
      (PUSCH mapping type)
      startSymbolAndLength  INTEGER (0..127)
      (start symbol and length of PUSCH)
}
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

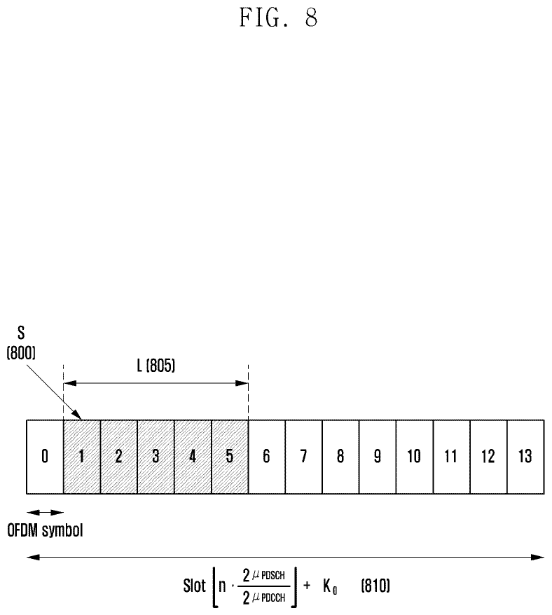

FIG. 8 illustrates an example of time domain resource assignment with regard to a PDSCH in a wireless communication system according to an embodiment of the disclosure.

Referring to FIG. 8, the base station may indicate the time domain location 810 of a PDSCH resource according to the subcarrier spacing (SCS) (PDSCH, PDCCH) of a data channel and a control channel configured by using an higher layer, the scheduling offset (K0) value, and the OFDM symbol start location 800 and length 805 within one slot dynamically indicated through DCI.

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 29 through higher signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 29 through higher signaling. If PUSCH transmission is operated by a configured grant, parameters applied to the PUSCH transmission are applied through configuredGrantConfig (higher signaling) in Table 29 except for dataScramblingIdentityPUSCH, txConfig, codebookSubset, maxRank, and scaling of UCI-OnPUSCH, which are provided by pusch-Config (higher signaling) in Table 30. If provided with transformPrecoder inside configuredGrantConfig (higher signaling) in Table 29, the UE applies tp-pi2BPSK inside pusch-Config in Table 30 to PUSCH transmission operated by a configured grant.

TABLE 29

| | |
|---|---|
| | ConfiguredGrantConfig ::= SEQUENCE { |
| | frequencyHopping ENUMERATED {intraSlot, interSlot} |
| | OPTIONAL, -- Need S, |
| | cg-DMRS-Configuration DMRS-UplinkConfig, |
| | mcs-Table ENUMERATED {qam256, qam64LowSE} |
| | OPTIONAL, -- Need S |
| | mcs-TableTransformPrecoder ENUMERATED {qam256, qam64LowSE} |
| | OPTIONAL, -- Need S |
| | uci-OnPUSCH SetupRelease { CG-UCI-OnPUSCH } |
| | OPTIONAL, -- Need M |
| | resource Allocation ENUMERATED { resourceAllocation Type0, |
| | resourceAllocationType1, dynamicSwitch }, |
| | rbg-Size ENUMERATED {config2} |
| | OPTIONAL, -- Need S |
| | powerControlLoopToUse ENUMERATED {n0, n1}, |
| | p0-PUSCH-Alpha P0-PUSCH-AlphaSetId, |
| | transformPrecoder ENUMERATED {enabled, disabled} |
| | OPTIONAL, -- Need S |
| | nrofHARQ-Processes INTEGER(1..16), |
| | repK ENUMERATED {n1, n2, n4, n8}, |
| | repK-RV ENUMERATED {s1-0231, s2-0303, s3-0000} |
| | OPTIONAL, -- Need R |
| | periodicity ENUMERATED { |
| | sym2, sym7, sym1x14, sym2x14, sym4x14, sym5x14, |
| | sym8x14, sym10x14, sym16x14, sym20x14, |
| | sym32x14, sym40x14, sym64x14, sym80x14, sym128x14, |
| | sym160x14, sym256x14, sym320x14, sym512x14, |
| | sym640x14, sym1024x14, sym1280x14, sym2560x14, |
| | sym5120x14, |
| | sym6, sym1x12, sym2x12, sym4x12, sym5x12, sym8x12, |
| | sym10x12, sym16x12, sym20x12, sym32x12, |
| | sym40x12, sym64x12, sym80x12, sym128x12, sym 160x12, |
| | sym256x12, sym320x12, sym512x12, sym640x12, |
| | sym1280x12, sym2560x12 |
| | }, |
| | configuredGrantTimer INTEGER (1..64) |
| | OPTIONAL, -- Need R |
| | rrc-ConfiguredUplinkGrant SEQUENCE { |
| | timeDomainOffset INTEGER (0..5119), |
| | timeDomainAllocation INTEGER (0..15), |
| | frequencyDomainAllocation BIT STRING (SIZE(18)), |
| | antennaPort INTEGER (0..31) |
| | dmrs-SeqInitialization INTEGER (0..1) |
| | OPTIONAL, -- Need R |
| | precodingAndNumberOfLayers INTEGER (0..63), |
| | srs-ResourceIndicator INTEGER (0..15) |
| | OPTIONAL, -- Need R |
| | mcsAndTBS INTEGER (0..31), |
| | frequencyHoppingOffset INTEGER (1..maxNrofPhysicalResourceBlocks- |
| | 1) OPTIONAL, -- Need R |
| | pathlossReferenceIndex INTEGER (0..maxNrofPUSCH- |
| | PathlossReferenceRSs-1), |
| | ... |
| | } OPTIONAL, -- |
| | Need R |
| | ... |
| } | |

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 30, which is higher signaling, is “codebook” or “nonCodebook”.

As described above, PUSCH transmission may be dynamically scheduled through DCI format 0_0 or 01, and may be operated semi-statically configured by a configured grant. Upon receiving indication of scheduling regarding PUSCH transmission through DCI format 0_0, the UE performs beam configuration for PUSCH transmission by using pucch-spatialRelationInfoD corresponding to a UE-specific PUCCH resource corresponding to the minimum TD inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 30, the UE does not expect scheduling through DCI format 0_1.

TABLE 30

```
PUSCH-Config ::=  SEQUENCE {
  dataScramblingIdentityPUSCH  INTEGER (0..1023)
OPTIONAL, -- Need S
  txConfig  ENUMERATED {codebook, nonCodebook}
OPTIONAL, -- Need S
  dmrs-UplinkForPUSCH-MappingTypeA SetupRelease { DMRS-UplinkConfig }
OPTIONAL, -- Need M
  dmrs-UplinkForPUSCH-MappingTypeB SetupRelease { DMRS-UplinkConfig }
OPTIONAL, -- Need M
  pusch-PowerControl  PUSCH-PowerControl
OPTIONAL, -- Need M
  frequencyHopping  ENUMERATED {intraSlot, interSlot}
OPTIONAL, -- Need S
  frequencyHoppingOffsetLists SEQUENCE (SIZE (1..4)) OF INTEGER (1..
maxNrofPhysicalResourceBlocks-1)
                                                        OPTIONAL, -- Need
M
  resourceAllocation  ENUMERATED { resourceAllocationType0,
resourceAllocationType1, dynamicSwitch},
  pusch-TimeDomainAllocationList SetupRelease { PUSCH-
TimeDomainResourceAllocationList } OPTIONAL, -- Need M
  pusch-AggregationFactor ENUMERATED { n2, n4, n8 }
OPTIONAL, -- Need S
  mcs-Table  ENUMERATED {qam256, qam64LowSE}
OPTIONAL, -- Need S
  mcs-TableTransformPrecoder ENUMERATED {qam256, qam64LowSE}
OPTIONAL, -- Need S
  transformPrecoder  ENUMERATED {enabled, disabled}
OPTIONAL, -- Need S
  codebookSubset  ENUMERATED {fullyAndPartialAndNonCoherent,
partialAndNonCoherent,nonCoherent}
                                                  OPTIONAL, -- Cond
codebookBased
  maxRank  INTEGER (1..4)  OPTIONAL, --
Cond codebookBased
  rbg-Size  ENUMERATED { config2}
OPTIONAL, -- Need S
  uci-OnPUSCH  SetupRelease { UCI-OnPUSCH}
OPTIONAL, -- Need M
  tp-pi2BPSK  ENUMERATED {enabled }
OPTIONAL, -- Need S
  ...
}
```

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (higher signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (higher signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (higher signaling). In connection with codebook-based PUSCH transmission, the UE determines a codebook subset, based on codebookSubset inside pusch-Config (higher signaling) and TPMI. The codebookSubset inside pusch-Config (higher signaling) may be configured to be one of “fullyAndPartialAndNonCoherent”, “partialAndNonCoherent”, or “noncoherent”, based on UE capability reported by the UE to the base station. If the UE reported “partialAndNonCoherent′” as UE capability, the UE does not expect that the value of codebookSubset (higher signaling) will be configured as “fullyAndPartialAndNonCoherent”. In addition, if the UE reported “nonCoherent” as UE capability, UE does not expect that the value of codebookSubset (higher signaling) will be configured as “fullyAndPartialAndNonCoherent” or “partialAndNonCoherent”. If nrofSRS-Ports inside SRS-ResourceSet (higher signaling) indicates two SRS antenna ports, the UE does not expect that the value of codebookSubset (higher signaling) will be configured as “partialAndNonCoherent”.

The UE may have one SRS resource set configured therefor, wherein the value of usage inside SRS-ResourceSet (higher signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE expects that the value of nrofSRS-Ports inside SRS-Resource (higher signaling) is identical for all SRS resources.

The UE transmits, to the base station, one or multiple SRS resources included in the SRS resource set wherein the value of usage is configured as “codebook” according to higher signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station may add information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (higher signaling) is “nonCodebook”, non-codebook-based PUSCH transmission may be scheduled for the UE through DCI format 0_1.

With regard to the SRS resource set wherein the value of usage inside SRS-ResourceSet (higher signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (higher signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (higher signaling). With regard to non-codebook-based transmission, the UE does not expect that spatialRelationInfo which is higher signaling regarding the SRS resource and associatedCSI-RS inside SRS-ResourceSet (higher signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (higher signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (higher signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in an NR system in consideration thereof. The PUSCH preparation procedure time of the UE may follow Equation 2 given below.

$${T}_{proc , 2} = max ( ( {N}_{2} + {d}_{2 , 1} + {d}_{2} ) ( 2048 + 144 ) {κ2}^{- μ} {T}_{c} + {T}_{ext} + {T}_{switch} , {d}_{2 , 2} ) \qquad [ Equation 2 ]$$

Each parameter in T_{proc,2} described above in Equation 2 may have the following meaning.
N₂: the number of symbols determined according to UE processing capability 1 or 2, based on the UE's capability, and numerology μ. N₂ may have a value in Table 31 if UE processing capability 1 is reported according to the UE's capability report, and may have a value in Table 32 if UE processing capability 2 is reported, and if availability of UE processing capability 2 is configured through higher layer signaling.

TABLE 31

| μ | PUSCH preparation time N₂ [symbols] |
|---|---|
| 0 | 10 |
| 1 | 12 |
| 2 | 23 |
| 3 | 36 |

TABLE 32

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.
T_{c}: has

$$\frac{1}{Δ {f}_{max} \cdot {N}_{f}} , Δ {f}_{max} = 480 \cdot {10}^{3} Hz , {N}_{f} = 4096 {…}_{2} :$$

follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

Hereinafter, repetitive transmission of an uplink data channel in a 5G system will be described in detail. A 5G system supports two types of methods for repeatedly transmitting an uplink data channel, PUSCH repetitive transmission type A and PUSCH repetitive transmission type B. One of PUSCH repetitive transmission type A and type B may be configured for a UE through higher layer signaling.

Firstly, PUSCH repetitive transmission type A will be described.

As described above, the symbol length of an uplink data channel and the location of the start symbol may be determined by a time domain resource allocation method in one slot, and a base station may notify a UE of the number of repetitive transmissions through higher layer signaling (for example, RRC signaling) or L1 signaling (for example, DCI).

Based on the number of repetitive transmissions received from the base station, the UE may repeatedly transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE omits uplink data channel transmission, but counts the number of repetitive transmissions of the uplink data channel. That is, although included in the number of repetitive transmissions of the uplink data channel, the uplink data channel may not be transmitted. Contrarily, the UE supporting Rel-17 uplink data repetitive transmission may determine a slot capable of uplink data repetitive transmission as an available slot, and may count the number of transmissions during uplink data channel repetitive transmission in the slot determined as an available slot. If uplink data channel repetitive transmission is omitted in the slot determined as an available slot, the UE may postpone uplink data channel repetitive transmission till a next available slot without counting the corresponding omitted repetitive transmission and then transmit same.

In order to determine an available slot as described above, if at least one symbol configured for a PUSCH by time domain resource allocation (TDRA) in a slot for PUSCH transmission overlaps a symbol for purposes other than uplink transmission (for example, downlink transmission), the corresponding slot is determined as an unavailable slot (for example, a slot other than an available slot, which is determined as being unavailable for PUSCH transmission). In addition, an available slot may be considered a resource for PUSCH transmission and an uplink resource for determining a transport block size (TBS) in PUSCH repeated transmission and multi-slot PUSCH transmission including one TB (TBoMS (transport block on multiple slots)).

Second, PUSCH repetitive transmission type B will be discussed hereinafter.
As described above, the start symbol of an uplink data channel and the length of the start symbol may be determined by a time domain resource allocation method in one slot, and a base station may notify a UE of the number of repetitive transmissions through higher layer signaling (for example, RRC signaling) or L1 signaling (for example, DCI).
First, based on the configured start symbol of the uplink data channel and the length thereof, nominal repetition of an uplink data channel is determined as below. A slot at which the n-th nominal repetition starts is given by

$${K}_{s} + ⌊ \frac{S + n \cdot L}{{N}_{symb}^{slot}} ⌋ ,$$

and a symbol starting at the slot is given by mod(S+n·L,N_{symb}^{slot}). A slot at which the n-th nominal repetition ends is given by

$${K}_{s} + ⌊ \frac{S + ( n + 1 ) \cdot L - 1}{{N}_{symb}^{slot}} ⌋ ,$$

and a symbol starting at the slot is given by mod(S+(n+1)·L− 1, N_{symb}^{slot}). Here, symb n=0, . . . , (number of repetitions−1), S indicates the configured start symbol of uplink data channel, L indicates the configured symbol length of the uplink data channel, Kₛ indicates a slot at which the PUSCH transmission starts, and N_{symb}^{slot} indicates the number of symbols for each slot.
For PUSCH repetitive transmission type B, the UE may determine a specific OFDM symbol as an invalid symbol in the cases as follows:
a symbol configured for downlink by tdd-UL-DL-ConfigurationCommon or tdd-UL-DL-ConfigurationDedicated may be determined as an invalid symbol for PUSCH repetitive transmission type B;
symbols indicated as ssb-PositionsInBurst within ServingCellConfigCommon,which is higher layer signaling, or ssb-PositionsInBurst within SIB1 for reception of SSB in an Unpaired spectrum (TDD spectrum) may be determined as invalid symbols for PUSCH repetitive transmission type B;
symbols indicated through pdcch-ConfigSIB1 within MIB in order to transmit a control resource set connected to Type0-PDCCH CSS set in an Unpaired spectrum (TDD spectrum) may be determined as invalid symbols for PUSCH repetitive transmission type B; and
in case that numberOfInvalidSymbolsForDL-UL-Switching, which is higher layer signaling, in an Unpaired spectrum (TDD spectrum) is configured, symbols during numberOfInvalidSymbolsForDL-UL-Switching from symbols configured for downlink by tdd-UL-DL-ConfigurationCommon or tdd-UL-DL-ConfigurationDedicated may be determined as invalid symbols.
Additionally, an invalid symbol may be configured by an higher layer parameter (for example, InvalidSymbolPattern). An higher layer parameter (for example, InvalidSymbolPattern) may provide a symbol level bitmap over one slot or two slots to enable configuration of an invalid symbol. In the bitmap, 1 indicates an invalid symbol. Additionally, through an higher layer parameter (for example, periodicityAndPattern), the period and pattern of the bitmap may be configured. If an higher layer parameter (for example, InvalidSymbolPattern) is configured and InvalidSymbolPatternIndicator-ForDCIFormat0_1 or InvalidSymbolPatternIndicator-ForDCIFormat0_2 parameter indicates 1, the UE applies the invalid symbol pattern, and if the parameter indicates 0, the UE does not apply the invalid symbol pattern. If an higher layer parameter (for example, InvalidSymbolPattern) is configured and InvalidSymbolPatternIndicator-ForDCIFormat0_1 or InvalidSymbolPatternIndicator-ForDCIFormat0_2 parameter is not configured, the UE applies the invalid symbol pattern.

After an invalid symbol is determined, the UE may additionally take, for each nominal repetition, symbols other than the invalid symbol into consideration for invalid symbols. In case that each nominal repetition includes one or more valid symbols, the nominal repetition may include one or more actual repetitions. Each of the actual repetitions includes a set of consecutive valid symbols usable for PUSCH repetitive transmission type B in one slot. In case that the length of the nominal repetition is not 1, the UE may disregard transmission of an actual repetition having a length of 1.

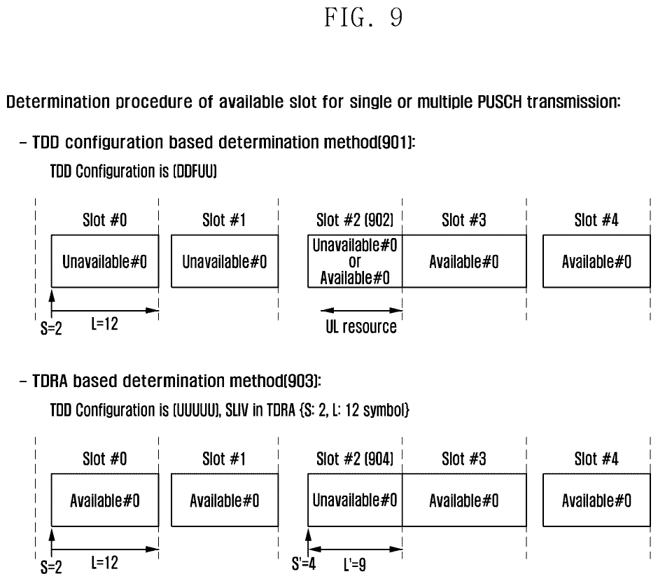

FIG. 9 illustrates an example of a method for determining an available slot at the time of transmission by a UE according to PUSCH repetitive transmission type A in a 5G system.

In case of configuring an uplink resource through higher layer signaling (for example, tdd-UL-DL-ConfigurationCommon or tdd-UL-DL-ConfigurationDedicated) or L1 signaling (for example, dynamic slot format indicator), a base station may determine an available slot for the configured uplink resource, according to the following two methods:
method of determining an available slot based on TDD configuration; and
method of determining an available slot in consideration of TDD configuration and time domain resource allocation (TDRA), CG (Configured grant) configuration or activation DCI.

As noted from FIG. 9, as an example of a method 901 for determining an available slot based on TDD configuration, in case that a TDD configuration is configured as “DDFUU” through higher layer signaling, a base station and a UE may determine, based on the TDD configuration, slot #3 and slot #4 configured for uplink “U”, as available slots. Also, the base station and the UE may determine slot #2 (‘L=9’≤SLIV ‘L=12’) as unavailable slots (904). This example is just a simple example not limited to the PUSCH transmission, and may be applied to cases of PUCCH transmission, PUSCH/PUCCH repetitive transmission, nominal repetition of PUSCH repetition type B, or TBoMS.

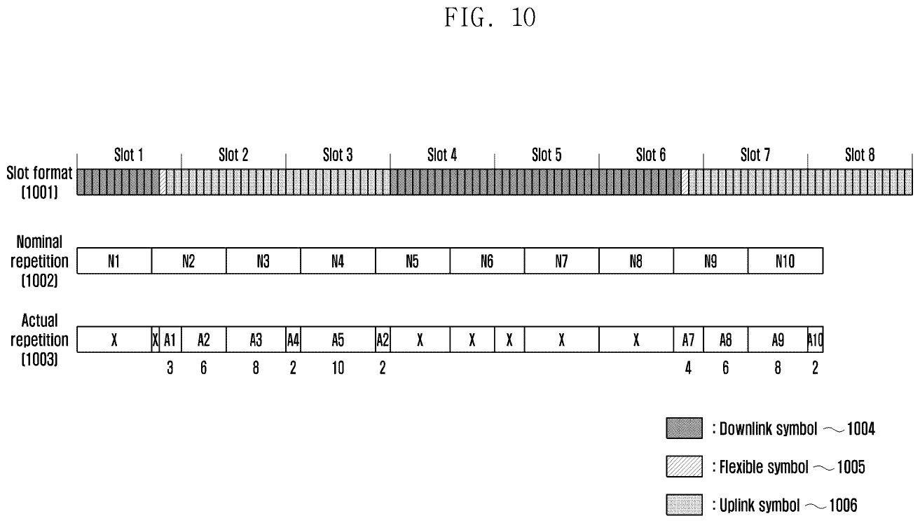

FIG. 10 illustrates an example of PUSCH repetitive transmission type B in a wireless communication system.

As noted from FIG. 10, in the slot format 1001, each of slots #1 and #6 includes all of a DL symbol 1004, a flexible symbol 1005, and a UL symbol 1006, slots #2, #3, and #8 are uplink slots, and slots #4 and #5 are downlink slots. The UE may receive a configuration wherein a start symbol S of an uplink data channel is 0, the length L of the uplink data channel is 14, and the number of times of repetitive transmission is 16. In this case, the nominal repetition is expressed in 16 consecutive slots (1002). Then, the UE may determine, as an invalid symbol, a symbol configured for downlink in each nominal repetition 1002. Further, the UE may determine, as invalid symbols, symbols configured as 1 in the invalid symbol pattern. In case that valid symbols other than invalid symbols in each nominal repetition are configured as one or more consecutive symbols in one slot, the valid symbols are configured as transmitted as actual repetition (1003).

In addition, with regard to PUSCH repetitive transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repetitive transmissions are scheduled inside one slot or across the boundary of consecutive slots. In connection with method 1, time domain resource allocation information inside DCI indicates resources of the first repetitive transmission. In addition, time domain resource information of remaining repetitive transmissions may be determined according to time domain resource information of the first repetitive transmission, and the uplink or downlink direction determined with regard to each symbol of each slot. Each repetitive transmission occupies consecutive symbols.
Method 2 (multi-segment transmission): through one UL grant, two or more PUSCH repetitive transmissions are scheduled in consecutive slots. Transmission no. 1 may be designated with regard to each slot, and the start point or repetition length may differ between respective transmission. In method 2, time domain resource allocation information inside DCI indicates the start point and repetition length of all repetitive transmissions. In the case of performing repetitive transmissions inside a single slot through method 2, if there are multiple bundles of consecutive uplink symbols in the corresponding slot, respective repetitive transmissions may be performed with regard to respective uplink symbol bundles. If there is a single bundle of consecutive uplink symbols in the corresponding slot, PUSCH repetitive transmission is performed once according to the method of NR Release 15.
Method 3: two or more PUSCH repetitive transmissions are scheduled in consecutive slots through two or more UL grants. Transmission no. 1 is designated for each slot, and the nth UL grant may be received before PUSCH transmission scheduled by the (n−1)th UL grant is over.
Method 4: through one UL grant or one configured grant, one or multiple PUSCH repetitive transmissions inside a single slot, or two or more PUSCH repetitive transmissions across the boundary of consecutive slots may be supported. The number of repetitions indicated to the UE by the base station is only a nominal value, and the UE may actually perform a larger number of PUSCH repetitive transmissions than the nominal number of repetitions. Time domain resource allocation information inside DCI or configured grant refers to resources of the first repetitive transmission indicated by the base station. Time domain resource information of remaining repetitive transmissions may be determined with reference to resource information of the first repetitive transmission and the uplink or downlink direction of symbols. If time domain resource information of a repetitive transmission indicated by the base station spans a slot boundary or includes an uplink/downlink switching point, the corresponding repetitive transmission may be divided into multiple repetitive transmissions. One repetitive transmission may be included in one slot with regard to each uplink period.

Hereinafter, frequency hopping of a physical uplink shared channel (PUSCH) in a 5G system will be described in detail.

5G supports two kinds of PUSCH frequency hopping methods with regard to each PUSCH repetitive transmission type. First of all, in PUSCH repetitive transmission type A, intra-slot frequency hopping and inter-slot frequency hopping are supported, and in PUSCH repetitive transmission type B, inter-repetition frequency hopping and inter-slot frequency hopping are supported.

The intra-slot frequency hopping method supported in PUSCH repetitive transmission type A is a method in which a UE transmits allocated resources in the frequency domain, after changing the same by a configured frequency offset, by two hops in one slot. The start RB of each hop in connection with intra-slot frequency hopping may be expressed by Equation 3 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 3 ]$$

In Equation 3, i=0 and i=1 denotes the first and second hops, respectively, and RBₛₜₐᵣₜ denotes the start RB in a UL BWP and is calculated from a frequency resource allocation method. RB_{offset} denotes a frequency offset between two hops through an higher layer parameter. The number of symbols of the first hop may be represented by

$$⌊ \frac{{N}_{symb}^{PUSCH , s}}{2} ⌋ ,$$

and number of symbols of the second hop may be represented by

$${N}_{symb}^{PUSCH , s} - ⌊ \frac{{N}_{symb}^{PUSCH , s}}{2} ⌋ . {N}_{symb}^{PUSCH , s}$$

is the length of PUSCH transmission in one slot and is expressed by the number of OFDM symbols.

Next, the inter-slot frequency hopping method supported in PUSCH repetitive transmission types A and B is a method in which the UE transmits allocated resources in the frequency domain, after changing the same by a configured frequency offset, in each slot. The start RB during nₛ^{μ} slots in connection with inter-slot frequency hopping may be expressed by Equation 4 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 4 ]$$

In Equation 4, nₛ^{μ} denotes the current slot number during multi-slot PUSCH transmission, and RBₛₜₐᵣₜ denotes the start RB inside a UL BWP and may be calculated from a frequency resource allocation method. RB_{offset} may denote a frequency offset between two hops through an higher layer parameter.

The inter-repetition frequency hopping method supported in PUSCH repetitive transmission type B is a method in which resources allocated in the frequency domain regarding one or multiple actual repetitions in each nominal repetition are moved by a configured frequency offset and then transmitted. The index RBₛₜₐᵣₜ(n) of the start RB in the frequency domain regarding one or multiple actual repetitions in the nth nominal repetition may follow Equation 5 below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad [ Equation 5 ]$$

In Equation 5, n denotes the index of nominal repetition, and RB_{offset} denotes an RB offset between two hops through an higher layer parameter.

Hereinafter, UE capability report procedure will be described. In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE configures UE capability according to band information and RAT type requested by the base station. The method in which the UE configures UE capability in an NR system is summarized below.

1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.

4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr→eutra-nr→eutra) In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

In 5G services, additional coverage expansion technology has been introduced compared to LTE communication services, but in actual 5G mobile communication services, TDD systems suitable for services with a high proportion of downlink traffic may be used. In addition, as the center frequency increases to increase the frequency band, the coverage of base stations and the UEs decreases, and coverage enhancement may be a key requirement in 5G mobile communication services. In particular, it is important to improve the coverage of uplink channels because the transmission power of the UE is lower than that of the base station, to support services with a high proportion of downlink traffic, and because the ratio of downlinks in the time domain is higher than the uplink. As a method of physically improving the coverage of the uplink channel between the base station and the UE, there may be a method of increasing the time resource of the uplink channel, lowering the center frequency, or increasing the transmission power of the UE. However, changing the frequency may be limited because the frequency band is determined for each network operator. In addition, since the maximum transmission power of the UE is regulated to reduce interference, there may be restrictions on increasing the maximum transmission power of the UE to improve coverage.

Accordingly, in order to improve the coverage of base stations and UEs, uplink and downlink resources may be divided not only in the time domain according to the proportion of uplink and downlink traffics as in the TDD system, but also in the frequency domain as in the FDD system. In an embodiment, a system capable of flexibly dividing uplink and downlink resources in the time domain and frequency domain may be referred to as an XDD system, a flexible TDD system, a hybrid TDD system, a TDD-FDD system, a hybrid TDD-FDD system, and the like, and for convenience of explanation, this will be described as an XDD system in the disclosure. According to an embodiment, X in XDD may refer to time or frequency.

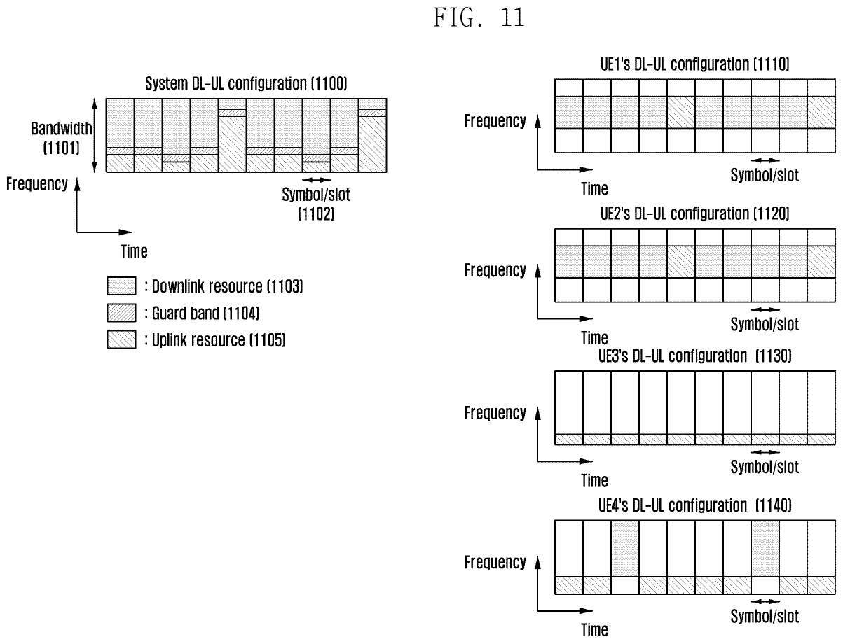

FIG. 11 illustrates an example of an uplink-downlink resource configuration of an XDD system in which resources of uplink and downlink are flexibly divided in the time domain and frequency domain, according to an embodiment of the disclosure.

Referring to FIG. 11, from the perspective of the base station, in the uplink-downlink configuration 1100 of the overall XDD system, resources may be flexibly allocated to each symbol or slot 1102 according to the proportion of uplink and downlink traffic for the entire frequency band 1101. However, this is only an example, and the unit in which resources are allocated is not limited to symbols or slots 1102, and resources maybe flexibly allocated depending on units such as mini-slots. In this case, a guard band 1104 maybe allocated between the frequency band of the downlink resource 1103 and the frequency band of the uplink resource 1105. The guard band 1104 may be allocated as a way to reduce interference inflicted on the uplink channel or signal reception by out-of-band emission that occurs when the base station transmits the downlink channel or signal in the downlink resource 1103.

In this case, as an example, a UE 1 1110 and a UE 2 1120, whose downlink traffic is generally more than uplink traffic due to the configurations of the base station, may be allocated a downlink to uplink resource ratio of 4:1 in the time domain. Simultaneously, a UE 3 1130, which lacks uplink coverage because of operating at the cell edge, may only be allocated uplink resources in a specific time period by the configurations of the base station. Additionally, a UE 4 1140, which lacks uplink coverage because of operating at the cell edge but has a relatively high amount of downlink and uplink traffic, may be allocated a lot of uplink resources in the time domain and a lot of downlink resources in the frequency band for uplink coverage.

As in the example described above, there is an advantage that more downlink resources may be allocated in the time domain to UEs with relatively more downlink traffic operating at the cell center, and more uplink resources may be allocated in the time domain to UEs with relatively insufficient uplink coverage operating at the cell edge.

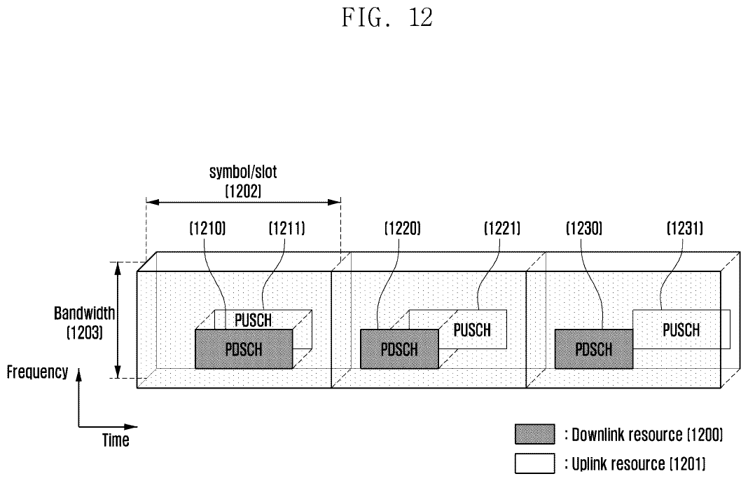

FIG. 12 illustrates an example of an uplink-downlink resource configuration in a full duplex communication system in which uplink and downlink resources are flexibly divided in the time domain and frequency domain.

According to an example illustrated in FIG. 12, the whole or part of the downlink resource 1200 and the uplink resource 1201 may be configured to overlap in the time and frequency domains. Downlink transmission from the base station to the UE may be performed in the area configured as the downlink resource 1200, and uplink transmission from the UE to the base station may be performed in the area configured as the uplink resource 1201.

In an example of FIG. 12, the entire downlink resource 1210 and the uplink resource 1211 may be configured to overlap in the time resource corresponding to the symbol or slot 1202 and the frequency resource corresponding to the bandwidth 1203. In this case, since the downlink resource 1210 and the uplink resource 1211 overlap in time and frequency, downlink and uplink transmission/reception by the base station or the UE may occur simultaneously in the same time and frequency resources.

In another example of FIG. 12, a part of the downlink resource 1220 and the uplink resource 1221 may be configured to overlap in the time resource corresponding to the symbol or slot and the frequency resource corresponding to the bandwidth 1203. In this case, downlink and uplink transmission/reception by the base station or the UE may occur simultaneously in a partial area where the downlink resource 1220 and the uplink resource 1221 overlap.

In another example of FIG. 12, the downlink resource 1230 and the uplink resource 1231 may be configured not to overlap in the time resource corresponding to the symbol or slot and the frequency resource corresponding to the bandwidth 1203.

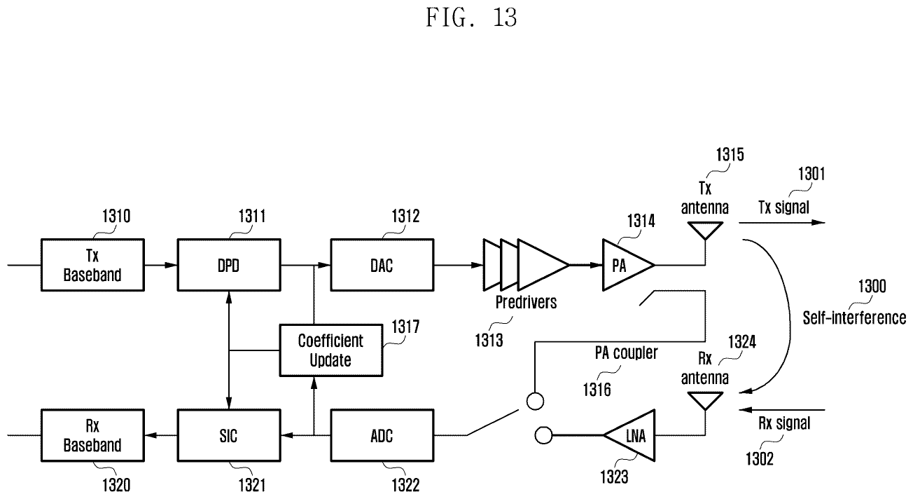

FIG. 13 illustrates a transmission/reception structure for a duplex method according to an embodiment of the disclosure.

The transmission/reception structure illustrated in FIG. 13 may be used in a base station device or a UE device. According to the transmission/reception structure illustrated in FIG. 13, the transmission end may consist of blocks such as a transmission baseband block (Tx baseband) 1310, a digital pre-distortion block (DPD) 1311, a digital-to-analog converter (DAC) 1312, a pre-driver 1313, a power amplifier (PA) 1314, and a transmission antenna (Tx antenna) 1315, and the like. Each block may perform the following roles.
Transmission baseband block 1310: Digital processing block for transmission signals
Digital pre-distortion block 1311: Performs pre-distortion of digital transmission signals
Digital-to-analog converter 1312: Converts digital signals to analog signals
Pre-Driver 1313: Progressive power amplification of analog transmission signals
Power Amplifier 1314: Power amplification of analog transmission signals
Transmission antenna 1315: Antenna for signal transmission

According to the transmission/reception structure illustrated in FIG. 13, the reception end may consist of a reception antenna (Rx antenna) 1324, a low noise amplifier (LNA) 1323, an analog-to-digital converter (ADC) 1322, a successive interference canceller 1321, and a reception baseband block (Rx baseband) 1320, and the like. Each block may perform the following roles.
Reception antenna 1324: Antenna for signal reception
Low-noise amplifier 1323: Amplifies the power of the analog reception signal while minimizing noise amplification
Analog to digital converter 1322: Converts analog signals to digital signals
Successive interference canceller 1321: Interference canceller for digital signals
Reception baseband block 1320: Digital processing block for reception signals

According to the transmission/reception structure illustrated in FIG. 13, for additional signal processing between the transmission end and the reception end, a power amplifier coupler (PA coupler) 1316 and a coefficient update block 1317 may exist. Each block may perform the following roles.

Power amplifier coupler 1316: Block for the purpose of observing the waveform of the analog transmission signal passing through the power amplifier at the reception end

Coefficient update block 1317: Updates various coefficients required for digital domain signal processing of the transmission end and the reception end, and the coefficients calculated here may be used to set various parameters in the DPD block 1311 of the transmission end and the SIC block 1321 of the reception end.

The transmission/reception structure illustrated in FIG. 13 may be used to effectively control interference between transmission and reception signals when transmission and reception are performed simultaneously in the base station or UE device. For example, when transmission and reception occur simultaneously in an arbitrary device, the transmission signal 1301 transmitted through the transmission antenna 1315 of the transmission end may be received through the reception antenna 1324 of the reception end, and in this case, the transmission signal 1301 received by the reception end may cause interference 1300 to the reception signal 1302 originally intended to be received by the reception end. The interference between the transmission signal 1301 and the reception signal 1302 received by the reception end is referred to as self-interference 1300.

For example, to be specific, if the base station device performs downlink transmission and uplink reception simultaneously, the downlink signal transmitted by the base station may be received by the reception end of the base station, which may cause interference at the reception end of the base station between the downlink signal transmitted by the base station and the uplink signal that the base station originally intended to receive at the reception end. If the UE device performs downlink reception and uplink transmission simultaneously, the uplink signal transmitted by the UE may be received by the reception end of the UE, which may cause interference at the reception end of the UE between the uplink signal transmitted by the UE and the downlink signal that the UE originally intended to receive at the reception end. In this way, interference between links in different directions in the base station and the UE device, that is, interference between the downlink signal and the uplink signal, is also called cross-link interference.

In an embodiment of the disclosure, self-interference between a transmission signal (or downlink signal) and a reception signal (or uplink signal) may occur in a system where transmission and reception may occur simultaneously.

As an example, magnetic interference may occur in the XDD system described above.

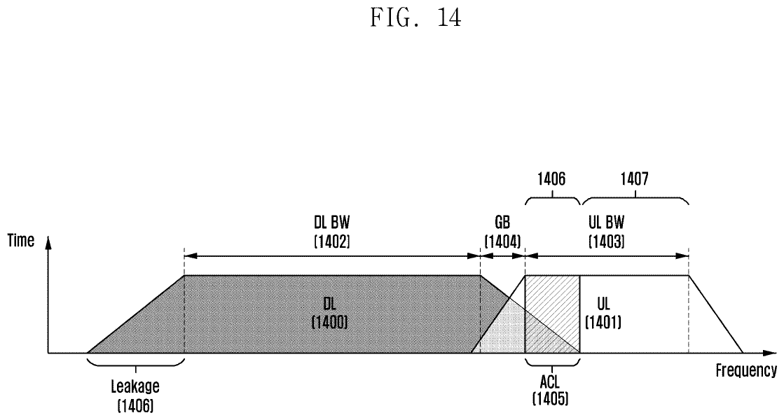

FIG. 14 is a graph for describing an example of downlink and uplink resource configurations in an XDD system.

In the case of XDD, the downlink resource 1400 and the uplink resource 1401 may be distinguished from each other in the frequency domain, and in this case, a guard band (GB) 1404 may exist between the downlink resource 1400 and the uplink resource 1401. Actual downlink transmission may be performed within the downlink bandwidth 1402, and uplink transmission may be performed within the actual uplink bandwidth 1403. In this case, leakage 1406 may occur outside the uplink or downlink transmission band. Interference (also may be referred to as adjacent carrier leakage (ACL) 1405) due to such leakage may occur in an area adjacent to the downlink resource 1400 and the uplink resource 1401.

FIG. 14 illustrates an example in which the ACL 1405 from the downlink 1400 to the uplink 1401 occurs. As the downlink bandwidth 1402 and the uplink bandwidth 1403 are closer together, the effect of signal interference by the ACL 1405 may increase, and accordingly, performance degradation may occur. As an example, as illustrated in FIG. 14, some resource areas 1406 within the uplink band 1403 adjacent to the downlink band 1402 may be greatly affected by interference by the ACL 1405. In some resource areas 1407 within the uplink band 1403 relatively far from the downlink band 1402, interference effects by the ACL 1405 may be reduced. That is, within the uplink band 1403, there may be resource areas 1406 that are relatively affected by interference and resource areas 1407 that are relatively less affected by interference.

For the purpose of reducing the performance degradation caused by the ACL 1405, the guard band 1404 may be inserted between the downlink bandwidth 1402 and the uplink bandwidth 1403. As the size of the guard band 1404 increases, the interference effect due to the ACL 1405 between the downlink bandwidth 1402 and the uplink bandwidth 1403 may decrease, but as the size of the guard band 1404 increases, resources that may be used for transmission and reception may decrease, and thus there may be a disadvantage in that resource efficiency may decrease. Conversely, as the size of the guard band 1404 decreases, the amount of resources that may be used for transmission and reception may increase, thereby increasing resource efficiency, but there is a disadvantage in that the interference effect due to the ACL 1405 between the downlink bandwidth 1402 and the uplink bandwidth 1403 may increase. Accordingly, it may be important to determine the appropriate size of the guard band 1404 by considering trade-offs.

Meanwhile, in 3GPP, the subband non-overlapping full duplex (SBFD) is being discussed as a new duplex method based on NR. The SBFD is a technology that expands the uplink coverage of the UE by receiving uplink transmission from the UE as much as the increased uplink resources by utilizing some of the downlink resources as uplink resources in the TDD band (spectrum) of frequencies below 6 GHz or above 6 GHz, and reduces feedback delay by receiving feedback on downlink transmission from the UE in the expanded uplink resources. In the disclosure, a UE capable of receiving information on whether SBFD is supported from the base station and performing uplink transmission in a part of downlink resources may be referred to as an SBFD-capable UE for convenience. To define the SBFD method in the standard and in order for the SBFD UE to determine whether the SBFD is supported in a specific cell (or frequency, frequency band), the following methods may be considered.

First method. In addition to the frame structure type of the existing unpaired spectrum (or time division duplex, TDD) or paired spectrum (or frequency division duplex, FDD), another frame structure type (e.g., frame structure type 2) may be introduced to define the above SBFD. The frame structure type 2 may be defined to be supported in the specific frequency or frequency band, or the base station may indicate to the UE whether SBFD is supported by system information. The SBFD UE may receive system information including whether the SBFD is supported and determine whether the SBFD is supported in the specific cell (or frequency, frequency band).

Second method. It may be indicated whether the SBFD is additionally supported at a specific frequency or frequency band of the existing unpaired spectrum (or TDD) without defining a new frame structure type. In the second method, it is possible to define whether the SBFD is additionally supported at the specific frequency or frequency band of the existing unpaired spectrum, or the base station may indicate to the UE whether SBFD is supported through system information. The SBFD UE may receive system information including whether the SBFD is supported and determine whether the SBFD is supported in the specific cell (or frequency, frequency band).

Information on whether SBFD is supported in the first and second methods may be information (e.g., SBFD resource configuration information in FIG. 5 described later) indicating whether SBFD is supported indirectly by configuring a part of the downlink resource as the uplink resource in addition to the configuration of TDD UL-DL resource configuration information indicating the downlink slot (or symbol) resource and uplink slot (or symbol) resource of the TDD, or may be information directly indicating whether SBFD is supported.

In the disclosure, the SBFD UE may acquire cell synchronization by receiving a synchronization signal block at initial cell access for accessing a cell (or base station). The process of acquiring cell synchronization may be the same for the SBFD UE and the existing TDD UE. Thereafter, the SBFD UE may determine whether the cell supports SBFD through an MIB acquisition, SIB acquisition, or random access process.

The system information for transmitting the information on whether the SBFD is supported may be system information transmitted separately from the system information for a UE (e.g., an existing TDD UE) supporting a different version of the standard within a cell, and the SBFD UE may determine whether to support SBFD by acquiring all or part of the system information transmitted separately from the system information for the existing TDD UE. When the SBFD UE acquires only system information for the existing TDD UE or acquires system information for non-SBFD support, it may be determined that the cell (or base station) supports only TDD.

When information on whether the SBFD is supported is included in system information for a UE (e.g., an existing TDD UE) that supports a different version of the standard, the information on whether the SBFD is supported may be inserted at the end so as not to affect the acquisition of system information by the existing TDD UE. When the SBFD UE fails to acquire information on whether the last inserted SBFD is supported or acquires information that SBFD is not supported, the SBFD UE may determine that the cell (or base station) supports only TDD.

When information on whether the SBFD is supported is included in system information for a UE (e.g., an existing TDD UE) that supports a different version of the standard, the information on whether the SBFD is supported may be transmitted on a separate PDSCH so as not to affect the acquisition of system information by the existing TDD UE. That is, the UE that does not support SBFD may receive the first SIB (or SIB1) including existing TDD-related system information from the first PDSCH. The UE that supports SBFD may receive the first SIB (or SIB1) including existing TDD-related system information from the first PDSCH, and receive the second SIB including SBFD-related system information from the second PDSCH. Here, the first PDSCH and the second PDSCH may be scheduled as the first PDCCH and the second PDCCH, and the cyclic redundancy code (CRC) of the first PDCCH and the second PDCCH may be scrambled with the same RNTI (e.g., SI-RNTI). The search space for monitoring the second PDCCH may be acquired from the system information of the first PDSCH, and if not acquired (i.e., if the system information of the first PDSCH does not include information on the search space), the second PDCCH may be received from the same search space as the search space of the first PDCCH.

As described above, when the SBFD UE determines that the cell (or base station) supports only TDD, the SBFD UE may perform random access procedures and data/control signal transmission and reception in the same way performed by the existing TDD UE.

The base station may configure a separate random access resource for each of the existing TDD UE or SBFD UE (e.g., an SBFD UE that supports duplex communication and an SBFD UE that supports half-duplex communication) and transmit configuration information (control information or configuration information indicating time-frequency resources that may be used for PRACH) on the random access resource to the SBFD UE through system information. The system information for transmitting information on the random access resource may be system information transmitted separately from system information for a UE (e.g., an existing TDD UE) supporting another version of the standard within a cell.

By configuring separate random access resources for the TDD UE and the SBFD UE supporting a different version of the standard, the base station may be able to distinguish whether the TDD UE supporting the different version of the standard performs random access or the SBFD UE performs random access. For example, the separate random access resource configured for the SBFD UE may be a resource that the existing TDD UE determines as a downlink time resource, and the SBFD UE may determine that the UE in which the base station attempts random access at the uplink resource is the SBFD UE by performing random access through an uplink resource (or a separate random access resource) configured at some frequencies of the downlink time resource.

Alternatively, the base station may configure a common random access resource for all UEs in the cell without configuring a separate random access resource for the SBFD UE. In this case, configuration information on the random access resource may be transmitted to all UEs in the cell through system information, and the SBFD UE receiving the system information may perform random access to the random access resource. Thereafter, the SBFD UE may complete the random access process and proceed to the RRC access mode for transmitting and receiving data to and from the cell. After the RRC access mode, the SBFD UE may receive a higher or physical signal from the base station to determine that some frequency resources of the downlink time resources are configured as uplink resources, and perform SBFD operation, for example, transmitting an uplink signal on the uplink resource.

When determining that the cell supports SBFD, the SBFD UE may inform the base station that the UE attempting to access is an SBFD UE by transmitting capability information to the base station, including at least one of whether the UE supports SBFD, whether full-duplex or half-duplex communication is supported, the number of transmission or reception antennas that are provided (or supported), and the like. Alternatively, when the half-duplex communication support is an essential implementation for the SBFD UE, whether the half-duplex communication support is provided may be omitted from the capability information. The SBFD UE's report on the capability information may be reported to the base station through a random access process, may be reported to the base station after completing the random access process, or may be reported to the base station after proceeding in the RRC access mode for transmitting and receiving cells and data.

The SBFD UE may support half-duplex communication that performs only uplink transmission or downlink reception simultaneously, like the existing TDD UE, and may support full-duplex communication that performs both uplink transmission and downlink reception simultaneously. Accordingly, the SBFD UE may report to the base station whether the half-duplex or full-duplex communication is supported through a capability report, and after the report, the base station may configure whether the SBFD UE transmits and receives using half-duplex communication or full-duplex communication to the SBFD UE. When the SBFD UE reports capability for the half-duplex communication to the base station, since duplexers don't usually exist, a switching gap for changing the RF between transmission and reception may be required when operating in FDD or TDD.

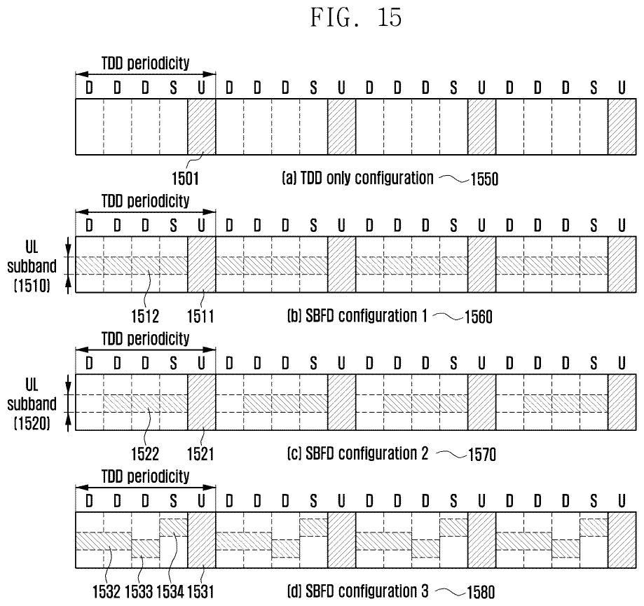

FIG. 15 is a diagram illustrating an example of SBFD being operated in the TDD band of a wireless communication system to which the disclosure is applied.

In 1550, a case where TDD is operated in a specific frequency band is illustrated. In the cell operating the TDD, the base station may transmit and receive signals including data/control information in the downlink slot (or symbol), the uplink slot (or symbol) 1501, and the flexible slot (or symbol), based on the configuration of TDD UL-DL resource configuration information indicating the downlink slot (or symbol) resource and uplink slot (or symbol) resource of the TDD with the existing TDD UE or SBFD UE.

In FIG. 15, it may be assumed that a DDDSU slot format is configured according to TDD UL-DL resource configuration information. Here, ‘D’ is a slot composed of all downlink symbols, ‘U’ is a slot composed of all uplink symbols, and ‘S’ is a slot other than ‘D’ or ‘U’, that is, a slot including a downlink symbol, an uplink symbol, or a flexible symbol. Here, for convenience, it may be assumed that S consists of 12 downlink symbols and 2 flexible symbols. In addition, the DDDSU slot format may be repeated according to the TDD UL-DL resource configuration information. That is, the repetition period of the TDD configuration is 5 slots (5 ms for 15 kHz SCS, 2.5 ms for 30 kHz SCS, etc.)

Next, in 1560, 1570 to 1580, a case in which the SBFD is operated together with the TDD in a specific frequency band is illustrated.

Referring to 1560, the UE may be configured with some of the cell's frequency bands as a frequency band 1510 capable of uplink transmission. This band may be referred to as an uplink subband (UL subband). In addition, the uplink subband (UL subband) may be applied to all symbols in all slots. The UE may transmit uplink channels or signals scheduled to all symbols 1512 within the subband (UL subband). However, the UE cannot transmit uplink channels or signals in bands other than the subband (UL subband).

Referring to 1570, the UE may be configured with some of the cell's frequency bands as a frequency band 1520 capable of uplink transmission, and configured with a time area in which the frequency band is activated. Here, this frequency band may be referred to as an uplink subband (UL subband). In 1570, the uplink subband (UL subband) may be deactivated the in the first slot, and the uplink subband (UL subband) may be activated in the remaining slots. Accordingly, the UE may transmit an uplink channel or signal in the uplink subband 1522 of the remaining slots. Therefore, here, the uplink subband (UL subband) is activated on a slot basis, but whether the uplink subband is activated may be configured on a symbol basis.

Referring to 1580, the UE may be configured with a time-frequency resource capable of transmitting uplink. The UE may be configured with one or more time-frequency resources as time-frequency resources capable of uplink transmission. For example, some frequency bands 1532 of the first slot and the second slot may be configured as a time-frequency resource capable of transmitting uplink. In addition, some frequency bands 1533 of the third slot and some frequency bands 1534 of the fourth slot may be configured as time-frequency resources capable of uplink transmission.

In the following description, a time-frequency resource capable of transmitting uplink within a downlink symbol or slot may be referred to as an SBFD resource. In addition, a symbol in which the uplink subband is configured within the downlink symbol may be referred to as an SBFD symbol. In addition, a time-frequency resource capable of receiving downlink within the uplink symbol or slot may be referred to as an SBFD resource. In addition, a symbol in which the downlink subband is configured within the uplink symbol may be referred to as an SBFD symbol.

For convenience, in the disclosure, a downlink channel or signal-receivable band excluding the uplink subband is expressed as a downlink subband. In the UE, a maximum of one uplink sub-band may be configured for one symbol, and a maximum of two downlink sub-bands may be configured. For example, in the frequency domain, the UE may be configured with one of {uplink sub-band, downlink sub-band}, {downlink sub-band, uplink sub-band}, or {first downlink sub-band, uplink sub-band, and second downlink sub-band}.

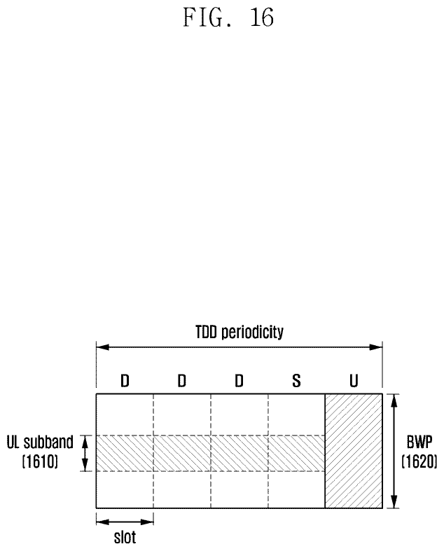

FIG. 16 illustrates an example of SBFD configuration according to an embodiment of the disclosure.

Referring to FIG. 16, the UE may be configured with an uplink symbol, a downlink symbol, or a flexible symbol according to the TDD configuration. Here, the ‘D’ slot is a slot in which all symbols are downlink symbols. The ‘U’ slot is a slot in which all symbols are uplink symbols. The ‘S’ slot is a slot that is neither the ‘D’ slot nor the ‘U’ slot. The UE may be configured with the UL BWP 1620. In addition, the UE may be configured with the UL subband 1610 within the DL symbol. In addition, the UE may be configured with a slot or symbol to which the UL subband 1610 is applied. Referring to FIG. 16, the UL subband may be applied to only some of the DL symbols of the TDD period. The UL subband is applied to the DL symbols in the second and third slots, but the UL subband may not be applied to other DL symbols. Here, the SBFD symbol may be referred to as a symbol to which the UL subband is applied.

The base station may configure a guard frequency period between the DL subband and the UL subband in the UE. When the guard frequency period is configured to the UE, the frequency resources in the frequency domain may be divided into a UL subband, a guard frequency period, and a DL subband. For description of the embodiment, it is assumed that the guard frequency period is included in the UL subband. In other words, in the following description, the expression ‘If ‘X’ overlaps with the UL subband’ may be interpreted as ‘If ‘X’ overlaps with the UL subband or guard frequency period’. In addition, the expression ‘If ‘X’ overlaps with the UL subband’ may be interpreted as ‘If ‘X’ does not overlap with the DL sub-band’.

The expression ‘If ‘X’ does not overlap with the UL subband’ may be interpreted as ‘If ‘X’ does not overlap with the UL subband and the Guard frequency period’. In addition, the expression ‘If ‘X’ does not overlap with the UL subband’ may be interpreted as ‘If ‘X’ overlaps with the DL subband’.

Hereinafter, embodiments of the disclosure will be described in detail in conjunction with the accompanying drawings.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

In the following description of embodiments of the disclosure, a 5G system will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, higher layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through multiple embodiments, but they are not independent of each other, and one or more embodiments may be applied simultaneously or in combination.

### First Embodiment: Aperiodic or Semi-Persistent CSI Report Multiplexing Method

As an embodiment of the disclosure, aperiodic or semi-persistent CSI report multiplexing methods of a UE are described. This embodiment may operate in combination with other embodiments of the disclosure.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘10’ or ‘11’, the UE is configured with PUSCH repetition type A through higher layer signaling, and the UE is scheduled through the CSI request field in the DCI from the base station for an instruction to report the aperiodic CSI by using PUSCH including a transport block.
If the UE is instructed to CSI-AperiodicTriggerState with AP-CSI-MultiplexingMode, which is higher layer signaling, configured through the CSI request field in DCI, and if no UCI other than the aperiodic CSI report is multiplexed in the corresponding PUSCH,
The UE may multiplex the corresponding aperiodic CSI report in the first PUSCH repetitive transmission among the PUSCH repetitive transmissions corresponding to the first SRS resource set and the first PUSCH repetitive transmission among the PUSCH repetitive transmissions corresponding to the second SRS resource set.
Otherwise (i.e., if the UE is instructed to CSI-AperiodicTriggerState without AP-CSI-MultiplexingMode, which is higher layer signaling, configured through the CSI request field in DCI, or if UCI other than the aperiodic CSI report is multiplexed in the corresponding PUSCH),
The UE may multiplex the corresponding aperiodic CSI report in the first PUSCH repetitive transmission among one or more PUSCH repetitive transmissions.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘10’ or ‘11’, the UE is configured with PUSCH repetition type A through higher layer signaling, and the UE is scheduled through the CSI request field in the DCI from the base station for an instruction to report the aperiodic CSI by using PUSCH not including a transport block.
The UE may regard the number of PUSCH repetitive transmissions as 2 regardless of the configured and indicated number of PUSCH repetitive transmissions.
In this case, the first PUSCH repetitive transmission may be performed toward a TRP corresponding to the first SRS resource set, and the second PUSCH repetitive transmission may be performed toward a TRP corresponding to the second SRS resource set.
In this case, the configured and indicated number of PUSCH repetitive transmissions may be a value configured to numberOfRepetitions, which is higher layer signaling within the entry indicated through the TDRA field, or a value set to push-AggregationFactor, which is higher layer signaling, if numberOfRepetitions are not configured.
If the UE is instructed to CSI-AperiodicTriggerState with AP-CSI-MultiplexingMode, which is higher layer signaling, configured through the CSI request field in DCI, and if no UCI other than the aperiodic CSI report is multiplexed in the corresponding PUSCH,
The UE may multiplex the corresponding aperiodic CSI report in the first PUSCH repetitive transmission among the PUSCH repetitive transmissions corresponding to the first SRS resource set and the first PUSCH repetitive transmission among the PUSCH repetitive transmissions corresponding to the second SRS resource set.
Otherwise (i.e., if the UE is instructed to CSI-AperiodicTriggerState without AP-CSI-MultiplexingMode, which is higher layer signaling, configured through the CSI request field in DCI, or if UCI other than the aperiodic CSI report is multiplexed in the corresponding PUSCH),
The UE may multiplex the corresponding aperiodic CSI report in the first PUSCH repetitive transmission among two PUSCH repetitive transmissions.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘10’ or ‘11’, the UE is configured with PUSCH repetition type A through higher layer signaling, and the UE is scheduled through the CSI request field in the DCI from the base station for an instruction to report the semi-persistent CSI by using PUSCH not including a transport block.
The UE may regard the number of PUSCH repetitive transmissions as 2 regardless of the configured and indicated number of PUSCH repetitive transmissions.
In this case, the first PUSCH repetitive transmission may be performed toward a TRP corresponding to the first SRS resource set, and the second PUSCH repetitive transmission may be performed toward a TRP corresponding to the second SRS resource set.
In this case, the configured and indicated number of PUSCH repetitive transmissions may be a value configured to numberOfRepetitions, which is higher layer signaling within the entry indicated through the TDRA field, or a value set to push-AggregationFactor, which is higher layer signaling, if numberOfRepetitions are not configured.
If the UE is instructed to CSI-SemiPersistentOnPUSCH-TriggerState or CSI-SemiPersistentOnPUSCH-TriggerStateList with SP-CSI-MultiplexingMode, which is higher layer signaling, configured through the CSI request field in DCI, and if no UCI other than the semi-persistent CSI report is multiplexed in the corresponding PUSCH,
For the first PUSCH transmission after receiving the PUSCH transmission in which the semi-persistent CSI report may be multiplexed is scheduled through DCI, the UE may multiplex the corresponding semi-persistent CSI report for both the first PUSCH repetitive transmission and the second PUSCH repetitive transmission.
From the second PUSCH transmission, which may be transmitted periodically without DCI after the first PUSCH transmission after receiving the PUSCH transmission in which the semi-persistent CSI report may be multiplexed is scheduled through DCI, the UE may multiplex the corresponding semi-persistent CSI report for both the first PUSCH repetitive transmission and the second PUSCH repetitive transmission.
Otherwise (i.e., if the UE is instructed to CSI-SemiPersistentOnPUSCH-TriggerState or CSI-SemiPersistentOnPUSCH-TriggerStateList without SP-CSI-MultiplexingMode, which is higher layer signaling, configured through the CSI request field in DCI, or if UCI other than the semi-persistent CSI report is multiplexed in the corresponding PUSCH),
The UE may multiplex the corresponding semi-persistent CSI report in the first PUSCH repetitive transmission among two PUSCH repetitive transmissions.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘10’ or ‘11’, the UE is configured with PUSCH repetition type B through higher layer signaling, and the UE is scheduled through the CSI request field in the DCI from the base station for an instruction to report the aperiodic CSI by using PUSCH including a transport block.
If the UE is instructed to CSI-AperiodicTriggerState with AP-CSI-MultiplexingMode, which is higher layer signaling, configured through the CSI request field in DCI, the first actual repetition corresponding to the first SRS resource set and the first actual repetition corresponding to the second SRS resource set have the same OFDM symbol length, and if no UCI other than the aperiodic CSI report is multiplexed in the corresponding PUSCH,
The UE may multiplex the corresponding aperiodic CSI report in the first PUSCH actual repetition among the actual repetitions corresponding to the first SRS resource set and the first PUSCH actual repetition among the actual repetitions corresponding to the second SRS resource set.
Otherwise (i.e., if the UE is instructed to CSI-AperiodicTriggerState without AP-CSI-MultiplexingMode, which is higher layer signaling, configured through the CSI request field in DCI, the first actual repetition corresponding to the first SRS resource set and the first actual repetition corresponding to the second SRS resource set have different OFDM symbol lengths, or if UCI other than the aperiodic CSI report is multiplexed in the corresponding PUSCH),
The UE may multiplex the corresponding aperiodic CSI report in the first actual repetition among one or more PUSCH repetitive transmissions.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘10’ or ‘11’, the UE is configured with PUSCH repetition type A through higher layer signaling, and the UE is scheduled through the CSI request field in the DCI from the base station for an instruction to report the aperiodic CSI by using PUSCH not including a transport block.
The UE may regard the value of nominal repetition as 2 regardless of the configured and indicated value of nominal repetition, and regard that the first nominal repetition has the same OFDM symbol length as the first actual repetition, and the second nominal repetition has the same OFDM symbol length as the second actual repetition.
In this case, the first actual repetition may be transmitted to a TRP corresponding to the first SRS resource set, and the second actual repetition may be transmitted to a TRP corresponding to the second SRS resource set.
In this case, the configured and indicated number of PUSCH repetitive transmissions may be a value configured to numberOfRepetitions, which is higher layer signaling within the entry indicated through the TDRA field.
If the UE is instructed to CSI-AperiodicTriggerState with AP-CSI-MultiplexingMode, which is higher layer signaling, configured through the CSI request field in DCI, and if no UCI other than the aperiodic CSI report is multiplexed in the corresponding PUSCH,
The UE may multiplex the corresponding aperiodic CSI report in the first actual repetition and the second actual repetition.
Otherwise (i.e., if the UE is instructed to CSI-AperiodicTriggerState without AP-CSI-MultiplexingMode, which is higher layer signaling, configured through the CSI request field in DCI, or if UCI other than the aperiodic CSI report is multiplexed in the corresponding PUSCH),
The UE may multiplex the corresponding aperiodic CSI report in the first actual repetition.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘10’ or ‘11’, the UE is configured with PUSCH repetition type A through higher layer signaling, and the UE is scheduled through the CSI request field in the DCI from the base station for an instruction to report the semi-persistent CSI by using PUSCH not including a transport block.
For the first PUSCH transmission after receiving the PUSCH transmission in which the semi-persistent CSI report may be multiplexed is scheduled through DCI,
The UE may regard the value of nominal repetition as 2 regardless of the configured and indicated value of nominal repetition, and regard that the first nominal repetition has the same OFDM symbol length as the first actual repetition, and the second nominal repetition has the same OFDM symbol length as the second actual repetition.
In this case, the first actual repetition may be transmitted to a TRP corresponding to the first SRS resource set, and the second actual repetition may be transmitted to a TRP corresponding to the second SRS resource set.
In this case, the number of PUSCH repetitive transmissions may be a value configured to numberOfRepetitions, which is higher layer signaling within the entry indicated through the TDRA field.
If the UE is instructed to CSI-SemiPersistentOnPUSCH-TriggerState or CSI-SemiPersistentOnPUSCH-TriggerStateList with SP-CSI-MultiplexingMode, which is higher layer signaling, configured through the CSI request field in DCI, and if no UCI other than the semi-persistent CSI report is multiplexed in the corresponding PUSCH,
The UE may multiplex the corresponding semi-persistent CSI report in the first actual repetition and the second actual repetition.
Otherwise (i.e., if the UE is instructed to CSI-SemiPersistentOnPUSCH-TriggerState or CSI-SemiPersistentOnPUSCH-TriggerStateList without SP-CSI-MultiplexingMode, which is higher layer signaling, configured through the CSI request field in DCI, or if UCI other than the aperiodic CSI report is multiplexed in the corresponding PUSCH),
The UE may multiplex the corresponding semi-persistent CSI report in the first actual repetition.
From the second PUSCH transmission, which may be transmitted periodically without DCI after the first PUSCH transmission, after receiving the PUSCH transmission in which the semi-persistent CSI report may be multiplexed is scheduled through DCI,
The UE may regard the value of nominal repetition as 2 regardless of the configured and indicated value of nominal repetition.
In this case, the first actual repetition may be transmitted to a TRP corresponding to the first SRS resource set, and the second actual repetition may be transmitted to a TRP corresponding to the second SRS resource set.
In this case, the number of PUSCH repetitive transmissions may be a value configured to numberOfRepetitions, which is higher layer signaling within the entry indicated through the TDRA field.
If the UE is instructed to CSI-SemiPersistentOnPUSCH-TriggerState or CSI-SemiPersistentOnPUSCH-TriggerStateList with SP-CSI-MultiplexingMode, which is higher layer signaling, configured through the CSI request field in DCI,
If the OFDM symbol length between the first nominal repetition and the first actual repetition is the same, and the OFDM symbol length between the second nominal repetition and the second actual repetition is different, the second nominal repetition is not transmitted, and semi-persistent CSI report may be multiplexed to the second actual repetition.
If the OFDM symbol length between the first nominal repetition and the first actual repetition is different, and the OFDM symbol length between the second nominal repetition and the second actual repetition is the same, the first actual repetition is not transmitted, and semi-persistent CSI report may be multiplexed to the second actual repetition.
If the UE is instructed to CSI-SemiPersistentOnPUSCH-TriggerState or CSI-SemiPersistentOnPUSCH-TriggerStateList with SP-CSI-MultiplexingMode, which is higher layer signaling, configured through the CSI request field in DCI, the OFDM symbol length between the first nominal repetition and the first actual repetition is the same, the OFDM symbol length between the second nominal repetition and the second actual repetition is the same, and no other UCI is multiplexed corresponding PUSCH other than the semi-persistent CSI report,
The UE may multiplex the corresponding semi-persistent CSI report in the first actual repetition and the second actual repetition.
Otherwise (i.e., if the UE is instructed to CSI-SemiPersistentOnPUSCH-TriggerState or CSI-SemiPersistentOnPUSCH-TriggerStateList without SP-CSI-MultiplexingMode, which is higher layer signaling, configured through the CSI request field in DCI, the OFDM symbol length between the first nominal repetition and the first actual repetition is different, the OFDM symbol length between the second nominal repetition and the second actual repetition is different, or if UCI other than the aperiodic CSI report is multiplexed in the corresponding PUSCH),
The UE may multiplex the corresponding semi-persistent CSI report in the first actual repetition.

If the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’, the UE is configured with PUSCH repetition type A through higher layer signaling, and the UE is scheduled through the CSI request field in the DCI from the base station for an instruction to report the aperiodic CSI by using PUSCH including a transport block, the UE may multiplex the corresponding aperiodic CSI report in the first PUSCH repetition.

If the UE is configured with one SRS resource set in which the usage is configured as codebook or non-codebook through higher layer signaling from the base station (therefore, there is no SRS resource set indicator field within the DCI), the UE is configured with PUSCH repetition type A through higher layer signaling, and the UE is scheduled through the CSI request field in the DCI from the base station for an instruction to report the aperiodic CSI by using PUSCH including a transport block, the UE may multiplex the corresponding aperiodic CSI report in the first PUSCH repetition.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’, the UE is configured with PUSCH repetition type A through higher layer signaling, and the UE is scheduled through the CSI request field in the DCI from the base station for an instruction to report the aperiodic CSI or semi-persistent CSI by using PUSCH not including a transport block.
The UE may regard the number of PUSCH repetitive transmissions as 1 regardless of the configured and indicated number of PUSCH repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
The UE may multiplex the corresponding aperiodic CSI or semi-persistent CSI reports in the first PUSCH repetition.
In the case of semi-persistent CSI report, the UE may equally multiplex the corresponding aperiodic CSI or semi-persistent CSI reports in the first PUSCH repetition for the first PUSCH transmission after receiving the PUSCH transmission in which semi-persistent CSI report may be multiplexed is scheduled through DCI, or for the second PUSCH transmission, which may be transmitted periodically without DCI after the first PUSCH transmission after receiving scheduling through DCI for PUSCH transmission where semi-persistent CSI report may be multiplexed.
It is considered that the UE is configured with one SRS resource set in which the usage is configured as codebook or non-codebook through higher layer signaling from the base station (therefore, there is no SRS resource set indicator field within the DCI), the UE receives an indication from the base station that the SRS resource set indicator in the DCI is ‘00’ or ‘01’, the UE is configured with PUSCH repetition type A through higher layer signaling, and the UE is scheduled through the CSI request field in the DCI from the base station for an instruction to report the aperiodic CSI or semi-persistent CSI by using PUSCH not including a transport block.
The UE may regard the number of PUSCH repetitive transmissions as 1 regardless of the configured and indicated number of PUSCH repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
The UE may multiplex the corresponding aperiodic CSI or semi-persistent CSI reports in the first PUSCH repetition.
In the case of semi-persistent CSI report, the UE may equally multiplex the corresponding aperiodic CSI or semi-persistent CSI reports in the first PUSCH repetition for the first PUSCH transmission after receiving the PUSCH transmission in which semi-persistent CSI report may be multiplexed is scheduled through DCI, or for the second PUSCH transmission, which may be transmitted periodically without DCI after the first PUSCH transmission after receiving scheduling through DCI for PUSCH transmission where semi-persistent CSI report may be multiplexed.

If the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’, the UE is configured with PUSCH repetition type B through higher layer signaling, and the UE is scheduled through the CSI request field in the DCI from the base station for an instruction to report the aperiodic CSI by using PUSCH including a transport block, the UE may multiplex the corresponding aperiodic CSI report in the first actual repetition.

If the UE is configured with one SRS resource set in which the usage is configured as codebook or non-codebook through higher layer signaling from the base station (therefore, there is no SRS resource set indicator field within the DCI), the UE is configured with PUSCH repetition type B through higher layer signaling, and the UE is scheduled through the CSI request field in the DCI from the base station for an instruction to report the aperiodic CSI by using PUSCH including a transport block, the UE may multiplex the corresponding aperiodic CSI report in the first PUSCH repetition.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’, the UE is configured with PUSCH repetition type A through higher layer signaling, and the UE is scheduled through the CSI request field in the DCI from the base station for an instruction to report the aperiodic CSI by using PUSCH not including a transport block.
The UE may regard the value of nominal repetition as 1 regardless of the configured and indicated value of nominal repetition, and regard that the first nominal repetition has the same OFDM symbol length as the first actual repetition. In this case, the number of PUSCH repetitive transmissions may be a value configured to numberOfRepetitions, which is higher layer signaling within the entry indicated through the TDRA field.
The UE may multiplex the corresponding aperiodic CSI report in the first actual repetition.
It is considered that the UE is configured with one SRS resource set in which the usage is configured as codebook or non-codebook through higher layer signaling from the base station (therefore, there is no SRS resource set indicator field within the DCI), the UE is configured with PUSCH repetition type B through higher layer signaling, and the UE is scheduled through the CSI request field in the DCI from the base station for an instruction to report the aperiodic CSI by using PUSCH not including a transport block.
The UE may regard the value of nominal repetition as 1 regardless of the configured and indicated value of nominal repetition, and regard that the first nominal repetition has the same OFDM symbol length as the first actual repetition. In this case, the number of PUSCH repetitive transmissions may be a value configured to numberOfRepetitions, which is higher layer signaling within the entry indicated through the TDRA field.
The UE may multiplex the corresponding aperiodic CSI report or semi-persistent CSI report in the first PUSCH repetition.

It is considered that the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’, the UE is configured with PUSCH repetition type A through higher layer signaling, and the UE is scheduled through the CSI request field in the DCI from the base station for an instruction to report the semi-persistent CSI by using PUSCH not including a transport block.
For the first PUSCH transmission after receiving the PUSCH transmission in which the semi-persistent CSI report may be multiplexed is scheduled through DCI,
The UE may regard the value of nominal repetition as 1 regardless of the configured and indicated value of nominal repetition, and regard that the first nominal repetition has the same OFDM symbol length as the first actual repetition, and the second nominal repetition has the same OFDM symbol length as the second actual repetition. In this case, the number of PUSCH repetitive transmissions may be a value configured to numberOfRepetitions, which is higher layer signaling within the entry indicated through the TDRA field.
The UE may multiplex the corresponding semi-persistent CSI in the first actual repetition.
From the second PUSCH transmission, which may be transmitted periodically without DCI after the first PUSCH transmission, after the UE receives the PUSCH transmission in which the semi-persistent CSI report may be multiplexed is scheduled through DCI,
The UE may regard the value of nominal repetition as 1 regardless of the configured and indicated value of nominal repetition. In this case, the number of PUSCH repetitive transmissions may be a value configured to numberOfRepetitions, which is higher layer signaling within the entry indicated through the TDRA field.
If the OFDM symbol length of the first nominal repetition and the first actual repetition are different, the UE may ignore the first nominal repetition without transmitting, and if the OFDM symbol length of the first nominal repetition and the first actual repetition are the same, the UE may multiplex the semi-persistent CSI report in the first actual repetition.

It is considered that the TDRA field indicated by the UE through one DCI format 0_1 or 0_2 from the base station includes multiple pieces of time domain resource allocation information, that is, the UE receives a plurality of PUSCHs (multi-PUSCHs) scheduled and is instructed to report aperiodic CSI through the same DCI.
If the UE receives two different PUSCH transmissions scheduled, the UE may multiplex the aperiodic CSI report for the second PUSCH.
If the UE receives more than two different PUSCH transmissions scheduled, the UE may multiplex the aperiodic CSI report for the second to last PUSCH.

The UE may be configured with a transmission method (TBoMS: TB over Multiple Slots) for processing a transport block included in the PUSCH by using a plurality of slots, and it is considered that the UE receives a DCI format 0_1 or 0_2 for scheduling a PUSCH to which TBoMS is applied through a PDCCH including a CRC scrambled with C-RNTI, MCS-C-RNTI, or CS-RNTI.
The UE may be configured through numberOfSlotsTBoMS, which is higher layer signaling, from the base station for N, which is the number of slots for determining the transport block size. The numberOfSlotsTBoMS, which is higher layer signaling, may be configured as higher layer signaling for each entry that may be indicated through a TDRA field in DCI, and one of 1, 2, 4, or 8 may be configured.
K, which means the number of repetitive transmissions, may be set through numberOfRepetitions, which is higher layer signaling, and may mean the number of times N, which is the number of slots set through numberOfSlotsTBoMS, which is higher layer signaling, is repeated. As an example, if N is 2 and K is 4, the UE may expect one TBoMS-based PUSCH transmitted through two slots to be repeated four times and transmitted occupying a total of eight slots. The numberOfSlotsTBoMS, which is higher layer signaling, may be configured as higher layer signaling for each entry that may be indicated through a TDRA field in DCI, and value of up to 32 may be possible (e.g., one value of n1, n2, n3, n4, n7, n8, n12, n16, n20, n24, n28, and n32).
The UE may not expect a product of N and K to be greater than 32.
If the UE is instructed to perform the aperiodic CSI report, the aperiodic CSI report may be multiplexed only in the first PUSCH transmission among N×K slots.

### Second Embodiment: Aperiodic or Semi-Persistent CSI Report Multiplexing Method Considering SBFD Resource Allocation

As an embodiment of the disclosure, aperiodic or semi-persistent CSI report multiplexing methods considering SBFD resource allocation are described. The embodiment may operate in combination with other embodiments of the disclosure.

As described above, if the UE accesses a base station operating as SBFD, the UE may receive notification of a combination of at least one of higher layer signaling, MAC-CE, and L1 signaling for the uplink subband from the base station. Based on this, the base station and the UE may determine the transmission and reception direction between the base station and the UE, that is, the duplex method and direction by using at least one of the SBFD configuration methods illustrated in FIG. 15.

If the UE operates as SBFD and is scheduled for at least one combination of repetitive PUSCH transmission, multi-PUSCH scheduling, or TBoMS-based PUSCH transmission transmitted in at least a plurality of slots, the UE may select a PUSCH in which aperiodic CSI report may be multiplexed by considering the following matters.
If different PUSCH or repeated PUSCH transmissions are performed in multiple slots or multiple symbols, the UE may perform repeated PUSCH transmission not only in uplink slots, but also in slots capable of SBFD operation. Accordingly, when the UE performs multiplexing for aperiodic CSI reports, the UE may consider more candidates for PUSCH transmission locations that may multiplex aperiodic CSI reports. As an example, in 1550 of FIG. 15, which represents an example of TDD configuration, if PUSCH transmission was possible only in the uplink slot 1501, since uplink subbands 1512, 1522, 1532, 1533, and 1534 also exist in the existing downlink slot in 1560, 1570, and 1580, PUSCH transmission may also be possible at the time location of the downlink slot including the corresponding uplink subband, which may increase coverage and shorten delay time by securing more uplink transmission locations.
It is considered that different PUSCH or repeated PUSCH transmissions are performed in multiple slots or multiple symbols, and some of the plurality of slots or symbols operate as SBFD (i.e., when some frequency resources operate in the uplink and some other resources operate in the downlink within the same time) and some of the remaining slots or symbols operate only in the uplink. The UE may expect that different PUSCH or PUSCH repetitive transmissions are performed in different slots or symbol locations and that the amount of time and frequency resources of each repetitive transmission are the same or different. As an example, if the frequency resource amount of PUSCH in one symbol transmitted in an uplink slot is 10 RB, and the frequency resource overlaps the uplink subband and two RBs in a symbol or slot capable of SBFD operation, the amount of resources of the PUSCH may be different because the PUSCH transmitted in the corresponding uplink subband may occupy 8 RBs of frequency resources.
While the UE may acquire uplink transmission opportunities through the uplink subband in the SBFD slot or symbol, downlink scheduling may still be possible in frequency resources where there is no uplink subband in the same SBFD slot or symbol. Accordingly, for uplink transmission from the UE to the base station in the uplink subband, reception performance at the base station may be degraded due to the amount of interference depending on the presence or absence of downlink scheduling from the base station in the same SBFD slot or symbol, and further, the amount of interference may vary in different SBFD slots or symbols. Accordingly, depending on which SBFD slot or symbol the UE multiplexes the aperiodic CSI report in the PUSCH transmitted, the reception performance of the multiplexed aperiodic CSI report may also vary.
If the UE operates in SBFD and is scheduled for at least one combination of repetitive PUSCH transmission, multi-PUSCH scheduling, or TBoMS-based PUSCH transmission transmitted in multiple slots, three detailed embodiments may be considered as follows. In addition, under each embodiment, at least one of the following items may be considered as detailed conditions that the UE and base station may consider. In addition, under each condition and combination of detailed conditions, the UE and base station may multiplex aperiodic CSI or semi-persistent CSI reports through a combination of at least one of the various methods below.

### Embodiment 2-1: Aperiodic CSI Report Multiplexing Method when Scheduling PUSCH Repetition Including Transport Block

### Condition 2-1

When the UE receives an aperiodic CSI report instruction from the base station through DCI, PUSCH scheduled through the corresponding DCI may include a transport block, and the corresponding PUSCH may be a PUSCH that is repeatedly transmitted in the PUSCH repetition type A or B method, depending on the PUSCH repetition type configured by the UE through higher layer signaling and the number of repetition transmissions configured in the entry of the TDRA field that the UE may receive instructions through DCI. Additional conditions may be a combination of at least one of the following.
[Condition 2-1-1] The UE may receive scheduling on the transmission method (TBoMS: TB over Multiple Slots) of processing a transport block included in a PUSCH by using a plurality of slots from the base station through DCI format 0_1 or 0_2 based on a PDCCH including a CRC scrambled with a C-RNTI, an MCS-C-RNTI, or a CS-RNTI. That is, it may be a case in which the UE is configured through numberOfSlotsTBoMS, which is higher layer signaling, from the base station for N, which is the number of slots for determining the transport block size, and a case in which the UE is indicated the entry of the TDRA field in which numberOfSlotsTBoMS is configured through the TDRA field in the DCI.
[Condition 2-1-2] When the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’
[Condition 2-1-3] When the UE is configured with one SRS resource set in which the usage is configured as codebook or non-codebook through higher layer signaling from the base station (therefore, there is no SRS resource set indicator field within the DCI)
[Condition 2-1-4] Conditions for multiplexed CSI in addition to aperiodic CSI report

Regarding the combination of at least one of the [Condition 2-1] and its detailed conditions [Condition 2-1-1] to [Condition 2-1-4], the UE and base station may define a multiplexing method for aperiodic CSI report by considering a combination of at least one of the following methods.
[Method 2-1-1] The UE may multiplex the corresponding aperiodic CSI report in the first PUSCH repetition transmitted first.

Through this, the UE may quickly transmit an aperiodic CSI report to the base station while consuming the shortest delay time. However, if the first PUSCH repetition transmitted first is located in an uplink subband within an SBFD slot or a set of consecutive SBFD symbols and the interference due to downlink scheduling within the slot or symbol is strong, the periodic CSI report transmitted by the UE may not be properly decoded by the base station.

Accordingly, when the base station instructs aperiodic CSI report through DCI, if the first repetition is located in an uplink subband within an SBFD slot or a set of consecutive SBFD symbols, the base station may adjust the amount of self-interference at the base station where downlink transmission affects uplink reception by adjusting quasi-static or dynamic downlink scheduling in the corresponding SBFD slot. The base station scheduler may delay dynamic downlink scheduling, perform quasi-statically configuration, scheduling, or transmitting activated downlink channels and signals as they are, or cancel downlink transmission according to conditions with an SBFD slot or a set of consecutive SBFD symbols or a downlink slot or a set of consecutive downlink symbols in which aperiodic CSI report is not transmitted.
If the UE is scheduled based on PUSCH repetition type B, the first PUSCH repetition may be the first actual repetition.
For [Method 2-1-1], the UE may report the UE capability for aperiodic CSI report multiplexing during the SBFD operation to the base station.
As an example, the UE and the base station may use the [Method 2-1-1]according to the UE capability report of the UE, and there may be no specific higher layer signaling that the UE may be configured from the base station for [Method 2-1-1].
As another example, the base station may configure specific higher layer signaling to the UE that means using [Method 2-1-1] according to the UE capability report of the UE. If the corresponding higher layer signaling is not configured, the UE may operate in a combination of at least one of [Method 2-1-1] to [Method 2-1-11].
[Method 2-1-2] The UE may multiplex the corresponding aperiodic CSI report in the PUSCH repetition transmitted in the first uplink slot or a set of consecutive uplink symbols.
Through this, the UE may transmit an aperiodic CSI report to the base station while avoiding interference from downlink scheduling that may be experienced by the PUSCH, which may be transmitted in an uplink subband within an SBFD slot or a set of consecutive SBFD symbols. However, the delay time may increase depending on how soon the first uplink slot or set of consecutive uplink symbols for which the UE may be scheduled appears from the DCI instructing the corresponding aperiodic CSI report.
Accordingly, in order to reduce the delay time, the base station may transmit a DCI instructing the aperiodic CSI report to the UE in a downlink resource close to the location of an uplink slot or a set of consecutive uplink symbols.
If the UE is scheduled based on PUSCH repetition type B, the PUSCH repetition transmitted in the first uplink slot or set of first consecutive uplink symbols in which the corresponding aperiodic CSI report is multiplexed may be the actual repetition transmitted in the first uplink slot or the first set of consecutive uplink symbols.
If all PUSCH repetitions are transmitted in an SBFD slot or a set of consecutive SBFD symbols, that is, if there are no PUSCH repetitions transmitted in an uplink slot or a set of consecutive uplink symbols, the UE may operate in a combination of at least one of [Method 2-1-1] to [Method 2-1-11].
For [Method 2-1-2], the UE may report the UE capability for aperiodic CSI report multiplexing during the SBFD operation to the base station.
As an example, the UE and the base station may use the [Method 2-1-2]according to the UE capability report of the UE, and there may be no specific higher layer signaling that the UE may be configured from the base station for [Method 2-1-2].
As another example, the base station may configure specific higher layer signaling to the UE that means using [Method 2-1-2] according to the UE capability report of the UE. If the corresponding higher layer signaling is not configured, the UE may operate in a combination of at least one of [Method 2-1-1] to [Method 2-1-11].
[Method 2-1-3] The UE may multiplex the corresponding aperiodic CSI report in the PUSCH repetition transmitted in the first appearing SBFD slot or the first appearing set of consecutive SBFD symbols, after receiving scheduling through DCI.
Since an SBFD slot or a set of consecutive SBFD symbols may exist more frequently than an uplink slot or a set of consecutive uplink symbols, the UE may transmit an aperiodic CSI report to the base station after a relatively short delay time. However, if the interference due to downlink scheduling in the same SBFD slot or the same set of consecutive SBFD symbols in the uplink subband within the first SBFD slot or the first set of consecutive SBFD symbols is strong, the aperiodic CSI report transmitted by the UE may not be properly decoded by the base station.
Accordingly, when instructing aperiodic CSI report through DCI, similar to the above, the base station may control downlink transmission that may be scheduled semi-statically or dynamically, so that aperiodic CSI report in the first SBFD slot or first set of consecutive SBFD symbols is multiplexed from the UE to ensure PUSCH reception performance when receiving the PUSCH to be transmitted from the base station.
If the UE is scheduled based on PUSCH repetition type B, the PUSCH repetition transmitted in the SBFD slot that appears first after receiving the DCI or the set of consecutive SBFD symbols that appears first may be the actual repetition transmitted in the SBFD slot that appears first or the set of SBFD symbols that appears first after receiving the DCI.
If all PUSCH repetitions are transmitted in an uplink slot or a set of consecutive uplink symbols, that is, if there are no PUSCH repetitions transmitted in an SBFD slot or a set of consecutive SBFD symbols, the UE may operate in a combination of at least one of [Method 2-1-1] to [Method 2-1-11].
For [Method 2-1-3], the UE may report the UE capability for aperiodic CSI report multiplexing during the SBFD operation to the base station.
As an example, the UE and the base station may use the [Method 2-1-3]according to the UE capability report of the UE, and there may be no specific higher layer signaling that the UE may be configured from the base station for [Method 2-1-3].
As another example, the base station may configure specific higher layer signaling to the UE that means using [Method 2-1-3] according to the UE capability report of the UE. If the corresponding higher layer signaling is not configured, the UE may operate in a combination of at least one of [Method 2-1-1] to [Method 2-1-11].
[Method 2-1-4] The UE may multiplex the corresponding aperiodic CSI report in the PUSCH repetition transmitted in the X-th appearing SBFD slot or the X-th appearing set of consecutive SBFD symbols, after receiving scheduling through DCI. The X may be notified to the UE from the base station by using a combination of at least one of higher layer signaling, MAC-CE, and L1 signaling. (Similarly, the UE may multiplex the corresponding aperiodic CSI report in the PUSCH repetition transmitted in the X-th appearing uplink slot or the X-th appearing set of consecutive SBFD symbols.)
As an example, if X is notified to the UE based on higher layer signaling, the UE, for example, may be configured with a value of a specific X in CSI-AperiodicTriggerState or CSI-AssociatedReportConfigInfo, which is higher layer signaling.
As another example, if X is notified to the UE through a combination of higher layer signaling and L1 signaling, the UE, for example, may be configured with candidates for a plurality of X values in PUSCH-config, which is higher layer signaling, and may receive a specific X value from the base station through a new field in DCI or a reserved code point of an existing field.
If the UE is scheduled based on PUSCH repetition type B, the PUSCH repetition may be the actual repetition.
For this purpose, the base station may adjust scheduling in the downlink resource within the corresponding X-th SBFD slot or the X-th appearing set of consecutive SBFD symbols to reduce interference with the PUSCH as described above while indicating the UE the X value simultaneously.
For [Method 2-1-4], the UE may report the UE capability for aperiodic CSI report multiplexing during the SBFD operation to the base station.
As an example, the UE and the base station may use the [Method 2-1-4]according to the UE capability report of the UE, and there may be no specific higher layer signaling that the UE may be configured from the base station for [Method 2-1-4].
As another example, the base station may configure specific higher layer signaling to the UE that means using [Method 2-1-4] according to the UE capability report of the UE. If the corresponding higher layer signaling is not configured, the UE may operate in a combination of at least one of [Method 2-1-1] to [Method 2-1-11].
[Method 2-1-5] The UE may multiplex the corresponding aperiodic CSI report in the first two PUSCH repetitions.
Through this, the UE may multiplex the aperiodic CSI report to the first two PUSCH reports with different interference situations, allowing the base station receiver to acquire diversity from different reception situations of the two PUSCHs to which the aperiodic CSI report is transmitted. As an example, when the first two PUSCH repetitions are transmitted in two SBFD slots or two sets of consecutive SBFD symbols, the base station receiver may acquire diversity from different downlink interference situations in each SBFD slot or the set of consecutive SBFD symbols.
Accordingly, when the base station instructs the UE to perform the aperiodic CSI report through DCI, the base station may schedule two PUSCHs, on which the UE may multiplex and transmit aperiodic CSI reports, to experience different interference situations or different reception situations. As an example, the base station may schedule the first two PUSCH repetitions to be transmitted in two SBFD slots or two sets of consecutive SBFD symbols, or may schedule one PUSCH repetition to be transmitted in an SBFD slot or a set of consecutive SBFD symbols, and the other PUSCH repetition to be transmitted in an uplink slot or a set of consecutive uplink symbols.
If the UE is scheduled based on PUSCH repetition type B, the first two PUSCH repetitions may be the first two actual repetitions.
The UE may multiplex aperiodic CSI reports in both of the first two PUSCH repetitions without any specific conditions. Even if the first two PUSCH repetitions have different OFDM symbol lengths, different amount of frequency resources, or different numbers of REs, the UE may multiplex aperiodic CSI reports in both of the first two PUSCH repetitions.
Alternatively, the UE may multiplex aperiodic CSI reports in both the first two PUSCH repetitions only if a specific condition is satisfied, and such conditions may be a combination of at least one of the following.
When the first two PUSCH repetitions have the same OFDM symbol length
When the first two PUSCH repetitions have the same frequency resource amount
When the first two PUSCH repetitions have the same number of REs
If the specific condition is not satisfied, the UE may operate in a combination of at least one of [Method 2-1-1] to [Method 2-1-11]. Alternatively, the UE may multiplex an aperiodic CSI report on the first PUSCH repetition among the first two PUSCH repetitions, the PUSCH repetition, PUSCH repetition notified by higher layer signaling, MAC-CE, and L1 signaling, PUSCH repetition with a large amount of time and/or frequency resources, PUSCH repetition with a small amount of resources, PUSCH repetition transmitted in an uplink slot or a set of consecutive uplink symbols, or PUSCH repetition transmitted in an SBFD slot or a set of consecutive SBFD symbols.
For [Method 2-1-5], the UE may report the UE capability for aperiodic CSI report multiplexing during the SBFD operation to the base station.
As an example, the UE and the base station may use the [Method 2-1-5]according to the UE capability report of the UE, and there may be no specific higher layer signaling that the UE may be configured from the base station for [Method 2-1-5].
As another example, the base station may configure specific higher layer signaling to the UE that means using [Method 2-1-5] according to the UE capability report of the UE. If the corresponding higher layer signaling is not configured, the UE may operate in a combination of at least one of [Method 2-1-1] to [Method 2-1-11].
[Method 2-1-6] The UE may multiplex the corresponding aperiodic CSI report in the PUSCH repetition transmitted in the first uplink slot or the first set of consecutive uplink symbols, and with the PUSCH repetition transmitted in the first SBFD slot or first set of consecutive SBFD symbols.
Through this, since the UE may transmit an aperiodic CSI report to the base station using two slots or a set of consecutive symbols with two different interference situations, even if the base station's reception performance is poor in either the uplink slot and the set of consecutive uplink symbols, or the SBFD slot and the set of consecutive SBFD symbols, the base station may achieve the diversity effect as the aperiodic CSI reports are repeatedly transmitted. In addition, since the UE transmits an aperiodic CSI report considering both the uplink slot or the set of consecutive uplink symbols, and the SBFD slot or the set of consecutive SBFD symbols, although multiplexing of two aperiodic CSI reports is required, the delay time until the aperiodic CSI report is transmitted to the base station may be reduced.
If the UE is scheduled based on PUSCH repetition type B, the PUSCH repetition may be the actual repetition.
The UE may multiplex aperiodic CSI reports in both the PUSCH repetition transmitted in the first uplink slot or the first set of consecutive uplink symbols and the PUSCH repetition transmitted in the first SBFD slot or the first set of consecutive SBFD symbols without any specific conditions. Even if the PUSCH repetition transmitted in the first uplink slot or the first set of consecutive uplink symbols and the PUSCH repetition transmitted in the first SBFD slot or the first set of consecutive SBFD symbols have different OFDM symbol lengths, different amount of frequency resources, or different number of REs, the UE may multiplex aperiodic CSI reports in both the PUSCH repetition transmitted in the first uplink slot or the first set of consecutive uplink symbols and the PUSCH repetition transmitted in the first SBFD slot or the first set of consecutive SBFD symbols.
Alternatively, the UE may multiplex aperiodic CSI reports in both the PUSCH repetition transmitted in the first uplink slot or the first set of consecutive uplink symbols and the PUSCH repetition transmitted in the first SBFD slot or the first set of consecutive SBFD symbols only if a specific condition is satisfied, and such conditions may be a combination of at least one of the following.
When the PUSCH repetition transmitted in the first uplink slot or the first set of consecutive uplink symbols and the PUSCH repetition transmitted in the first SBFD slot or the first set of consecutive SBFD symbols have the same OFDM symbol length
When the PUSCH repetition transmitted in the first uplink slot or the first set of consecutive uplink symbols and the PUSCH repetition transmitted in the first SBFD slot or the first set of consecutive SBFD symbols have the same frequency resource amount
When the PUSCH repetition transmitted in the first uplink slot or the first set of consecutive uplink symbols and the PUSCH repetition transmitted in the first SBFD slot or the first set of consecutive SBFD symbols have the same number of Res
If the specific condition is not satisfied or at least one of the two PUSCH repetitions does not occur (i.e., if all PUSCH repetitions are transmitted in an uplink slot or a set of consecutive uplink symbols, or if all PUSCH repetitions are transmitted in an SBFD slot or a set of consecutive SBFD symbols), the UE may operate in a combination of at least one of [Method 2-1-1] to [Method 2-1-11]. Alternatively, the UE may multiplex an aperiodic CSI report in one of the PUSCH repetition transmitted in the first uplink slot or the first set of consecutive uplink symbols and the PUSCH repetition transmitted in the first SBFD slot or the first set of consecutive SBFD symbols, and in this case, one PUSCH repetition may correspond to PUSCH repetition transmitted in the first uplink slot or in the first set of consecutive uplink symbols, PUSCH repetition transmitted in the first SBFD slot or in the first set of consecutive SBFD symbols, PUSCH repetition that appears first in the time dimension among the two PUSCH repetitions, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
For [Method 2-1-6], the UE may report the UE capability for aperiodic CSI report multiplexing during the SBFD operation to the base station.
As an example, the UE and the base station may use the [Method 2-1-6]according to the UE capability report of the UE, and there may be no specific higher layer signaling that the UE may be configured from the base station for [Method 2-1-6].
As another example, the base station may configure specific higher layer signaling to the UE that means using [Method 2-1-6] according to the UE capability report of the UE. If the corresponding higher layer signaling is not configured, the UE may operate in a combination of at least one of [Method 2-1-1] to [Method 2-1-11].
[Method 2-1-7] The UE may multiplex the corresponding aperiodic CSI report in the PUSCH repetition transmitted in the first SBFD slot or the first set of consecutive SBFD symbols, and with the PUSCH repetition transmitted in the second SBFD slot or second set of consecutive SBFD symbols. (Similarly, the UE may multiplex the corresponding aperiodic CSI report in the PUSCH repetition transmitted in the first uplink slot or the first set of consecutive uplink symbols, and with the PUSCH repetition transmitted in the second uplink slot or second set of consecutive uplink symbols.)
Through this, the UE may transmit the aperiodic CSI report with a low delay time and reduce a time interval between two transmissions of the aperiodic CSI report by utilizing multiple SBFD slots or sets of consecutive SBFD symbols that allow the UE to have more opportunities for uplink transmission than using uplink slots. In addition, diversity effects according to different downlink interference amounts in two SBFD slots or two sets of consecutive SBFD symbols may also be acquired. Alternatively, the UE may transmit an aperiodic CSI report to have stable reception performance by multiplexing the corresponding aperiodic CSI report on PUSCH repetition transmitted in the first uplink slot or the first set of consecutive uplink symbols, and the second uplink slot or second consecutive uplink symbols. The PUSCH repetition transmitted in the SBFD slot or set of consecutive SBFD symbols described below may be understood as a PUSCH repetition transmitted in the uplink slot and set of consecutive uplink symbols.
If the UE is scheduled based on PUSCH repetition type B, the PUSCH repetition may be the actual repetition.
The UE may multiplex aperiodic CSI reports in both the PUSCH repetition transmitted in the first SBFD slot or the first set of consecutive SBFD symbols and the PUSCH repetition transmitted in the second SBFD slot or the second set of consecutive SBFD symbols without any specific conditions. Even if the PUSCH repetition transmitted in the first SBFD slot or the first set of consecutive SBFD symbols and the PUSCH repetition transmitted in the second SBFD slot or the second set of consecutive SBFD symbols have different OFDM symbol lengths, different amount of frequency resources, or different number of REs, the UE may multiplex aperiodic CSI reports in both the PUSCH repetition transmitted in the first SBFD slot or the first set of consecutive SBFD symbols and the PUSCH repetition transmitted in the second SBFD slot or the second set of consecutive SBFD symbols.
Alternatively, the UE may multiplex aperiodic CSI reports in both the PUSCH repetition transmitted in the first SBFD slot or the first set of consecutive SBFD symbols and the PUSCH repetition transmitted in the second SBFD slot or the second set of consecutive SBFD symbols only if a specific condition is satisfied, and such conditions may be a combination of at least one of the following.
When the PUSCH repetition transmitted in the first SBFD slot or the first set of consecutive SBFD symbols and the PUSCH repetition transmitted in the second SBFD slot or the second set of consecutive SBFD symbols have the same OFDM symbol length
When the PUSCH repetition transmitted in the first SBFD slot or the first set of consecutive SBFD symbols and the PUSCH repetition transmitted in the second SBFD slot or the second set of consecutive SBFD symbols have the same frequency resource amount
When the PUSCH repetition transmitted in the first SBFD slot or the first set of consecutive SBFD symbols and the PUSCH repetition transmitted in the second SBFD slot or the second set of consecutive SBFD symbols have the same number of REs
If the specific condition is not satisfied or at least one of the two PUSCH repetitions does not occur (i.e., if all PUSCH repetitions are transmitted in an uplink slot or a set of consecutive uplink symbols, or if one PUSCH repetition is transmitted in an SBFD slot or a set of consecutive SBFD symbols), the UE may operate in a combination of at least one of [Method 2-1-1] to [Method 2-1-11]. Alternatively, the UE may multiplex an aperiodic CSI report on one of the PUSCH repetition transmitted in the first SBFD slot or the first set of consecutive SBFD symbols and the PUSCH repetition transmitted in the second SBFD slot or the second set of consecutive SBFD symbols, and in this case, one PUSCH repetition may correspond to PUSCH repetition transmitted in the first uplink slot or in the first set of consecutive uplink symbols, PUSCH repetition transmitted in the second SBFD slot or in the second set of consecutive SBFD symbols, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
For [Method 2-1-7], the UE may report the UE capability for aperiodic CSI report multiplexing during the SBFD operation to the base station.
As an example, the UE and the base station may use the [Method 2-1-7]according to the UE capability report of the UE, and there may be no specific higher layer signaling that the UE may be configured from the base station for [Method 2-1-7].
As another example, the base station may configure specific higher layer signaling to the UE that means using [Method 2-1-7] according to the UE capability report of the UE. If the corresponding higher layer signaling is not configured, the UE may operate in a combination of at least one of [Method 2-1-1] to [Method 2-1-11].
[Method 2-1-8] The UE may multiplex the corresponding aperiodic CSI report in the PUSCH repetition transmitted in the first SBFD slot or the first set of consecutive SBFD symbols, and the PUSCH repetition transmitted in the X-th SBFD slot or X-th set of consecutive SBFD symbols notified from the base station. (Similarly, the UE may multiplex the corresponding aperiodic CSI report in the PUSCH repetition transmitted in the first uplink slot or the first set of consecutive uplink symbols, and the PUSCH repetition transmitted in the X-th uplink slot or X-th set of consecutive uplink symbols notified from the base station.) The X may be notified from the base station by using a combination of at least one of higher layer signaling, MAC-CE, and L1 signaling.
Through this, the UE may transmit the aperiodic CSI report with a low delay time and reduce a time interval between two transmissions of the aperiodic CSI report by utilizing multiple SBFD slots or sets of consecutive SBFD symbols that allow the UE to have more opportunities for uplink transmission than using uplink slots, and diversity effects according to different downlink interference amounts in two SBFD slots or two sets of consecutive SBFD symbols may also be acquired. In addition, the delay time for aperiodic CSI report transmission may be reduced by the UE using the first SBFD resource rather than using the first two SBFD resources, and as the UE uses the X-th SBFD resource indicated by the base station, the base station may secure time to control the interference situation by adjusting uplink and downlink scheduling situations for the X-th SBFD resource.
If the UE is scheduled based on PUSCH repetition type B, the PUSCH repetition may be the actual repetition.
The UE may multiplex aperiodic CSI reports in both the PUSCH repetition transmitted in the first SBFD slot or the first set of consecutive SBFD symbols, and the PUSCH repetition transmitted in the X-th SBFD slot or X-th set of consecutive SBFD symbols notified from the base station without any specific conditions. Even if the PUSCH repetition transmitted in the first SBFD slot or the first set of consecutive SBFD symbols, and the PUSCH repetition transmitted in the X-th SBFD slot or X-th set of consecutive SBFD symbols notified from the base station have different OFDM symbol lengths, different amount of frequency resources, or different number of REs, the UE may multiplex aperiodic CSI reports in both the PUSCH repetition transmitted in the first SBFD slot or the first set of consecutive SBFD symbols, and the PUSCH repetition transmitted in the X-th SBFD slot or X-th set of consecutive SBFD symbols notified from the base station.
Alternatively, the UE may multiplex aperiodic CSI reports in both the PUSCH repetition transmitted in the first SBFD slot or the first set of consecutive SBFD symbols, and the PUSCH repetition transmitted in the X-th SBFD slot or X-th set of consecutive SBFD symbols notified from the base station only if a specific condition is satisfied, and such conditions may be a combination of at least one of the following.
When the PUSCH repetition transmitted in the first SBFD slot or the first set of consecutive SBFD symbols, and the PUSCH repetition transmitted in the X-th SBFD slot or X-th set of consecutive SBFD symbols notified from the base station have the same OFDM symbol length
When the PUSCH repetition transmitted in the first SBFD slot or the first set of consecutive SBFD symbols, and the PUSCH repetition transmitted in the X-th SBFD slot or X-th set of consecutive SBFD symbols notified from the base station have the same frequency resource amount
When the PUSCH repetition transmitted in the first SBFD slot or the first set of consecutive SBFD symbols, and the PUSCH repetition transmitted in the X-th SBFD slot or X-th set of consecutive SBFD symbols notified from the base station have the same number of REs
If the specific condition is not satisfied or at least one of the two PUSCH repetitions does not occur (i.e., if all PUSCH repetitions are transmitted in an uplink slot or a set of consecutive uplink symbols, or if one PUSCH repetition is transmitted in an SBFD slot or a set of consecutive SBFD symbols, or if the PUSCH transmitted in the X-th SBFD slot or the X-th set of consecutive SBFD symbols instructed by the base station is not transmitted or does not exist), the UE may operate in a combination of at least one of [Method 2-1-1] to [Method 2-1-11]. Alternatively, the UE may multiplex an aperiodic CSI report on one of the PUSCH repetition transmitted in the first SBFD slot or the first set of consecutive SBFD symbols, and the PUSCH repetition transmitted in the X-th SBFD slot or X-th set of consecutive SBFD symbols notified from the base station, and in this case, one PUSCH repetition may correspond to PUSCH repetition transmitted in the first SBFD slot or the first set of consecutive SBFD symbols, PUSCH repetition transmitted in the X-th SBFD slot or X-th set of consecutive SBFD symbols notified from the base station, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
For [Method 2-1-8], the UE may report the UE capability for aperiodic CSI report multiplexing during the SBFD operation to the base station.
As an example, the UE and the base station may use the [Method 2-1-8]according to the UE capability report of the UE, and there may be no specific higher layer signaling that the UE may be configured from the base station for [Method 2-1-8].
As another example, the base station may configure specific higher layer signaling to the UE that means using [Method 2-1-8] according to the UE capability report of the UE. If the corresponding higher layer signaling is not configured, the UE may operate in a combination of at least one of [Method 2-1-1] to [Method 2-1-11].
[Method 2-1-9] The UE may multiplex the corresponding aperiodic CSI report in the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station. (Similarly, the X1-th and X2-th resources may be SBFD resources or uplink resources, respectively.) The X1 and X2 may be notified from the base station by using a combination of at least one of higher layer signaling, MAC-CE, and L1 signaling.
Through this, as the UE performs an aperiodic CSI report on resources indicated by the base station, there is an advantage of being able to fully control interference that may be experienced when the aperiodic CSI report is not transmitted due to insufficient processing time or when it is multiplexed in the PUSCH transmitted from random resources. However, the signaling overhead that the base station must indicate increases, and the scheduling of the base station may become complicated to ensure reception performance of the PUSCH transmitted in the X1-th and X2-th resources.
If the UE is scheduled based on PUSCH repetition type B, the PUSCH repetition may be the actual repetition.
The UE may multiplex aperiodic CSI reports in both the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station without any specific conditions. Even if the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station have different OFDM symbol lengths, different amount of frequency resources, or different number of REs, the UE may multiplex aperiodic CSI reports in both the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station.
The UE may multiplex aperiodic CSI reports in both the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station only if a specific condition is satisfied, and such conditions may be a combination of at least one of the following.
When the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station have the same OFDM symbol length
When the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station have the same frequency resource amount
When the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station have the same number of REs
If the specific condition is not satisfied or at least one of the two PUSCH repetitions does not occur (i.e., if all PUSCH repetitions are transmitted in an uplink slot or a set of consecutive uplink symbols, or if one PUSCH repetition is transmitted in an SBFD slot or a set of consecutive SBFD symbols, or if the PUSCH transmitted in the X1-th SBFD slot or the X1-th set of consecutive SBFD symbols or transmitted in the X2-th SBFD slot or the X2-th set of consecutive SBFD symbols instructed by the base station is not transmitted or does not exist), the UE may operate in a combination of at least one of [Method 2-1-1] to [Method 2-1-11]. Alternatively, the UE may multiplex an aperiodic CSI report on one of the PUSCH repetition transmitted in the X1-th SBFD slot or the X1-th set of consecutive SBFD symbols notified from the base station, and the PUSCH repetition transmitted in the X2-th SBFD slot or X2-th set of consecutive SBFD symbols notified from the base station, and in this case, one PUSCH repetition may correspond to PUSCH repetition transmitted in the X1-th SBFD slot or the X1-th set of consecutive SBFD symbols notified from the base station, PUSCH repetition transmitted in the X2-th SBFD slot or X2-th set of consecutive SBFD symbols notified from the base station, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
For [Method 2-1-9], the UE may report the UE capability for aperiodic CSI report multiplexing during the SBFD operation to the base station.
As an example, the UE and the base station may use the [Method 2-1-9]according to the UE capability report of the UE, and there may be no specific higher layer signaling that the UE may be configured from the base station for [Method 2-1-9].
As another example, the base station may configure specific higher layer signaling to the UE that means using [Method 2-1-9] according to the UE capability report of the UE. If the corresponding higher layer signaling is not configured, the UE may operate in a combination of at least one of [Method 2-1-1] to [Method 2-1-11].
[Method 2-1-10] The UE may multiplex the corresponding aperiodic CSI report in two PUSCH repetitions with the same amount of time and/or frequency resources (e.g., OFDM symbol length, number of RBs per symbol, or total number of REs) among PUSCH repetition transmitted in the N-th SBFD slot or a set of consecutive SBFD symbols and PUSCH repetition transmitted in the N-th uplink slot or a set of consecutive uplink symbols. The N may be determined by the UE itself by calculating the resource amount of the PUSCH repetition transmitted in each N-th SBFD slot or a set consecutive SBFD symbols and the PUSCH repetition transmitted in the N-th uplink slot or a set consecutive uplink symbols, and as the base station notifies the N by using at least one combination of higher layer signaling, MAC-CE, and L1 signaling, the base station may ensure that the resource amount of the PUSCH repetition transmitted in the N-th SBFD slot or a set consecutive SBFD symbols and the PUSCH repetition transmitted in the N-th uplink slot or a set consecutive uplink symbols are the same.
Through this, the UE may have the advantage of transmitting the aperiodic CSI report twice to the base station under different interference conditions in the SBFD and uplink resources by multiplexing the aperiodic CSI report in two PUSCH reports with the same resource amount. However, the scheduling complexity of the base station or additional calculation of the UE may be required because the resource amount comparison calculation for the PUSCH repetition transmitted in the N-th SBFD slot or a set of consecutive SBFD symbols and PUSCH repetition transmitted in the N-th uplink slot or a set of consecutive uplink symbols is performed N times in the UE, or the base station must ensure that the amount of resources between the PUSCH repetition transmitted in the N-th SBFD slot or a set of consecutive SBFD symbols and PUSCH repetition transmitted in the N-th uplink slot or a set of consecutive uplink symbols are the same.
If the UE is scheduled based on PUSCH repetition type B, the PUSCH repetition may be the actual repetition.
If the UE cannot multiplex the aperiodic CSI report in the PUSCH repetition transmitted in the N-th SBFD slot or a set of consecutive SBFD symbols and PUSCH repetition transmitted in the N-th uplink slot or a set of consecutive uplink symbols, it may be a combination of at least one of the following.
When the PUSCH repetition transmitted in the N-th SBFD slot or a set of consecutive SBFD symbols and PUSCH repetition transmitted in the N-th uplink slot or a set of consecutive uplink symbols with the same resource amount through calculation by the UE do not exist
When all PUSCH repetitions are transmitted only in SBFD resources or only in uplink resources
When the base station fails to match the amount of resources of the PUSCH repetition transmitted in the N-th SBFD slot or a set of consecutive SBFD symbols and PUSCH repetition transmitted in the N-th uplink slot or a set of consecutive uplink symbols
If the specific condition is not satisfied, the UE may operate in a combination of at least one of [Method 2-1-1] to [Method 2-1-11]. Alternatively, if theN is notified by the base station, the UE may multiplex an aperiodic CSI report in one of the PUSCH repetition transmitted in the N-th SBFD slot or a set of consecutive SBFD symbols and PUSCH repetition transmitted in the N-th uplink slot or a set of consecutive uplink symbols, and in this case, one PUSCH repetition may correspond to PUSCH repetition transmitted in the N-th SBFD slot or the N-th set of consecutive SBFD symbols notified from the base station, PUSCH repetition that appears first in the time dimension among the two PUSCH repetitions, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
For [Method 2-1-10], the UE may report the UE capability for aperiodic CSI report multiplexing during the SBFD operation to the base station.
As an example, the UE and the base station may use the [Method 2-1-10]according to the UE capability report of the UE, and there may be no specific higher layer signaling that the UE may be configured from the base station for [Method 2-1-10].
As another example, the base station may configure specific higher layer signaling to the UE that means using [Method 2-1-10] according to the UE capability report of the UE. If the corresponding higher layer signaling is not configured, the UE may operate in a combination of at least one of [Method 2-1-1] to [Method 2-1-11].
[Method 2-1-11] The UE may be notified by the base station through a combination of at least one of higher layer signaling, MAC-CE, and L1 signaling to use a combination of at least one of the [Method 2-1-1] to [Method 2-1-10], or at least one combination may be fixedly defined in the standard. As an example, when the UE receives SBFD configuration and resource allocation information from the base station, and when the UE receives an aperiodic CSI report instruction from the base station through DCI, the [Method 2-1-1] may be defined as a method fixed in the standard as a method of multiplexing the aperiodic CSI report. As another example, the UE may receive notification of one of [Method 2-1-1] to [Method 2-1-4] from the base station through a combination of at least one of higher layer signaling, MAC-CE, and L1 signaling. As another example, the UE may receive notification of one of [Method 2-1-1] and [Method 2-1-5] from the base station through a combination of at least one of higher layer signaling, MAC-CE, and L1 signaling. The above description may only be an example, and other combinations may not be excluded.
For [Method 2-1-11], the UE may report the UE capability for aperiodic CSI report multiplexing during the SBFD operation to the base station.
As an example, the UE and the base station may use the [Method 2-1-11]according to the UE capability report of the UE, and there may be no specific higher layer signaling that the UE may be configured from the base station for [Method 2-1-11].
As another example, the base station may configure specific higher layer signaling to the UE that means using [Method 2-1-11] according to the UE capability report of the UE. If the corresponding higher layer signaling is not configured, the UE may operate in a combination of at least one of [Method 2-1-1] to [Method 2-1-11].

### Embodiment 2-2: Aperiodic CSI Report Multiplexing or Semi-Persistent CSI Report Multiplexing Method when Scheduling PUSCH Repetition not Including Transport Block

### Condition 2-2

When the UE receives an aperiodic CSI report instruction or a semi-persistent CSI report instruction from the base station through DCI, PUSCH scheduled through the corresponding DCI may not include a transport block, and the corresponding PUSCH may be a PUSCH that is repeatedly transmitted in the PUSCH repetition type A or B method, depending on the PUSCH repetition type configured by the UE through higher layer signaling and the number of repetition transmissions configured in the entry of the TDRA field that the UE may receive instructions through DCI. Additional conditions may be a combination of at least one of the following.
[Condition 2-2-1] The UE may receive scheduling on the transmission method (TBoMS: TB over Multiple Slots) of processing a transport block included in a PUSCH by using a plurality of slots from the base station through DCI format 0_1 or 0_2 based on a PDCCH including a CRC scrambled with a C-RNTI, an MCS-C-RNTI, or a CS-RNTI. That is, it may be a case in which the UE is configured through numberOfSlotsTBoMS, which is higher layer signaling, from the base station for N, which is the number of slots for determining the transport block size, and a case in which the UE is indicated the entry of the TDRA field in which numberOfSlotsTBoMS is configured through the TDRA field in the DCI.
[Condition 2-2-2] When the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’
[Condition 2-2-3] When the UE is configured with one SRS resource set in which the usage is configured as codebook or non-codebook through higher layer signaling from the base station (therefore, there is no SRS resource set indicator field within the DCI)
[Condition 2-2-4] Whether aperiodic CSI report is instructed
[Condition 2-2-5] In the case of the first PUSCH transmission after receiving a DCI indicating semi-persistent CSI report
[Condition 2-2-6] In the case of PUSCH transmitted without DCI scheduling in the next cycle after the first PUSCH transmission after receiving the DCI indicating semi-persistent CSI report
[Condition 2-2-7] Conditions for multiplexed CSI in addition to aperiodic CSI report or semi-persistent CSI report
Regarding the combination of at least one of the [Condition 2-2] and its detailed conditions [Condition 2-2-1] to [Condition 2-2-7], the UE and base station may define a multiplexing method for aperiodic CSI report or semi-persistent CSI report by considering a combination of at least one of the following methods.
[Method 2-2-1] The UE may regard the number of repetitive transmissions as 1 regardless of the indicated number of repetitive transmissions, and one transmission may be the first repetitive transmission among a plurality of indicated repetitive transmissions. The UE may perform specific operations as follows according to PUSCH repetition type A or B, which may be configured by higher layer signaling.
In the case of PUSCH repetition type A, the UE may regard the number of PUSCH repetitive transmissions as 1 regardless of the configured and indicated number of PUSCH repetitive transmissions, and one transmission may be the first repetitive transmission among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the corresponding first PUSCH repetition.
In the case of PUSCH repetition type B, the UE may regard the value of nominal repetition as 1 regardless of the value of nominal repetition configured and indicated, and one transmission may be the first nominal repetition among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report, the UE may consider that the first nominal repetition has the same amount of time and/or frequency resources (e.g., OFDM symbol length, number of RBs per symbol, or total number of REs) as the first actual repetition, and may multiplex the aperiodic CSI report in the corresponding first actual repetition.
If the PUSCH is transmitted without DCI scheduling in the next cycle after the first PUSCH is transmitted after receiving the DCI instructing a semi-persistent CSI report, and if the first nominal repetition has different amount of time and/or frequency resources (e.g., OFDM symbol length, number of RBs per symbol, or total number of REs) with the first actual repetition, the UE may ignore transmission for the first actual repetition. In this case, the semi-persistent CSI report in the corresponding cycle may not be performed.
Through this, the UE may quickly transmit the aperiodic CSI report and the semi-persistent CSI report to the base station while consuming the shortest delay time, but if the first PUSCH repetition transmitted first is located in an uplink subband within an SBFD slot or a set of consecutive SBFD symbols and the interference due to downlink scheduling within the slot or symbol is strong, the periodic CSI report transmitted by the UE may not be properly decoded by the base station.
Accordingly, when the base station instructs aperiodic CSI report through DCI, if the first repetition is located in an uplink subband within an SBFD slot or a set of consecutive SBFD symbols, the base station may adjust the amount of self-interference at the base station where downlink transmission affects uplink reception by adjusting quasi-static or dynamic downlink scheduling in the corresponding SBFD slot. The base station scheduler may delay dynamic downlink scheduling, perform quasi-statically configuration, scheduling, or transmitting activated downlink channels and signals as they are, or cancel downlink transmission according to conditions with an SBFD slot or a set of consecutive SBFD symbols or a downlink slot or a set of consecutive downlink symbols in which aperiodic CSI report is not transmitted.
For [Method 2-2-1], the UE may report the UE capability for aperiodic CSI report or semi-persistent CSI multiplexing during the SBFD operation to the base station.
As an example, the UE and the base station may use the [Method 2-2-1]according to the UE capability report of the UE, and there may be no specific higher layer signaling that the UE may be configured from the base station for [Method 2-2-1].
As another example, the base station may configure specific higher layer signaling to the UE that means using [Method 2-2-1] according to the UE capability report of the UE. If the corresponding higher layer signaling is not configured, the UE may operate in a combination of at least one of [Method 2-2-1] to [Method 2-2-11].
[Method 2-2-2] The UE may regard the number of repetitive transmissions as 1 regardless of the indicated number of repetitive transmissions, and one transmission may be a repetitive transmission transmitted in the first uplink slot or the first set of consecutive uplink symbols among a plurality of indicated repetitive transmissions. The UE may perform specific operations as follows according to PUSCH repetition type A or B, which may be configured by higher layer signaling.
In the case of PUSCH repetition type A, the UE may regard the number of PUSCH repetitive transmissions as 1 regardless of the configured and indicated number of PUSCH repetitive transmissions. The one transmission may be a repetitive transmission transmitted in the first uplink slot or the first set of consecutive uplink symbols among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the corresponding first PUSCH repetition.
In the case of PUSCH repetition type B, the UE may regard the value of nominal repetition as 1 regardless of the value of nominal repetition configured and indicated. The one transmission may be a repetitive transmission transmitted in the first uplink slot or the first set of consecutive uplink symbols among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report, the UE may consider that the first nominal repetition has the same amount of time and/or frequency resources (e.g., OFDM symbol length, number of RBs per symbol, or total number of REs) as the first actual repetition, and may multiplex the aperiodic CSI report in the corresponding first actual repetition.
If the PUSCH is transmitted without DCI scheduling in the next cycle after the first PUSCH is transmitted after receiving the DCI instructing a semi-persistent CSI report, and if the first nominal repetition has different amount of time and/or frequency resources (e.g., OFDM symbol length, number of RBs per symbol, or total number of REs) with the first actual repetition, the UE may ignore transmission for the first actual repetition. In this case, the semi-persistent CSI report in the corresponding cycle may not be performed.
Through this, the UE may transmit an aperiodic CSI report to the base station while avoiding interference from downlink scheduling that may be experienced by the PUSCH, which may be transmitted in an uplink subband within an SBFD slot or a set of consecutive SBFD symbols. However, the delay time may increase depending on how soon the first uplink slot or set of consecutive uplink symbols for which the UE may be scheduled appears from the DCI instructing the corresponding aperiodic CSI report.
Accordingly, in order to reduce the delay time, the base station may transmit a DCI instructing the aperiodic CSI report to the UE in a downlink resource close to the location of an uplink slot or a set of consecutive uplink symbols.
If all PUSCH repetitions are transmitted in an SBFD slot or a set of consecutive SBFD symbols, that is, if there are no PUSCH repetitions transmitted in an uplink slot or a set of consecutive uplink symbols, the UE may operate in a combination of at least one of [Method 2-2-1] to [Method 2-2-11].
For [Method 2-2-2], the UE may report the UE capability for aperiodic CSI report multiplexing during the SBFD operation to the base station.
As an example, the UE and the base station may use the [Method 2-2-2]according to the UE capability report of the UE, and there may be no specific higher layer signaling that the UE may be configured from the base station for [Method 2-2-2].
As another example, the base station may configure specific higher layer signaling to the UE that means using [Method 2-2-2] according to the UE capability report of the UE. If the corresponding higher layer signaling is not configured, the UE may operate in a combination of at least one of [Method 2-2-1] to [Method 2-2-11].
[Method 2-2-3] The UE may regard the number of repetitive transmissions as 1 regardless of the indicated number of repetitive transmissions, and one transmission may be a repetitive transmission transmitted in the first SBFD slot or the first set of consecutive SBFD symbols among a plurality of indicated repetitive transmissions. The UE may perform specific operations as follows according to PUSCH repetition type A or B, which may be configured by higher layer signaling.
In the case of PUSCH repetition type A, the UE may regard the number of PUSCH repetitive transmissions as 1 regardless of the configured and indicated number of PUSCH repetitive transmissions. The one transmission may be a repetitive transmission transmitted in the first SBFD slot or the first set of consecutive SBFD symbols among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the corresponding first PUSCH repetition.
In the case of PUSCH repetition type B, the UE may regard the value of nominal repetition as 1 regardless of the value of nominal repetition configured and indicated. The one transmission may be a repetitive transmission transmitted in the first SBFD slot or the first set of consecutive SBFD symbols among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report, the UE may consider that the first nominal repetition has the same amount of time and/or frequency resources (e.g., OFDM symbol length, number of RBs per symbol, or total number of REs) as the first actual repetition, and may multiplex the aperiodic CSI report in the corresponding first actual repetition.
If the PUSCH is transmitted without DCI scheduling in the next cycle after the first PUSCH is transmitted after receiving the DCI instructing a semi-persistent CSI report, and if the first nominal repetition has different amount of time and/or frequency resources (e.g., OFDM symbol length, number of RBs per symbol, or total number of REs) with the first actual repetition, the UE may ignore transmission for the first actual repetition. That is, the UE may not perform the semi-persistent CSI report in the corresponding cycle.
Since an SBFD slot or a set of consecutive SBFD symbols may exist more frequently than an uplink slot or a set of consecutive uplink symbols, the UE may transmit an aperiodic CSI report to the base station after a relatively short delay time. However, if the interference due to downlink scheduling in the same SBFD slot or the same set of consecutive SBFD symbols in the uplink subband within the first SBFD slot or the first set of consecutive SBFD symbols is strong, the aperiodic CSI report transmitted by the UE may not be properly decoded by the base station.
Accordingly, when instructing aperiodic CSI report through DCI, similar to the above, the base station may control downlink transmission that may be scheduled semi-statically or dynamically, so that aperiodic CSI report in the first SBFD slot or first set of consecutive SBFD symbols is multiplexed from the UE to ensure PUSCH reception performance when receiving the PUSCH to be transmitted from the base station.
If all PUSCH repetitions are transmitted in an uplink slot or a set of consecutive uplink symbols, that is, if there are no PUSCH repetitions transmitted in an SBFD slot or a set of consecutive SBFD symbols, the UE may operate in a combination of at least one of [Method 2-2-1] to [Method 2-2-11].
For [Method 2-2-3], the UE may report the UE capability for aperiodic CSI report multiplexing during the SBFD operation to the base station.
As an example, the UE and the base station may use the [Method 2-2-3]according to the UE capability report of the UE, and there may be no specific higher layer signaling that the UE may be configured from the base station for [Method 2-2-3].
As another example, the base station may configure specific higher layer signaling to the UE that means using [Method 2-2-3] according to the UE capability report of the UE. If the corresponding higher layer signaling is not configured, the UE may operate in a combination of at least one of [Method 2-2-1] to [Method 2-2-11].
[Method 2-2-4] The UE may regard the number of repetitive transmissions as 1 regardless of the indicated number of repetitive transmissions, and one transmission may be a repetitive transmission transmitted in the X-th appearing SBFD slot or the X-th appearing set of consecutive SBFD symbols, after receiving scheduling through DCI among a plurality of indicated repetitive transmissions. The X may be notified from the base station by using a combination of at least one of higher layer signaling, MAC-CE, and L1 signaling. (Similarly, the UE may multiplex the corresponding aperiodic CSI report in the PUSCH repetition transmitted in the X-th appearing uplink slot or the X-th appearing set of consecutive SBFD symbols.) The UE may perform specific operations as follows according to PUSCH repetition type A or B, which may be configured by higher layer signaling.
In the case of PUSCH repetition type A, the UE may regard the number of PUSCH repetitive transmissions as 1 regardless of the configured and indicated number of PUSCH repetitive transmissions. The one transmission may be a repetitive transmission transmitted in the X-th appearing SBFD slot or the X-th appearing set of consecutive SBFD symbols, after receiving scheduling through DCI among a plurality of indicated repetitive transmissions. The X may be notified from the base station by using a combination of at least one of higher layer signaling, MAC-CE, and L1 signaling. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the corresponding first PUSCH repetition.
In the case of PUSCH repetition type B, the UE may regard the value of nominal repetition as 1 regardless of the value of nominal repetition configured and indicated. The one transmission may be a repetitive transmission transmitted in the X-th appearing SBFD slot or the X-th appearing set of consecutive SBFD symbols, after receiving scheduling through DCI among a plurality of indicated repetitive transmissions. The X may be notified from the base station by using a combination of at least one of higher layer signaling, MAC-CE, and L1 signaling. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report, the UE may consider that the first nominal repetition has the same amount of time and/or frequency resources (e.g., OFDM symbol length, number of RBs per symbol, or total number of REs) as the first actual repetition, and may multiplex the aperiodic CSI report in the corresponding first actual repetition.
If the PUSCH is transmitted without DCI scheduling in the next cycle after the first PUSCH is transmitted after receiving the DCI instructing a semi-persistent CSI report, and if the first nominal repetition has different amount of time and/or frequency resources (e.g., OFDM symbol length, number of RBs per symbol, or total number of REs) with the first actual repetition, the UE may ignore transmission for the first actual repetition. That is, the UE may not perform the semi-persistent CSI report in the corresponding cycle.
As an example, if X is notified to the UE based on higher layer signaling, in the case of aperiodic CSI report, the UE may be configured with a specific X value in CSI-AperiodicTriggerState or CSI-AssociatedReportConfigInfo, for example, which is higher layer signaling, and in the case of semi-persistent CSI report, the UE may be configured with a specific X value in the CSI-Semi PersistentOnPUSCH-TriggerState or CSI-Semi PersistentOnPUSCH-TriggerStateList, for example, which is higher layer signaling.
As another example, if X is notified to the UE through a combination of higher layer signaling and L1 signaling, the UE, for example, may be configured with candidates for a plurality of X values in PUSCH-config, which is higher layer signaling, and may receive a specific X value from the base station through a new field in DCI or a reserved code point of an existing field.
For this purpose, the base station may adjust scheduling in the downlink resource within the corresponding X-th SBFD slot or the X-th appearing set of consecutive SBFD symbols to reduce interference with the PUSCH as described above while indicating the UE the X value simultaneously.
If all PUSCH repetitions are transmitted in an uplink slot or a set of consecutive uplink symbols, that is, if there are no PUSCH repetitions transmitted in an SBFD slot or a set of consecutive SBFD symbols, the UE may operate in a combination of at least one of [Method 2-2-1] to [Method 2-2-11].
For [Method 2-2-4], the UE may report the UE capability for aperiodic CSI report multiplexing during the SBFD operation to the base station.
As an example, the UE and the base station may use the [Method 2-2-4]according to the UE capability report of the UE, and there may be no specific higher layer signaling that the UE may be configured from the base station for [Method 2-2-4].
As another example, the base station may configure specific higher layer signaling to the UE that means using [Method 2-2-4] according to the UE capability report of the UE. If the corresponding higher layer signaling is not configured, the UE may operate in a combination of at least one of [Method 2-2-1] to [Method 2-2-11].
[Method 2-2-5] The UE may regard the number of repetitive transmissions as 2 regardless of the indicated number of repetitive transmissions, and two transmissions may be the first two repetitive transmissions among a plurality of indicated repetitive transmissions. The UE may perform specific operations as follows according to PUSCH repetition type A or B, which may be configured by higher layer signaling.
In the case of PUSCH repetition type A, the UE may regard the number of PUSCH repetitive transmissions as 2 regardless of the configured and indicated number of PUSCH repetitive transmissions. The two transmissions may be the first two PUSCH repetitions among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the corresponding first two PUSCH repetitions.
As an example, the UE may consider that the first two PUSCH repetitions have the same amount of time and/or frequency resources (e.g., OFDM symbol length, number of RBs per symbol, total number of REs). That is, the UE may expect the base station to guarantee the same time and/or frequency resource amount of the first two PUSCH repetitions.
As another example, the UE may multiplex the aperiodic CSI report in the first two PUSCH repetitions only if a specific condition is satisfied, and such conditions may be a combination of at least one of the following.
When the first two PUSCH repetitions have the same OFDM symbol length
When the first two PUSCH repetitions have the same frequency resource amount
When the first two PUSCH repetitions have the same number of REs
If the specific condition is not satisfied, the UE may operate in a combination of at least one of [Method 2-2-1] to [Method 2-2-11]. Alternatively, the UE may multiplex an aperiodic CSI report on the first PUSCH repetition among the first two PUSCH repetitions, the PUSCH repetition, PUSCH repetition notified by higher layer signaling, MAC-CE, and L1 signaling, PUSCH repetition with a large amount of time and/or frequency resources, PUSCH repetition with a small amount of resources, PUSCH repetition transmitted in an uplink slot or a set of consecutive uplink symbols, or PUSCH repetition transmitted in an SBFD slot or a set of consecutive SBFD symbols.
In the case of PUSCH repetition type B, the UE may regard the value of nominal repetition as 2 regardless of the value of nominal repetition configured and indicated. The two transmissions may be the first two PUSCH repetitions among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report,
The UE may consider that the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition. In addition, the UE may multiplex the aperiodic CSI report or semi-persistent CSI report in both the corresponding first and second actual repetitions.
As another example, the UE may multiplex the aperiodic CSI report in the first and second PUSCH repetitions only if a specific condition is satisfied, and such conditions may be a combination of at least one of the following.
When the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition
If the specific condition is not satisfied, the UE may operate in a combination of at least one of [Method 2-2-1] to [Method 2-2-11]. Alternatively, the UE may multiplex an aperiodic CSI report on the first PUSCH repetition among the first two PUSCH repetitions, the PUSCH repetition, PUSCH repetition notified by higher layer signaling, MAC-CE, and L1 signaling, PUSCH repetition with a large amount of time and/or frequency resources, PUSCH repetition with a small amount of resources, PUSCH repetition transmitted in an uplink slot or a set of consecutive uplink symbols, or PUSCH repetition transmitted in an SBFD slot or a set of consecutive SBFD symbols.
If the PUSCH is transmitted without DCI scheduling in the next cycle after the first PUSCH is transmitted after receiving the DCI instructing a semi-persistent CSI report,
If the first nominal repetition has the same amount of time and/or frequency resources (e.g., OFDM symbol length, number of RBs per symbol, or total number of REs) as the first actual repetition, and if the second nominal repetition has the same amount of time and/or frequency resources (e.g., OFDM symbol length, number of RBs per symbol, or total number of REs) as the second actual repetition, the UE may multiplex semi-persistent CSI reports in both the first and second actual repetitions.
If the first nominal repetition has different amount of time and/or frequency resources (e.g., OFDM symbol length, number of RBs per symbol, or total number of REs) with the first actual repetition, and if the second nominal repetition has the same amount of time and/or frequency resources (e.g., OFDM symbol length, number of RBs per symbol, or total number of REs) as the second actual repetition, the UE may ignore transmission for the first actual repetition, and may multiplex the semi-persistent CSI report in the second actual repetitions.
In addition, if the first nominal repetition has the same amount of time and/or frequency resources (e.g., OFDM symbol length, number of RBs per symbol, or total number of REs) as the first actual repetition, and if the second nominal repetition has different amount of time and/or frequency resources (e.g., OFDM symbol length, number of RBs per symbol, or total number of REs) with the second actual repetition, the UE may ignore transmission for the second actual repetition, and may multiplex the semi-persistent CSI report in the first actual repetitions.
In addition, if the first nominal repetition has different amount of time and/or frequency resources (e.g., OFDM symbol length, number of RBs per symbol, or total number of REs) with the first actual repetition, and if the second nominal repetition has different amount of time and/or frequency resources (e.g., OFDM symbol length, number of RBs per symbol, or total number of REs) with the second actual repetition, the UE may operate in a combination of at least one of [Method 2-2-1] to [Method 2-2-11]. Alternatively, the UE may multiplex an aperiodic CSI report on the first actual repetition among the first two PUSCH repetitions, the second actual repetition, actual repetition notified by higher layer signaling, MAC-CE, and L1 signaling, actual repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols, and may ignore transmission for the remaining one actual repetition.
Through this, the UE may multiplex the aperiodic CSI report in the first two PUSCH reports with different interference situations, allowing the base station receiver to acquire diversity from different reception situations of the two PUSCHs to which the aperiodic CSI report is transmitted. As an example, when the first two PUSCH repetitions are transmitted in two SBFD slots or two sets of consecutive SBFD symbols, the base station receiver may acquire diversity from different downlink interference situations in each SBFD slot or the set of consecutive SBFD symbols.
Accordingly, when the base station instructs the UE to perform the aperiodic CSI report through DCI, the base station may schedule the first two PUSCH repetitions to be transmitted in two SBFD slots or two sets of consecutive SBFD symbols, or may schedule one PUSCH repetition to be transmitted in an SBFD slot or a set of consecutive SBFD symbols, and the other PUSCH repetition to be transmitted in an uplink slot or a set of consecutive uplink symbols two PUSCHs, on which the UE may multiplex and transmit aperiodic CSI reports, to experience different interference situations or different reception situations.
For [Method 2-2-5], the UE may report the UE capability for aperiodic CSI report multiplexing during the SBFD operation to the base station.
As an example, the UE and the base station may use the [Method 2-2-5]according to the UE capability report of the UE, and there may be no specific higher layer signaling that the UE may be configured from the base station for [Method 2-2-5].
As another example, the base station may configure specific higher layer signaling to the UE that means using [Method 2-2-5] according to the UE capability report of the UE. If the corresponding higher layer signaling is not configured, the UE may operate in a combination of at least one of [Method 2-2-1] to [Method 2-2-11].
[Method 2-2-6] The UE may regard the number of repetitive transmissions as 2 regardless of the indicated number of repetitive transmissions. The two transmissions may be PUSCH repetition transmitted in the first uplink slot or the first set of consecutive uplink symbols among a plurality of indicated repetitive transmissions, and PUSCH repetition transmitted in the first SBFD slot or the first set of consecutive SBFD symbols. The UE may perform specific operations as follows according to PUSCH repetition type A or B, which may be configured by higher layer signaling.
In the case of PUSCH repetition type A, the UE may regard the number of PUSCH repetitive transmissions as 2 regardless of the configured and indicated number of PUSCH repetitive transmissions. The two transmissions may be the PUSCH repetition transmitted in the first uplink slot or the first set of consecutive uplink symbols, and the PUSCH repetition transmitted in the first SBFD slot or the first set of consecutive SBFD symbols among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the PUSCH repetition transmitted in the first uplink slot or the first set of consecutive uplink symbols, and the PUSCH repetition transmitted in the first SBFD slot or the first set of consecutive SBFD symbols.
As an example, the UE may consider that the PUSCH repetition transmitted in the first uplink slot or the first set of consecutive uplink symbols, and the PUSCH repetition transmitted in the first SBFD slot or the first set of consecutive SBFD symbols have the same amount of time and/or frequency resources (e.g., OFDM symbol length, number of RBs per symbol, total number of REs). That is, the UE may expect the base station to guarantee the same time and/or frequency resource amount of the PUSCH repetition transmitted in the first uplink slot or the first set of consecutive uplink symbols, and the PUSCH repetition transmitted in the first SBFD slot or the first set of consecutive SBFD symbols.
As another example, the UE may multiplex the aperiodic CSI report in the PUSCH repetition transmitted in the first uplink slot or the first set of consecutive uplink symbols, and the PUSCH repetition transmitted in the first SBFD slot or the first set of consecutive SBFD symbols only if a specific condition is satisfied, and such conditions may be a combination of at least one of the following.
When the PUSCH repetition transmitted in the first uplink slot or the first set of consecutive uplink symbols, and the PUSCH repetition transmitted in the first SBFD slot or the first set of consecutive SBFD symbols have the same OFDM symbol length
When the PUSCH repetition transmitted in the first uplink slot or the first set of consecutive uplink symbols, and the PUSCH repetition transmitted in the first SBFD slot or the first set of consecutive SBFD symbols have the same frequency resource amount
When the PUSCH repetition transmitted in the first uplink slot or the first set of consecutive uplink symbols, and the PUSCH repetition transmitted in the first SBFD slot or the first set of consecutive SBFD symbols have the same number of REs
If the specific condition is not satisfied or at least one of the two PUSCH repetitions does not occur (i.e., if all PUSCH repetitions are transmitted in an uplink slot or a set of consecutive uplink symbols, or if all PUSCH repetitions are transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on one of the PUSCH repetition transmitted in the first uplink slot or the first set of consecutive uplink symbols and the PUSCH repetition transmitted in the first SBFD slot or the first set of consecutive SBFD symbols, and in this case, one PUSCH repetition may correspond to PUSCH repetition transmitted in the first uplink slot or in the first set of consecutive uplink symbols, PUSCH repetition transmitted in the first SBFD slot or in the first set of consecutive SBFD symbols, PUSCH repetition that appears first in the time dimension among the two PUSCH repetitions, PUSCH repetition notified by higher layer signaling, MAC-CE, and L1 signaling, PUSCH repetition with a large amount of time and/or frequency resources, PUSCH repetition with a small amount of frequency resources.
In the case of PUSCH repetition type B, the UE may regard the value of nominal repetition as 2 regardless of the value of nominal repetition configured and indicated. The two transmissions may be the PUSCH repetition transmitted in the first uplink slot or the first set of consecutive uplink symbols, and the PUSCH repetition transmitted in the first SBFD slot or the first set of consecutive SBFD symbols among a plurality of indicated repetitive transmissions. In this case, the number of PUSCH repetitive transmissions may be a value configured to numberOfRepetitions, which is higher layer signaling within the entry indicated through the TDRA

### FIELD

If receiving DCI instructing an aperiodic CSI report or it is the first PUSCH transmission after receiving DCI instructing a semi-persistent CSI report,
The UE may consider that the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition. In addition, the UE may multiplex the aperiodic CSI report or semi-persistent CSI report in both the corresponding first and second actual repetitions.
As another example, the UE may multiplex the aperiodic CSI report in the first and second PUSCH repetitions only if a specific condition is satisfied, and such conditions may be a combination of at least one of the following.
When the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition
If the specific condition is not satisfied or at least one of the two PUSCH repetitions does not occur (i.e., if all PUSCH repetitions are transmitted in an uplink slot or a set of consecutive uplink symbols, or if all PUSCH repetitions are transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on the first PUSCH repetition among the first two PUSCH repetitions, the second PUSCH repetition, PUSCH repetition notified by higher layer signaling, MAC-CE, and L1 signaling, PUSCH repetition with a large amount of time and/or frequency resources, PUSCH repetition with a small amount of resources, PUSCH repetition transmitted in an uplink slot or a set of consecutive uplink symbols, or PUSCH repetition transmitted in an SBFD slot or a set of consecutive SBFD symbols.
If the PUSCH is transmitted without DCI scheduling in the next cycle after the first PUSCH is transmitted after receiving the DCI instructing a semi-persistent CSI report,
If the first nominal repetition has the same amount of time and/or frequency resources (e.g., OFDM symbol length, number of RBs per symbol, or total number of REs) as the first actual repetition, and if the second nominal repetition has the same amount of time and/or frequency resources (e.g., OFDM symbol length, number of RBs per symbol, or total number of REs) as the second actual repetition, the UE may multiplex semi-persistent CSI reports in both the first and second actual repetitions.
If the first nominal repetition has different amount of time and/or frequency resources (e.g., OFDM symbol length, number of RBs per symbol, or total number of REs) with the first actual repetition, and if the second nominal repetition has the same amount of time and/or frequency resources (e.g., OFDM symbol length, number of RBs per symbol, or total number of REs) as the second actual repetition, the UE may ignore transmission for the first actual repetition, and may multiplex the semi-persistent CSI report in the second actual repetitions.
In addition, if the first nominal repetition has the same amount of time and/or frequency resources (e.g., OFDM symbol length, number of RBs per symbol, or total number of REs) as the first actual repetition, and if the second nominal repetition has different amount of time and/or frequency resources (e.g., OFDM symbol length, number of RBs per symbol, or total number of REs) with the second actual repetition, the UE may ignore transmission for the second actual repetition, and may multiplex the semi-persistent CSI report in the first actual repetitions.
In addition, if the first nominal repetition has different amount of time and/or frequency resources (e.g., OFDM symbol length, number of RBs per symbol, or total number of REs) with the first actual repetition, if the second nominal repetition has different amount of time and/or frequency resources (e.g., OFDM symbol length, number of RBs per symbol, or total number of REs) with the second actual repetition, or if at least one of the two PUSCH repetitions does not occur (that is, when all PUSCH repetitions are transmitted in the uplink slot or set of consecutive uplink symbols, or when all PUSCH repetitions are transmitted in the SBFD slot or set of consecutive SBFD symbols), the UE may operate in a combination of at least one of [Method 2-2-1] to [Method 2-2-11]. Alternatively, the UE may multiplex an aperiodic CSI report on the first actual repetition among the PUSCH repetition transmitted in the first uplink slot or the first set of consecutive uplink symbols, and the PUSCH repetition transmitted in the first SBFD slot or the first set of consecutive SBFD symbols, the second actual repetition, actual repetition notified by higher layer signaling, MAC-CE, and L1 signaling, PUSCH repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols, and may ignore transmission for the remaining one actual repetition.
Through this, since the UE may transmit an aperiodic CSI report to the base station using two slots or a set of consecutive symbols with two different interference situations, even if the base station's reception performance is poor in either the uplink slot and the set of consecutive uplink symbols, or the SBFD slot and the set of consecutive SBFD symbols, the base station may achieve the diversity effect as the aperiodic CSI reports are repeatedly transmitted. In addition, since the UE transmits an aperiodic CSI report considering both the uplink slot or the set of consecutive uplink symbols, and the SBFD slot or the set of consecutive SBFD symbols, although multiplexing of two aperiodic CSI reports is required, the delay time until the aperiodic CSI report is transmitted to the base station may be reduced.
For [Method 2-2-6], the UE may report the UE capability for aperiodic CSI report multiplexing during the SBFD operation to the base station.
As an example, the UE and the base station may use the [Method 2-2-6]according to the UE capability report of the UE, and there may be no specific higher layer signaling that the UE may be configured from the base station for [Method 2-2-6].
As another example, the base station may configure specific higher layer signaling to the UE that means using [Method 2-2-6] according to the UE capability report of the UE. If the corresponding higher layer signaling is not configured, the UE may operate in a combination of at least one of [Method 2-2-1] to [Method 2-2-11].
[Method 2-2-7] The UE may regard the number of repetitive transmissions as 2 regardless of the indicated number of repetitive transmissions. The two transmissions may be PUSCH repetition transmitted in the first SBFD slot or the first set of consecutive SBFD symbols among a plurality of indicated repetitive transmissions, and PUSCH repetition transmitted in the second SBFD slot or the second set of consecutive SBFD symbols. (Similarly, the UE may multiplex the corresponding aperiodic CSI report in the PUSCH repetition transmitted in the first uplink slot or the first set of consecutive uplink symbols, and the PUSCH repetition transmitted in the second uplink slot or second set of consecutive uplink symbols.) The UE may perform specific operations as follows according to PUSCH repetition type A or B, which may be configured by higher layer signaling.
In the case of PUSCH repetition type A, the UE may regard the number of PUSCH repetitive transmissions as 2 regardless of the configured and indicated number of PUSCH repetitive transmissions. The two transmissions may be the PUSCH repetition transmitted in the first SBFD slot or first set of consecutive SBFD symbols, and the PUSCH repetition transmitted in the second SBFD slot or second set of consecutive SBFD symbols among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the PUSCH repetition transmitted in the first SBFD slot or first set of consecutive SBFD symbols, and the PUSCH repetition transmitted in the second SBFD slot or second set of consecutive SBFD symbols.
As an example, the UE may consider that the PUSCH repetition transmitted in the first SBFD slot or first set of consecutive SBFD symbols, and the PUSCH repetition transmitted in the second SBFD slot or second set of consecutive SBFD symbols have the same amount of time and/or frequency resources (e.g., OFDM symbol length, number of RBs per symbol, total number of REs). That is, the UE may expect the base station to guarantee the same time and/or frequency resource amount of the PUSCH repetition transmitted in the first SBFD slot or first set of consecutive SBFD symbols, and the PUSCH repetition transmitted in the second SBFD slot or second set of consecutive SBFD symbols.
As another example, the UE may multiplex the aperiodic CSI report in the PUSCH repetition transmitted in the first SBFD slot or first set of consecutive SBFD symbols, and the PUSCH repetition transmitted in the second SBFD slot or second set of consecutive SBFD symbols only if a specific condition is satisfied, and such conditions may be a combination of at least one of the following.
When the PUSCH repetition transmitted in the first SBFD slot or first set of consecutive SBFD symbols, and the PUSCH repetition transmitted in the second SBFD slot or second set of consecutive SBFD symbols have the same OFDM symbol length
When the PUSCH repetition transmitted in the first SBFD slot or first set of consecutive SBFD symbols, and the PUSCH repetition transmitted in the second SBFD slot or second set of consecutive SBFD symbols have the same frequency resource amount
When the PUSCH repetition transmitted in the first SBFD slot or first set of consecutive SBFD symbols, and the PUSCH repetition transmitted in the second SBFD slot or second set of consecutive SBFD symbols have the same number of REs
If the specific condition is not satisfied or at least one of the two PUSCH repetitions does not occur (i.e., if all PUSCH repetitions are transmitted in an uplink slot or a set of consecutive uplink symbols, or if one PUSCH repetition is transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on one of the PUSCH repetition transmitted in the first SBFD slot or the first set of consecutive SBFD symbols and the PUSCH repetition transmitted in the second SBFD slot or the second set of consecutive SBFD symbols, and in this case, one PUSCH repetition may correspond to PUSCH repetition transmitted in the first SBFD slot or in the first set of consecutive SBFD symbols, PUSCH repetition transmitted in the second SBFD slot or in the second set of consecutive SBFD symbols, PUSCH repetition that appears first in the time dimension among the two PUSCH repetitions, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
In the case of PUSCH repetition type B, the UE may regard the value of nominal repetition as 2 regardless of the value of nominal repetition configured and indicated. The two transmissions may be the PUSCH repetition transmitted in the first SBFD slot or first set of consecutive SBFD symbols, and the PUSCH repetition transmitted in the second SBFD slot or second set of consecutive SBFD symbols among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report,
The UE may consider that the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition. In addition, the UE may multiplex the aperiodic CSI report or semi-persistent CSI report in both the corresponding first and second actual repetitions.
As another example, the UE may multiplex the aperiodic CSI report in the first and second PUSCH repetitions only if a specific condition is satisfied, and such conditions may be a combination of at least one of the following.
When the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition
If the specific condition is not satisfied or at least one of the two PUSCH repetitions does not occur (i.e., if all PUSCH repetitions are transmitted in an uplink slot or a set of consecutive uplink symbols, or one PUSCH repetition is transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on the first PUSCH repetition among the first two PUSCH repetitions, the second PUSCH repetition, PUSCH repetition notified by higher layer signaling, MAC-CE, and L1 signaling, PUSCH repetition with a large amount of time and/or frequency resources, PUSCH repetition with a small amount of resources, PUSCH repetition transmitted in an uplink slot or a set of consecutive uplink symbols, or PUSCH repetition transmitted in an SBFD slot or a set of consecutive SBFD symbols.
If the PUSCH is transmitted without DCI scheduling in the next cycle after the first PUSCH is transmitted after receiving the DCI instructing a semi-persistent CSI report,
If the first nominal repetition has the same amount of time and/or frequency resources (e.g., OFDM symbol length, number of RBs per symbol, or total number of REs) as the first actual repetition, and if the second nominal repetition has the same amount of time and/or frequency resources (e.g., OFDM symbol length, number of RBs per symbol, or total number of REs) as the second actual repetition, the UE may multiplex semi-persistent CSI reports in both the first and second actual repetitions.
If the first nominal repetition has different amount of time and/or frequency resources (e.g., OFDM symbol length, number of RBs per symbol, or total number of REs) with the first actual repetition, and if the second nominal repetition has the same amount of time and/or frequency resources (e.g., OFDM symbol length, number of RBs per symbol, or total number of REs) as the second actual repetition, the UE may ignore transmission for the first actual repetition, and may multiplex the semi-persistent CSI report in the second actual repetitions.
In addition, if the first nominal repetition has the same amount of time and/or frequency resources (e.g., OFDM symbol length, number of RBs per symbol, or total number of REs) as the first actual repetition, and if the second nominal repetition has different amount of time and/or frequency resources (e.g., OFDM symbol length, number of RBs per symbol, or total number of REs) with the second actual repetition, the UE may ignore transmission for the second actual repetition, and may multiplex the semi-persistent CSI report in the first actual repetitions.
In addition, if the first nominal repetition has different amount of time and/or frequency resources (e.g., OFDM symbol length, number of RBs per symbol, or total number of REs) with the first actual repetition, if the second nominal repetition has different amount of time and/or frequency resources (e.g., OFDM symbol length, number of RBs per symbol, or total number of REs) with the second actual repetition, or if at least one of the two PUSCH repetitions does not occur (that is, when all PUSCH repetitions are transmitted in the uplink slot or set of consecutive uplink symbols, or one PUSCH repetition is transmitted in the SBFD slot or set of consecutive SBFD symbols), the UE may operate in a combination of at least one of [Method 2-2-1] to [Method 2-2-11]. Alternatively, the UE may multiplex an aperiodic CSI report on the first actual repetition among the PUSCH repetition transmitted in the first SBFD slot or first set of consecutive SBFD symbols, and the PUSCH repetition transmitted in the second SBFD slot or second set of consecutive SBFD symbols, the second actual repetition, actual repetition notified by higher layer signaling, MAC-CE, and L1 signaling, actual repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols, and may ignore transmission for the remaining one actual repetition.
Through this, the UE may transmit the aperiodic CSI report with a low delay time and reduce a time interval between two transmissions of the aperiodic CSI report by utilizing multiple SBFD slots or sets of consecutive SBFD symbols that allow the UE to have more opportunities for uplink transmission than using uplink slots, and diversity effects according to different downlink interference amounts in two SBFD slots or two sets of consecutive SBFD symbols may also be acquired. Alternatively, the UE may transmit an aperiodic CSI report to have stable reception performance by multiplexing the corresponding aperiodic CSI report on PUSCH repetition transmitted in the first uplink slot or the first set of consecutive uplink symbols, and the second uplink slot or second consecutive uplink symbols. The PUSCH repetition transmitted in the SBFD slot or set of consecutive SBFD symbols described below may be understood as a PUSCH repetition transmitted in the uplink slot and set of consecutive uplink symbols.
For [Method 2-2-7], the UE may report the UE capability for aperiodic CSI report multiplexing during the SBFD operation to the base station.
As an example, the UE and the base station may use the [Method 2-2-7]according to the UE capability report of the UE, and there may be no specific higher layer signaling that the UE may be configured from the base station for [Method 2-2-7].
As another example, the base station may configure specific higher layer signaling to the UE that means using [Method 2-2-7] according to the UE capability report of the UE. If the corresponding higher layer signaling is not configured, the UE may operate in a combination of at least one of [Method 2-2-1] to [Method 2-2-11].
[Method 2-2-8] The UE may regard the number of repetitive transmissions as 2 regardless of the indicated number of repetitive transmissions. The two transmissions may be the PUSCH repetition transmitted in the first SBFD slot or the first set of consecutive SBFD symbols, and the PUSCH repetition transmitted in the X-th SBFD slot or the X-th set of consecutive SBFD symbols notified from the base station among a plurality of indicated repetitive transmissions. (Similarly, the UE may multiplex the corresponding aperiodic CSI report in the PUSCH repetition transmitted in the first uplink slot or the first set of consecutive uplink symbols, and the PUSCH repetition transmitted in the X-th uplink slot or the X-th set of consecutive uplink symbols notified from the base station.) The X may be notified from the base station by using a combination of at least one of higher layer signaling, MAC-CE, and L1 signaling. The UE may perform specific operations as follows according to PUSCH repetition type A or B, which may be configured by higher layer signaling.
In the case of PUSCH repetition type A, the UE may regard the number of PUSCH repetitive transmissions as 2 regardless of the configured and indicated number of PUSCH repetitive transmissions. The two transmissions may be the PUSCH repetition transmitted in the first SBFD slot or first set of consecutive SBFD symbols, and the PUSCH repetition transmitted in the X-th SBFD slot or the X-th set of consecutive SBFD symbols notified from the base station among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the PUSCH repetition transmitted in the first SBFD slot or first set of consecutive SBFD symbols, and the PUSCH repetition transmitted in the X-th SBFD slot or the X-th set of consecutive SBFD symbols notified from the base station.
As an example, the UE may consider that the PUSCH repetition transmitted in the first SBFD slot or first set of consecutive SBFD symbols, and the PUSCH repetition transmitted in the X-th SBFD slot or the X-th set of consecutive SBFD symbols notified from the base station have the same amount of time and/or frequency resources (e.g., OFDM symbol length, number of RBs per symbol, total number of REs). That is, the UE may expect the base station to guarantee the same time and/or frequency resource amount of the PUSCH repetition transmitted in the first SBFD slot or first set of consecutive SBFD symbols, and the PUSCH repetition transmitted in the X-th SBFD slot or the X-th set of consecutive SBFD symbols notified from the base station.
As another example, the UE may multiplex the aperiodic CSI report in the PUSCH repetition transmitted in the first SBFD slot or first set of consecutive SBFD symbols, and the PUSCH repetition transmitted in the X-th SBFD slot or the X-th set of consecutive SBFD symbols notified from the base station only if a specific condition is satisfied, and such conditions may be a combination of at least one of the following.
When the PUSCH repetition transmitted in the first SBFD slot or first set of consecutive SBFD symbols, and the PUSCH repetition transmitted in the X-th SBFD slot or the X-th set of consecutive SBFD symbols notified from the base station have the same OFDM symbol length
When the PUSCH repetition transmitted in the first SBFD slot or first set of consecutive SBFD symbols, and the PUSCH repetition transmitted in the X-th SBFD slot or the X-th set of consecutive SBFD symbols notified from the base station have the same frequency resource amount
When the PUSCH repetition transmitted in the first SBFD slot or first set of consecutive SBFD symbols, and the PUSCH repetition transmitted in the X-th SBFD slot or the X-th set of consecutive SBFD symbols notified from the base station have the same number of REs
If the specific condition is not satisfied or at least one of the two PUSCH repetitions does not occur (i.e., if all PUSCH repetitions are transmitted in an uplink slot or a set of consecutive uplink symbols, or if one PUSCH repetition is transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on one of the PUSCH repetition transmitted in the first SBFD slot or the first set of consecutive SBFD symbols and the PUSCH repetition transmitted in the X-th SBFD slot or the X-th set of consecutive SBFD symbols notified from the base station, and in this case, one PUSCH repetition may correspond to PUSCH repetition transmitted in the first SBFD slot or in the first set of consecutive SBFD symbols, PUSCH repetition transmitted in the PUSCH repetition transmitted in the X-th SBFD slot or the X-th set of consecutive SBFD symbols notified from the base station, PUSCH repetition that appears first in the time dimension among the two PUSCH repetitions, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
In the case of PUSCH repetition type B, the UE may regard the value of nominal repetition as 2 regardless of the value of nominal repetition configured and indicated. The two transmissions may be the PUSCH repetition transmitted in the first SBFD slot or first set of consecutive SBFD symbols, and the PUSCH repetition transmitted in the X-th SBFD slot or the X-th set of consecutive SBFD symbols notified from the base station among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report,
The UE may consider that the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition. In addition, the UE may multiplex the aperiodic CSI report or semi-persistent CSI report in both the corresponding first and second actual repetitions.
As another example, the UE may multiplex the aperiodic CSI report in the first and second PUSCH repetitions only if a specific condition is satisfied, and such conditions may be a combination of at least one of the following.
When the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition
If the specific condition is not satisfied or at least one of the two PUSCH repetitions does not occur (i.e., if all PUSCH repetitions are transmitted in an uplink slot or a set of consecutive uplink symbols, or one PUSCH repetition is transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on the first PUSCH repetition among the first two PUSCH repetitions, the second PUSCH repetition, PUSCH repetition notified by higher layer signaling, MAC-CE, and L1 signaling, PUSCH repetition with a large amount of time and/or frequency resources, PUSCH repetition with a small amount of resources, PUSCH repetition transmitted in an uplink slot or a set of consecutive uplink symbols, or PUSCH repetition transmitted in an SBFD slot or a set of consecutive SBFD symbols.
If the PUSCH is transmitted without DCI scheduling in the next cycle after the first PUSCH is transmitted after receiving the DCI instructing a semi-persistent CSI report,
If the first nominal repetition has the same amount of time and/or frequency resources (e.g., OFDM symbol length, number of RBs per symbol, or total number of REs) as the first actual repetition, and if the second nominal repetition has the same amount of time and/or frequency resources (e.g., OFDM symbol length, number of RBs per symbol, or total number of REs) as the second actual repetition, the UE may multiplex semi-persistent CSI reports in both the first and second actual repetitions.
If the first nominal repetition has different amount of time and/or frequency resources (e.g., OFDM symbol length, number of RBs per symbol, or total number of REs) with the first actual repetition, and if the second nominal repetition has the same amount of time and/or frequency resources (e.g., OFDM symbol length, number of RBs per symbol, or total number of REs) as the second actual repetition, the UE may ignore transmission for the first actual repetition, and may multiplex the semi-persistent CSI report in the second actual repetitions.
In addition, if the first nominal repetition has the same amount of time and/or frequency resources (e.g., OFDM symbol length, number of RBs per symbol, or total number of REs) as the first actual repetition, and if the second nominal repetition has different amount of time and/or frequency resources (e.g., OFDM symbol length, number of RBs per symbol, or total number of REs) with the second actual repetition, the UE may ignore transmission for the second actual repetition, and may multiplex the semi-persistent CSI report in the first actual repetitions.
In addition, if the first nominal repetition has different amount of time and/or frequency resources (e.g., OFDM symbol length, number of RBs per symbol, or total number of REs) with the first actual repetition, if the second nominal repetition has different amount of time and/or frequency resources (e.g., OFDM symbol length, number of RBs per symbol, or total number of REs) with the second actual repetition, or if at least one of the two PUSCH repetitions does not occur (that is, when all PUSCH repetitions are transmitted in the uplink slot or set of consecutive uplink symbols, or one PUSCH repetition is transmitted in the SBFD slot or set of consecutive SBFD symbols), the UE may operate in a combination of at least one of [Method 2-2-1] to [Method 2-2-11]. Alternatively, the UE may multiplex an aperiodic CSI report on the first actual repetition among the PUSCH repetition transmitted in the first SBFD slot or first set of consecutive SBFD symbols, and the PUSCH repetition transmitted in the X-th SBFD slot or the X-th set of consecutive SBFD symbols notified from the base station, the second actual repetition, actual repetition notified by higher layer signaling, MAC-CE, and L1 signaling, actual repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols, and may ignore transmission for the remaining one actual repetition.
Through this, the UE may transmit the aperiodic CSI report with a low delay time and reduce a time interval between two transmissions of the aperiodic CSI report by utilizing multiple SBFD slots or sets of consecutive SBFD symbols that allow the UE to have more opportunities for uplink transmission than using uplink slots, and diversity effects according to different downlink interference amounts in two SBFD slots or two sets of consecutive SBFD symbols may also be acquired.
For [Method 2-2-8], the UE may report the UE capability for aperiodic CSI report multiplexing during the SBFD operation to the base station.
As an example, the UE and the base station may use the [Method 2-2-8]according to the UE capability report of the UE, and there may be no specific higher layer signaling that the UE may be configured from the base station for [Method 2-2-8].
As another example, the base station may configure specific higher layer signaling to the UE that means using [Method 2-2-8] according to the UE capability report of the UE. If the corresponding higher layer signaling is not configured, the UE may operate in a combination of at least one of [Method 2-2-1] to [Method 2-2-11].
[Method 2-2-9] The UE may regard the number of repetitive transmissions as 2 regardless of the indicated number of repetitive transmissions. The two transmissions may be the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station among a plurality of indicated repetitive transmissions. (Similarly, the X1-th and X2-th resources may be SBFD resources or uplink resources, respectively.) The X1 and X2 may be notified from the base station by using a combination of at least one of higher layer signaling, MAC-CE, and L1 signaling. The UE may perform specific operations as follows according to PUSCH repetition type A or B, which may be configured by higher layer signaling.
In the case of PUSCH repetition type A, the UE may regard the number of PUSCH repetitive transmissions as 2 regardless of the configured and indicated number of PUSCH repetitive transmissions. The two transmissions may be the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station.
As an example, the UE may consider that the PUSCH repetition transmitted in the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station have the same amount of time and/or frequency resources (e.g., OFDM symbol length, number of RBs per symbol, total number of REs). That is, the UE may expect the base station to guarantee the same time and/or frequency resource amount of the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station.
As another example, the UE may multiplex the aperiodic CSI report in the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station only if a specific condition is satisfied, and such conditions may be a combination of at least one of the following.
When the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station have the same OFDM symbol length
When the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station have the same frequency resource amount
When the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station have the same number of REs
If the specific condition is not satisfied or at least one of the two PUSCH repetitions does not occur (i.e., if all PUSCH repetitions are transmitted in an uplink slot or a set of consecutive uplink symbols, or if one PUSCH repetition is transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on one of the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station, and in this case, one PUSCH repetition may correspond to PUSCH repetition transmitted in the X1-th SBFD slot or the X1-th set of consecutive SBFD symbols notified from the base station, PUSCH repetition transmitted in the X2-th SBFD slot or the X2-th set of consecutive SBFD symbols notified from the base station, PUSCH repetition that appears first in the time dimension among the two PUSCH repetitions, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
In the case of PUSCH repetition type B, the UE may regard the value of nominal repetition as 2 regardless of the value of nominal repetition configured and indicated. The two transmissions may be the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report,
The UE may consider that the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition. In addition, the UE may multiplex the aperiodic CSI report or semi-persistent CSI report in both the corresponding first and second actual repetitions.
As another example, the UE may multiplex the aperiodic CSI report in the first and second PUSCH repetitions only if a specific condition is satisfied, and such conditions may be a combination of at least one of the following.
When the first nominal repetition has the same amount of time and/or frequency resources (e.g., OFDM symbol length, number of RBs per symbol, or total number of REs) as the first actual repetition, and the second nominal repetition has the same amount of time and/or frequency resources (e.g., OFDM symbol length, number of RBs per symbol, or total number of REs) as the second actual repetition
If the specific condition is not satisfied or at least one of the two PUSCH repetitions does not occur (i.e., if all PUSCH repetitions are transmitted in an uplink slot or a set of consecutive uplink symbols, or one PUSCH repetition is transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on the first actual repetition among the first two PUSCH repetitions, the second actual repetition, actual repetition notified by higher layer signaling, MAC-CE, and L1 signaling, actual repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols.
If the PUSCH is transmitted without DCI scheduling in the next cycle after the first PUSCH is transmitted after receiving the DCI instructing a semi-persistent CSI report,
If the first nominal repetition has the same amount of time and/or frequency resources (e.g., OFDM symbol length, number of RBs per symbol, or total number of REs) as the first actual repetition, and if the second nominal repetition has the same amount of time and/or frequency resources (e.g., OFDM symbol length, number of RBs per symbol, or total number of REs) as the second actual repetition, the UE may multiplex semi-persistent CSI reports in both the first and second actual repetitions.
If the first nominal repetition has different amount of time and/or frequency resources (e.g., OFDM symbol length, number of RBs per symbol, or total number of REs) with the first actual repetition, and if the second nominal repetition has the same amount of time and/or frequency resources (e.g., OFDM symbol length, number of RBs per symbol, or total number of REs) as the second actual repetition, the UE may ignore transmission for the first actual repetition, and may multiplex the semi-persistent CSI report in the second actual repetitions.
In addition, if the first nominal repetition has the same amount of time and/or frequency resources (e.g., OFDM symbol length, number of RBs per symbol, or total number of REs) as the first actual repetition, and if the second nominal repetition has different amount of time and/or frequency resources (e.g., OFDM symbol length, number of RBs per symbol, or total number of REs) with the second actual repetition, the UE may ignore transmission for the second actual repetition, and may multiplex the semi-persistent CSI report in the first actual repetitions.
In addition, if the first nominal repetition has different amount of time and/or frequency resources (e.g., OFDM symbol length, number of RBs per symbol, or total number of REs) with the first actual repetition, if the second nominal repetition has different amount of time and/or frequency resources (e.g., OFDM symbol length, number of RBs per symbol, or total number of REs) with the second actual repetition, or if at least one of the two PUSCH repetitions does not occur (that is, when all PUSCH repetitions are transmitted in the uplink slot or set of consecutive uplink symbols, or one PUSCH repetition is transmitted in the SBFD slot or set of consecutive SBFD symbols), the UE may operate in a combination of at least one of [Method 2-2-1] to [Method 2-2-11]. Alternatively, the UE may multiplex an aperiodic CSI report on the first actual repetition among the PUSCH repetition transmitted in the X1-th SBFD slot or the X1-th set of consecutive SBFD symbols notified from the base station, and the PUSCH repetition transmitted in the X2-th SBFD slot or the X2-th set of consecutive SBFD symbols notified from the base station, the second actual repetition, actual repetition notified by higher layer signaling, MAC-CE, and L1 signaling, actual repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols, and may ignore transmission for the remaining one actual repetition.

Through this, as the UE performs an aperiodic CSI report on resources indicated by the base station, there is an advantage of being able to fully control interference that may be experienced when the aperiodic CSI report is not transmitted due to insufficient processing time or when it is multiplexed in the PUSCH transmitted from random resources. However, the signaling overhead that the base station must indicate increases, and the scheduling of the base station may become complicated to ensure reception performance of the PUSCH transmitted in the X1-th and X2-th resources.
For [Method 2-2-9], the UE may report the UE capability for aperiodic CSI report multiplexing during the SBFD operation to the base station.
As an example, the UE and the base station may use the [Method 2-2-9]according to the UE capability report of the UE, and there may be no specific higher layer signaling that the UE may be configured from the base station for [Method 2-2-9].
As another example, the base station may configure specific higher layer signaling to the UE that means using [Method 2-2-9] according to the UE capability report of the UE. If the corresponding higher layer signaling is not configured, the UE may operate in a combination of at least one of [Method 2-2-1] to [Method 2-2-11].
[Method 2-2-10] The UE may regard the number of repetitive transmissions as 2 regardless of the indicated number of repetitive transmissions. The two transmissions may be two PUSCH repetitions with the same amount of time and/or frequency resources (e.g., OFDM symbol length, number of RBs per symbol, or total number of REs) among the PUSCH repetition transmitted in the N-th SBFD slot or the N-th set of consecutive SBFD symbols and the PUSCH repetition transmitted in the N-th uplink slot or the N-th set of consecutive uplink symbols among a plurality of indicated repetitive transmissions. The N may be determined by the UE itself by calculating the resource amount of the PUSCH repetition transmitted in each N-th SBFD slot or a set consecutive SBFD symbols and the PUSCH repetition transmitted in the N-th uplink slot or a set consecutive uplink symbols, and as the base station notifies the N using at least one combination of higher layer signaling, MAC-CE, and L1 signaling, the base station may ensure that the resource amount of the PUSCH repetition transmitted in the N-th SBFD slot or a set consecutive SBFD symbols and the PUSCH repetition transmitted in the N-th uplink slot or a set consecutive uplink symbols are the same. The UE may perform specific operations as follows according to PUSCH repetition type A or B, which may be configured by higher layer signaling.
In the case of PUSCH repetition type A, the UE may regard the number of PUSCH repetitive transmissions as 2 regardless of the configured and indicated number of PUSCH repetitive transmissions. The two transmissions may be two PUSCH repetitions with the same amount of time and/or frequency resources (e.g., OFDM symbol length, number of RBs per symbol, or total number of REs) among the PUSCH repetition transmitted in the N-th SBFD slot or the N-th set of consecutive SBFD symbols and the PUSCH repetition transmitted in the N-th uplink slot or the N-th set of consecutive uplink symbols among a plurality of indicated repetitive transmissions. In this case, the number of PUSCH repetitive transmissions may be a value configured to numberOfRepetitions, which is higher layer signaling within the entry indicated through the TDRA field, or, a value configured to pusch-AggregationFactor, which is higher layer signaling if numberOfRepetitions is not configured.
In the case of receiving DCI instructing an aperiodic CSI report, first PUSCH transmission after receiving DCI instructing a semi-persistent CSI report, or the PUSCH transmitted without DCI scheduling in the next cycle after receiving the DCI instructing the semi-persistent CSI report, the UE may multiplex the aperiodic CSI report or the semi-persistent CSI report in the PUSCH repetition transmitted in the N-th SBFD slot or the N-th set of consecutive SBFD symbols and the PUSCH repetition transmitted in the N-th uplink slot or the N-th set of consecutive uplink symbols.
If at least one of the two PUSCH repetitions does not occur (i.e., if all PUSCH repetitions are transmitted in an uplink slot or a set of consecutive uplink symbols, or if all PUSCH repetitions are transmitted in an SBFD slot or a set of consecutive SBFD symbols), the UE may operate in a combination of at least one of [Method 2-2-1] to [Method 2-2-11]. Alternatively, the UE may multiplex an aperiodic CSI report in the first or the second PUSCH repetition among the first two PUSCH repetitions, and may also multiplex an aperiodic CSI report in the PUSCH repetition that appears first in the time dimension among the two PUSCH repetitions, PUSCH repetition notified by higher layer signaling, MAC-CE, and L1 signaling, PUSCH repetition with a large amount of time and/or frequency resources, PUSCH repetition with a small amount of frequency resources, PUSCH repetition transmitted in an uplink slot or a set of consecutive uplink symbols, or PUSCH repetition transmitted in an SBFD slot or a set of consecutive SBFD symbols.
In the case of PUSCH repetition type B, the UE may regard the value of nominal repetition as 2 regardless of the value of nominal repetition configured and indicated. The two transmissions may be two PUSCH repetitions with the same amount of time and/or frequency resources (e.g., OFDM symbol length, number of RBs per symbol, or total number of REs) among the PUSCH repetition transmitted in the N-th SBFD slot or the N-th set of consecutive SBFD symbols and the PUSCH repetition transmitted in the N-th uplink slot or the N-th set of consecutive uplink symbols among a plurality of indicated repetitive transmissions. In this case, the number of PUSCH repetitive transmissions may be a value configured to numberOfRepetitions, which is higher layer signaling within the entry indicated through the TDRA field.
If receiving DCI instructing an aperiodic CSI report or it is the first PUSCH transmission after receiving DCI instructing a semi-persistent CSI report,
If at least one of the two PUSCH repetitions does not occur (i.e., if all PUSCH repetitions are transmitted in an uplink slot or a set of consecutive uplink symbols, or one PUSCH repetition is transmitted in an SBFD slot or a set of consecutive SBFD symbols), the UE may operate in a combination of at least one of [Method 2-2-1] to [Method 2-2-11]. Alternatively, the UE may multiplex an aperiodic CSI report on the first actual repetition among the first two PUSCH repetitions, the second actual repetition, actual repetition notified by higher layer signaling, MAC-CE, and L1 signaling, actual repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols.
If the PUSCH is transmitted without DCI scheduling in the next cycle after the first PUSCH is transmitted after receiving the DCI instructing a semi-persistent CSI report,
If the first nominal repetition has the same amount of time and/or frequency resources (e.g., OFDM symbol length, number of RBs per symbol, or total number of REs) as the first actual repetition, and if the second nominal repetition has the same amount of time and/or frequency resources (e.g., OFDM symbol length, number of RBs per symbol, or total number of REs) as the second actual repetition, the UE may multiplex semi-persistent CSI reports in both the first and second actual repetitions.
If the first nominal repetition has different amount of time and/or frequency resources (e.g., OFDM symbol length, number of RBs per symbol, or total number of REs) with the first actual repetition, and if the second nominal repetition has the same amount of time and/or frequency resources (e.g., OFDM symbol length, number of RBs per symbol, or total number of REs) as the second actual repetition, the UE may ignore transmission for the first actual repetition, and may multiplex the semi-persistent CSI report in the second actual repetitions.
In addition, if the first nominal repetition has the same amount of time and/or frequency resources (e.g., OFDM symbol length, number of RBs per symbol, or total number of REs) as the first actual repetition, and if the second nominal repetition has different amount of time and/or frequency resources (e.g., OFDM symbol length, number of RBs per symbol, or total number of REs) with the second actual repetition, the UE may ignore transmission for the second actual repetition, and may multiplex the semi-persistent CSI report in the first actual repetitions.
In addition, if the first nominal repetition has different amount of time and/or frequency resources (e.g., OFDM symbol length, number of RBs per symbol, or total number of REs) with the first actual repetition, if the second nominal repetition has different amount of time and/or frequency resources (e.g., OFDM symbol length, number of RBs per symbol, or total number of REs) with the second actual repetition, or if at least one of the two PUSCH repetitions does not occur (that is, when all PUSCH repetitions are transmitted in the uplink slot or set of consecutive uplink symbols, or one PUSCH repetition is transmitted in the SBFD slot or set of consecutive SBFD symbols), the UE may operate in a combination of at least one of [Method 2-2-1] to [Method 2-2-11]. Alternatively, the UE may multiplex an aperiodic CSI report on the first actual repetition among the first two PUSCH repetitions, the second actual repetition, actual repetition notified by higher layer signaling, MAC-CE, and L1 signaling, actual repetition with a large amount of time and/or frequency resources, actual repetition with a small amount of resources, actual repetition transmitted in an uplink slot or a set of consecutive uplink symbols, or actual repetition transmitted in an SBFD slot or a set of consecutive SBFD symbols, and may ignore transmission for the remaining one actual repetition.
Through this, the UE may have the advantage of transmitting the aperiodic CSI report twice to the base station under different interference conditions in the SBFD and uplink resources by multiplexing the aperiodic CSI report in the two PUSCH reports with the same resource amount. However, the scheduling complexity of the base station or additional calculation of the UE may be required because the resource amount comparison calculation for the PUSCH repetition transmitted in the N-th SBFD slot or a set of consecutive SBFD symbols and PUSCH repetition transmitted in the N-th uplink slot or a set of consecutive uplink symbols is performed N times in the UE, or the base station must ensure that the amount of resources between the PUSCH repetition transmitted in the N-th SBFD slot or a set of consecutive SBFD symbols and PUSCH repetition transmitted in the N-th uplink slot or a set of consecutive uplink symbols are the same.
For [Method 2-2-10], the UE may report the UE capability for aperiodic CSI report multiplexing during the SBFD operation to the base station.
As an example, the UE and the base station may use the [Method 2-2-10]according to the UE capability report of the UE, and there may be no specific higher layer signaling that the UE may be configured from the base station for [Method 2-2-10].
As another example, the base station may configure specific higher layer signaling to the UE that means using [Method 2-2-10] according to the UE capability report of the UE. If the corresponding higher layer signaling is not configured, the UE may operate in a combination of at least one of [Method 2-2-1] to [Method 2-2-11].
[Method 2-2-11] The UE may be notified by the base station through a combination of at least one of higher layer signaling, MAC-CE, and L1 signaling to use a combination of at least one of the [Method 2-2-1] to [Method 2-2-10], or at least one combination may be fixedly defined in the standard. As an example, when the UE receives SBFD configuration and resource allocation information from the base station, and when the UE receives an aperiodic CSI report instruction from the base station through DCI, the [Method 2-2-1] may be defined as a method fixed in the standard as a method of multiplexing the aperiodic CSI report. As another example, the UE may receive notification of one of [Method 2-2-1] to [Method 2-2-4] from the base station through a combination of at least one of higher layer signaling, MAC-CE, and L1 signaling. As another example, the UE may receive notification of one of [Method 2-2-1] and [Method 2-2-5] from the base station through a combination of at least one of higher layer signaling, MAC-CE, and L1 signaling. The above description may only be an example, and other combinations may not be excluded.
For [Method 2-2-11], the UE may report the UE capability for aperiodic CSI report multiplexing during the SBFD operation to the base station.
As an example, the UE and the base station may use the [Method 2-2-11]according to the UE capability report of the UE, and there may be no specific higher layer signaling that the UE may be configured from the base station for [Method 2-2-11].
As another example, the base station may configure specific higher layer signaling to the UE that means using [Method 2-2-11] according to the UE capability report of the UE. If the corresponding higher layer signaling is not configured, the UE may operate in a combination of at least one of [Method 2-2-1] to [Method 2-2-11].

### Embodiment 2-3: Aperiodic CSI Report Multiplexing Method when Scheduling Multi-PUSCH

### Condition 2-3

When the TDRA field indicated through one DCI format 0_1 or 0_2 from the base station includes multiple pieces of time resource allocation information, that is, the UE receives a plurality of PUSCHs (multi-PUSCHs) scheduled and is instructed to report aperiodic CSI through the same DCI, additional conditions may be a combination of at least one of the following.
[Condition 2-3-1] When the number of different PUSCHs scheduled is 2
[Condition 2-3-2] When the number of different PUSCHs scheduled is more than 2
[Condition 2-3-3] When the UE is configured with two SRS resource sets in which the usage is configured as codebook or non-codebook through higher layer signaling from the base station (therefore, there is an SRS resource set indicator field within the DCI), the UE receives an indication from the base station that the SRS resource set indicator in the DCI is ‘00’ or ‘01’
[Condition 2-3-4] When the UE is configured with one SRS resource set in which the usage is configured as codebook or non-codebook through higher layer signaling from the base station (therefore, there is no SRS resource set indicator field within the DCI)
[Condition 2-3-5] Conditions for multiplexed CSI in addition to aperiodic CSI report

Regarding the combination of at least one of the [Condition 2-3] and its detailed conditions [Condition 2-3-1] to [Condition 2-3-5], the UE and base station may define a multiplexing method for aperiodic CSI report or semi-persistent CSI report by considering a combination of at least one of the following methods.
If the UE receives two different PUSCH transmissions scheduled,
[Method 2-3-1] The UE may multiplex the aperiodic CSI report in the second PUSCH regardless of whether the first and second PUSCHs are transmitted in an SBFD slot or a set of consecutive SBFD symbols, or in an uplink slot or a set of consecutive uplink symbols, respectively.
Through this, the UE may use the same method as the operation in the existing TDD even if the second PUSCH is transmitted in the SBFD resource or in the uplink resource.
For [Method 2-3-1], the UE may report the UE capability for aperiodic CSI report multiplexing during the SBFD operation to the base station.
As an example, the UE and the base station may use the [Method 2-3-1]according to the UE capability report of the UE, and there may be no specific higher layer signaling that the UE may be configured from the base station for [Method 2-3-1].
As another example, the UE and the base station may use the [Method 2-3-1] even if the UE only reports the UE capability, which means that the UE may support SBFD, and there may be no individual UE capability report required by the UE for [Method 2-3-1], and/or specific higher layer signaling with that the UE may be configured from the base station.
As another example, the base station may configure specific higher layer signaling to the UE that means using [Method 2-3-1] according to the UE capability report of the UE. If the corresponding higher layer signaling is not configured, the UE may operate in a combination of at least one of [Method 2-3-1] to [Method 2-3-6].
[Method 2-3-2] If the second PUSCH is transmitted in an SBFD slot or a set of consecutive SBFD symbols, and the first PUSCH is transmitted in an uplink slot or a set of consecutive uplink symbols, the UE may multiplex the aperiodic CSI report in the first PUSCH.
Otherwise (i.e., if the first PUSCH is transmitted in the uplink slot or set of consecutive uplink symbols and the second PUSCH is transmitted in the uplink slot or set of consecutive uplink symbols, if the first PUSCH is transmitted in the SBFD slot or set of consecutive SBFD symbols and the second PUSCH is transmitted in the uplink slot or set of consecutive uplink symbols, or if both the first PUSCH and the second PUSCH are transmitted in the SBFD slot or set of consecutive SBFD symbols), the UE may multiplex the aperiodic CSI report in the second PUSCH.
Through this, the UE may avoid self-interference that may affect reception at the base station for the PUSCH transmitted in the SBFD slot or set of consecutive SBFD symbols during aperiodic CSI report.
For [Method 2-3-2], the UE may report the UE capability for aperiodic CSI report multiplexing during the SBFD operation to the base station.
As an example, the UE and the base station may use the [Method 2-3-2]according to the UE capability report of the UE, and there may be no specific higher layer signaling that the UE may be configured from the base station for [Method 2-3-2].
As another example, the base station may configure specific higher layer signaling to the UE that means using [Method 2-3-2] according to the UE capability report of the UE. If the corresponding higher layer signaling is not configured, the UE may operate in a combination of at least one of [Method 2-3-1] to [Method 2-3-6].
If the UE receives more than two different PUSCH transmissions scheduled,
[Method 2-3-3] The UE may multiplex the aperiodic CSI report in the second to last PUSCH regardless of whether all different PUSCHs are transmitted in an SBFD slot or a set of consecutive SBFD symbols, or in an uplink slot or a set of consecutive uplink symbols, respectively.
Through this, the UE may use the same method as the operation in the existing TDD even if each PUSCH is transmitted in the SBFD resource or in the uplink resource during multi-PUSCH scheduling.
For [Method 2-3-3], the UE may report the UE capability for aperiodic CSI report multiplexing during the SBFD operation to the base station.
As an example, the UE and the base station may use the [Method 2-3-3]according to the UE capability report of the UE, and there may be no specific higher layer signaling that the UE may be configured from the base station for [Method 2-3-3].
As another example, the UE and the base station may use the [Method 2-3-3] even if the UE only reports the UE capability, which means that the UE may support SBFD, and there may be no individual UE capability report required by the UE for [Method 2-3-3], and/or specific higher layer signaling with that the UE may be configured from the base station.
As another example, the base station may configure specific higher layer signaling to the UE that means using [Method 2-3-3] according to the UE capability report of the UE. If the corresponding higher layer signaling is not configured, the UE may operate in a combination of at least one of [Method 2-3-1] to [Method 2-3-6].
[Method 2-3-4] The UE may multiplex the aperiodic CSI report in the second to last PUSCH transmitted in an uplink slot or a set of consecutive uplink symbols.
Through this, the UE may avoid self-interference that may affect reception at the base station for the PUSCH transmitted in the SBFD slot or set of consecutive SBFD symbols during aperiodic CSI report.
If all multiple PUSCH transmissions are transmitted in an SBFD slot or a set of consecutive SBFD symbols, the UE may multiplex the aperiodic CSI report in the second to last PUSCH.
For [Method 2-3-4], the UE may report the UE capability for aperiodic CSI report multiplexing during the SBFD operation to the base station.
As an example, the UE and the base station may use the [Method 2-3-4]according to the UE capability report of the UE, and there may be no specific higher layer signaling that the UE may be configured from the base station for [Method 2-3-4].
As another example, the base station may configure specific higher layer signaling to the UE that means using [Method 2-3-4] according to the UE capability report of the UE. If the corresponding higher layer signaling is not configured, the UE may operate in a combination of at least one of [Method 2-3-1] to [Method 2-3-6].
[Method 2-3-5] The UE may multiplex the aperiodic CSI report in the second to last PUSCH transmitted in an uplink slot or a set of consecutive uplink symbols and the second to last PUSCH transmitted in an SBFD slot or a set of consecutive SBFD symbols. That is, the UE multiplex the aperiodic CSI report in the two PUSCHs during multi-PUSCH scheduling.
Through this, the UE may acquire diversity by transmitting aperiodic CSI reports on two PUSCHs where different interference situations exist.
In this case, the UE may multiplex the aperiodic CSI report in the two PUSCHs regardless of whether the time and/or frequency resources (e.g., OFDM symbol length, number of RBs per symbol, or total number of REs) of the two PUSCHs are the same or different.
Alternatively, the UE may multiplex the aperiodic CSI report in the two PUSCHs only when the time and/or frequency resources (e.g., OFDM symbol length, number of RBs per symbol, or total number of REs) of the two PUSCHs are the same, and otherwise, the UE may multiplex the aperiodic CSI report in the second to last PUSCH, or may also multiplex the aperiodic CSI report in the first PUSCH of the two PUSCHs, the second PUSCH, PUSCH notified by higher layer signaling, MAC-CE, and L1 signaling, PUSCH with a large amount of time and/or frequency resources, PUSCH with a small amount of frequency resources, PUSCH transmitted in an uplink slot or a set of consecutive uplink symbols, or PUSCH transmitted in an SBFD slot or a set of consecutive SBFD symbols.
If all multiple PUSCH transmissions are transmitted in the SBFD slot or set of consecutive SBFD symbols, or if all multiple PUSCH transmissions are transmitted in the uplink slot or set of consecutive SBFD symbols, the UE may multiplex the aperiodic CSI report in the second to last PUSCH, or the UE may multiplex the aperiodic CSI report in the first PUSCH of the two PUSCHs, the second PUSCH, PUSCH notified by higher layer signaling, MAC-CE, and L1 signaling, PUSCH with a large amount of time and/or frequency resources, PUSCH with a small amount of frequency resources, PUSCH transmitted in an uplink slot or a set of consecutive uplink symbols, or PUSCH transmitted in an SBFD slot or a set of consecutive SBFD symbols.
For [Method 2-3-5], the UE may report the UE capability for aperiodic CSI report multiplexing during the SBFD operation to the base station.
As an example, the UE and the base station may use the [Method 2-3-5]according to the UE capability report of the UE, and there may be no specific higher layer signaling that the UE may be configured from the base station for [Method 2-3-5].
As another example, the base station may configure specific higher layer signaling to the UE that means using [Method 2-3-5] according to the UE capability report of the UE. If the corresponding higher layer signaling is not configured, the UE may operate in a combination of at least one of [Method 2-3-1] to [Method 2-3-6].
[Method 2-3-6] The UE may be notified by the base station through a combination of at least one of higher layer signaling, MAC-CE, and L1 signaling to use a combination of at least one of the [Method 2-3-1] to [Method 2-3-5], or at least one combination may be fixedly defined in the standard. As an example, when the UE receives SBFD configuration and resource allocation information from the base station, and when the UE receives an aperiodic CSI report instruction from the base station through DCI, the [Method 2-3-1] may be defined as a method fixed in the standard as a method of multiplexing the aperiodic CSI report. As another example, the UE may receive notification of one of [Method 2-3-1] to [Method 2-3-2] from the base station through a combination of at least one of higher layer signaling, MAC-CE, and L1 signaling. As another example, the UE may receive notification of one of [Method 2-3-1] and [Method 2-3-5] from the base station through a combination of at least one of higher layer signaling, MAC-CE, and L1 signaling. The above description may only be an example, and other combinations may not be excluded.
For [Method 2-3-6], the UE may report the UE capability for aperiodic CSI report multiplexing during the SBFD operation to the base station.
As an example, the UE and the base station may use the [Method 2-3-6]according to the UE capability report of the UE, and there may be no specific higher layer signaling that the UE may be configured from the base station for [Method 2-3-6].
As another example, the base station may configure specific higher layer signaling to the UE that means using [Method 2-3-6] according to the UE capability report of the UE. If the corresponding higher layer signaling is not configured, the UE may operate in a combination of at least one of [Method 2-3-1] to [Method 2-3-6].

### Third Embodiment: Independent Beta-Offset Indication Method Considering SBFD Resource Allocation

As an embodiment of the disclosure, independent beta-offset indication methods considering SBFD resource allocation are described. This embodiment may operate in combination with other embodiments of the disclosure.

The UE may be configured with higher layer signaling, UCI-OnPUSCH, from the base station for DCI format 0_1 and 0_2, respectively (as an example, UCI-OnPUSCH to be applied to DCI format 0_1 may be configured, and UCI-OnPUSCH-DCI-0-2, a parameter to be applied to DCI format 0_2, may be configured.).

If the UE receives and uses two HARQ-ACK codebooks configured, a HARQ-ACK codebook for unicast PDSCH and a HARQ-ACK codebook for multi-cast or broadcast, the UE may be configured with a list of UCI-OnPUSCH for each DCI format 0_1 and 0_2. As an example, the UE may be configured with UCI-OnPUSCH-ListDCI-0-1 as higher layer signaling including beta offset to be applied to DCI format 01, and may be configured with UCI-OnPUSCH-ListDCI-0-2 as higher layer signaling including beta offset to be applied to DCI format 0_2.

If the UE has been notified of the SBFD configuration information from the base station to operate in the SBFD through combination of at least one of higher layer signaling, MAC-CE, and L1 signaling, the UE may operate through a combination of at least one of the following matters with respect to the signaling method for the beta-offset value applied when performing UCI multiplexing during PUSCH transmission.

### Method 3-1

The UE may apply UCI-OnPUSCH, UCI-OnPUSCH-DCI-0-2, UCI-OnPUSCH-ListDCI-0-1, and UCI-OnPUSCH-ListDCI-0-2 to the PUSCH transmitted in an uplink slot or a set of consecutive uplink symbols, and to the PUSCH transmitted in an SBFD slot or a set of consecutive uplink symbols.
For [Method 3-1], the UE may not separately be configured with higher layer signaling for the method from the base station.

### Method 3-2

The UE may apply UCI-OnPUSCH, UCI-OnPUSCH-DCI-0-2, UCI-OnPUSCH-ListDCI-0-1, and UCI-OnPUSCH-ListDCI-0-2 only to the PUSCH transmitted in an uplink slot or a set of consecutive uplink symbols, and new higher layer signaling including a beta offset to be applied to the SBFD slot or the set of consecutive SBFD symbols may be defined.
Similar to the above, as higher layer signaling including a beta offset to be applied in SBFD resources, UCI-OnPUSCH_SBFD to be applied to DCI format 0_1 and UCI-OnPUSCH_SBFD to be applied to DCI format 0_2 may be defined.
For [Method 3-2], the UE must transmit a UE capability report indicating that the UE supports [Method 3-2] to the base station, and there may be higher layer signaling at the corresponding base station to support the function, or the higher layer signaling may not exist. If the higher layer signaling exists, when the corresponding higher layer signaling is not configured by the base station, the UE may apply the beta offset value based on a combination of at least one of [Method 3-1] to [Method 3-3].

### [Method 3-3]

If the UE is configured with the UCI-OnPUSCH-ListDCI-0-1 and UCI-OnPUSCH-ListDCI-0-2 as higher layer signaling from the base station, and the UE does not receive multi-cast or broadcast-related configurations and the HARQ-ACK codebook exists only for unicast PDSCH, the UE may apply one of the two beta offset values in the UCI-OnPUSCH-ListDCI-0-1 and UCI-OnPUSCH-ListDCI-0-2 received from the base station to an uplink slot or a set of consecutive uplink symbols, and the other beta offset value may be applied to an SBFD slot or a set of consecutive SBFD symbols.
For [Method 3-3], the UE must transmit a UE capability report indicating that the UE supports [Method 3-3] to the base station, and there may be higher layer signaling at the corresponding base station to support the function, or the higher layer signaling may not exist. If the higher layer signaling exists, when the corresponding higher layer signaling is not configured by the base station, the UE may apply the beta offset value based on a combination of at least one of [Method 3-1] to [Method 3-3].

### Method 3-4

The UE may be notified by the base station through a combination of at least one of higher layer signaling, MAC-CE, and L1 signaling to use a combination of at least one of the [Method 3-1] to [Method 3-3], or at least one combination may be fixedly defined and used in the standard. As an example, the UE and base station may use the method fixedly defined in the standard for [Method 3-2]. As another example, the UE may use one of [Method 3-1] and [Method 3-3] as higher layer signaling configured.

If the UE operates in one of [Method 3-2] to [Method 3-4], the UE may define a 2^{nd} beta offset field in addition to the beta offset field that already exists in the DCI, the 2^{nd} beta offset field may be used when UCI is multiplexed in the PUSCH transmitted in an SBFD slot or a set of consecutive SBFD symbols. Each code point of the beta offset field and the 2^{nd} beta offset field may have different meanings for each DCI format 0_1 and 0_2.

If the UE operates in one of [Method 3-2] to [Method 3-4], the UE may indicate two types of beta offset information through the beta offset field that already exists in the DCI, and one of the two beta offset information may be applied when UCI is multiplexed in the PUSCH transmitted in an uplink slot or a set of consecutive uplink symbols, and the other beta offset information may be applied when UCI is multiplexed in the PUSCH transmitted in an SBFD slot or a set of consecutive SBFD symbols. In this case, the beta offset field within the DCI may maintain 2 bits as before, or may be extended up to 4 bits because the UE must indicate two types of beta offset information. Each code point that the beta offset field may include may have a different meaning for each DCI format 0_1 and 0_2.

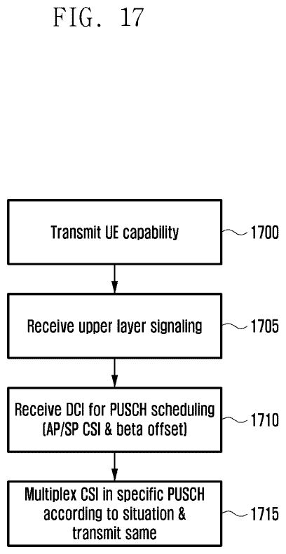

FIG. 17 illustrates an operation of a UE according to an embodiment of the disclosure.

In operation 1700, the UE may transmit UE capabilities to the base station. In this case, the UE capability signaling that may be reported may be a combination of at least one of the [Method 2-1-1] to [Method 2-1-11], [Method 2-2-1] to [Method 2-2-11], [Method 2-3-1] to [Method 2-3-6], and [Method 3-1] to [Method 3-4]. Operation 1700 may also be omitted.

In operation 1705, the UE may receive higher layer signaling from the base station according to the reported UE capabilities. In this case, the UE may define higher layer parameters for a combination of at least one of [Method 2-1-1] to [Method 2-1-11], [Method 2-2-1] to [Method 2-2-11], [Method 2-3-1] to [Method 2-3-6], and [Method 3-1] to [Method 3-4] from the base station and use one of them.

In operation 1710, the UE may receive DCI for PUSCH scheduling from the base station, trigger an aperiodic CSI report or a semi-persistent CSI report through the corresponding DCI, and/or multiple beta offset values may be indicated through the corresponding DCI.

In operation 1715, the UE may multiplex the aperiodic or semi-persistent CSI in a specific PUSCH and transmit the same to the base station. The specific PUSCH may be determined based on a combination of at least one of [Method 2-1-1] to [Method 2-1-11], [Method 2-2-1] to [Method 2-2-11], and [Method 2-3-1] to [Method 2-3-6].

The flowcharts described above illustrate exemplary methods that may be implemented in accordance with the principles of the disclosure, and various changes may be made to the methods illustrated in the flowcharts herein. For example, although illustrated as a series of operations, the various operations in each drawing may overlap, occur in parallel, occur in a different order, or occur multiple times. In other examples, operations may be omitted or replaced with other operations.

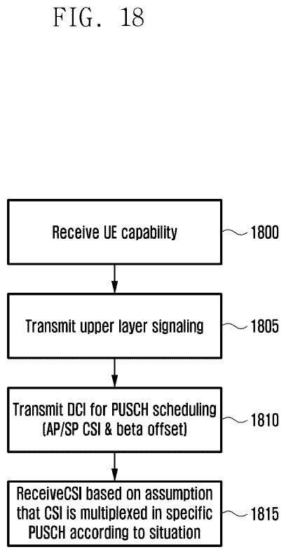

FIG. 18 illustrates an operation of a base station according to an embodiment of the disclosure.

In operation 1800, the base station may receive UE capabilities from the UE. In this case, the UE capability signaling that may be received may be a combination of at least one of the [Method 2-1-1] to [Method 2-1-11], [Method 2-2-1] to [Method 2-2-11], [Method 2-3-1] to [Method 2-3-6], and [Method 3-1] to [Method 3-4]. Operation 1800 may also be omitted.

In operation 1805, the base station may transmit higher layer signaling according to the reported UE capabilities reported by the UE. In this case, higher layer parameters for a combination of at least one of [Method 2-1-1] to [Method 2-1-11], [Method 2-2-1] to [Method 2-2-11], [Method 2-3-1] to [Method 2-3-6], and [Method 3-1] to [Method 3-4] may be defined and transmitted.

In operation 1810, the base station may transmit DCI for PUSCH scheduling to the UE. The DCI may include information that triggers aperiodic CSI report or semi-persistent CSI report to the UE, and/or multiple beta offset values may be indicated through the corresponding DCI.

In operation 1815, the base station may receive aperiodic or semi-persistent CSI multiplexed in the specific PUSCH. The specific PUSCH may be determined based on a combination of at least one of [Method 2-1-1] to [Method 2-1-11], [Method 2-2-1] to [Method 2-2-11], and [Method 2-3-1] to [Method 2-3-6].

The flowcharts described above illustrate exemplary methods that may be implemented in accordance with the principles of the disclosure, and various changes may be made to the methods illustrated in the flowcharts herein. For example, although illustrated as a series of operations, the various operations in each drawing may overlap, occur in parallel, occur in a different order, or occur multiple times. In other examples, operations may be omitted or replaced with other operations.

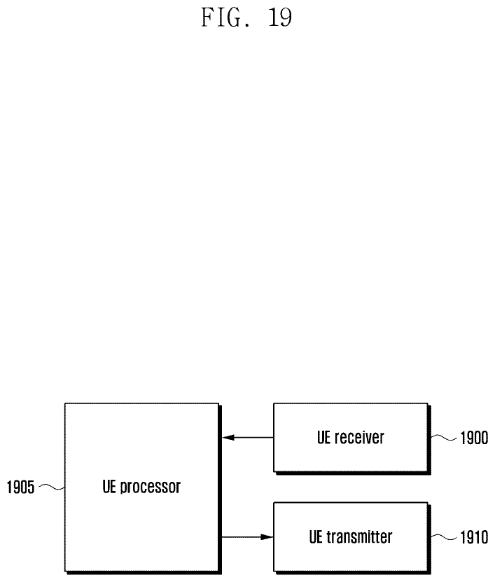

FIG. 19 illustrates a structure of a UE in a wireless communication system according to an embodiment of the disclosure.

Referring to FIG. 19, the UE may include a transceiver, which refers to a UE receiver 1900 and a UE transmitter 1910 as a whole, a memory (not illustrated), and a UE processor 1905 (or UE controller or processor). The UE transceiver 1900 and 1910, the memory, and the UE processor 1905 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

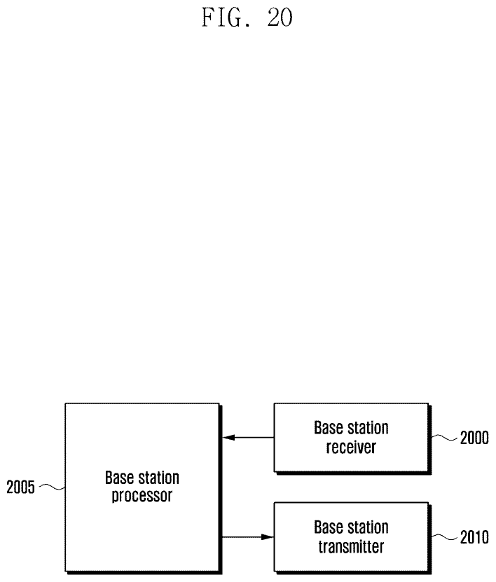

FIG. 20 illustrates a structure of a base station in a wireless communication system according to an embodiment of the disclosure.

Referring to FIG. 20, the base station may include a transceiver, which refers to a base station receiver 2000 and a base station transmitter 2010 as a whole, a memory (not illustrated), and a base station processor 2005 (or base station controller or processor). The base station transceiver 2000 and 2010, the memory, and the base station processor 2005 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, uplink subband configuration information including resource information indicating uplink resources in a downlink slot;
receiving, from the base station, physical uplink shared channel (PUSCH) configuration information including information on a PUSCH repetition;
receiving, from the base station, downlink control information (DCI) for scheduling the PUSCH repetition, the DCI including aperiodic channel state information (CSI) request indicator;
identifying two PUSCH repetitions for multiplexing aperiodic CSI; and
transmitting, to the base station, uplink data multiplexed with the aperiodic CSI on the two PUSCH repetitions on at least one of the uplink resources in the downlink slot or an uplink slot.

2. The method of claim 1, wherein a first PUSCH repetition of the two PUSCH repetitions corresponds to an earliest PUSCH repetition on the uplink resources in the downlink slot, and
wherein a second PUSCH repetition of the two PUSCH repetitions corresponds to a second earliest PUSCH repetition on the uplink resources in the downlink slot.

3. The method of claim 2, wherein the earliest PUSCH repetition and the second earliest PUSCH repetition have different orthogonal frequency division multiplexing (OFDM) symbol lengths, a different quantity of frequency resources, or a different number of resources elements (REs).

4. The method of claim 1, wherein one PUSCH repetition of the two PUSCH repetitions corresponds to a PUSCH repetition on the uplink resources in the downlink slot, and
wherein the other PUSCH repetition of the two PUSCH repetitions corresponds to a PUSCH repetition on the uplink slot.

5. The method of claim 4, wherein the PUSCH repetition on the uplink resources in the downlink slot and the PUSCH repetition on the uplink slot correspond to at least one of a same orthogonal frequency division multiplexing (OFDM)s symbol length, a same quantity of frequency resources, or a same number of resource elements (REs).

6. A method performed by a base station in a communication system, the method comprising:
transmitting, to a terminal, uplink subband configuration information including resource information indicating uplink resources in a downlink slot;
transmitting, to the terminal, physical uplink shared channel (PUSCH) configuration information including information on a PUSCH repetition;
transmitting, to the terminal, downlink control information (DCI) for scheduling the PUSCH repetition, the DCI including aperiodic channel state information (CSI) request indicator; and
receiving, from the terminal, uplink data multiplexed with aperiodic CSI on two PUSCH repetitions on at least one of the uplink resources in the downlink slot or an uplink slot.

7. The method of claim 6, wherein a first PUSCH repetition of the two PUSCH repetitions corresponds to an earliest PUSCH repetition on the uplink resources in the downlink slot, and
wherein a second PUSCH repetition of the two PUSCH repetitions corresponds to a second earliest PUSCH repetition on the uplink resources in the downlink slot.

8. The method of claim 7, wherein the earliest PUSCH repetition and the second earliest PUSCH repetition have different orthogonal frequency division multiplexing (OFDM) symbol lengths, a different quantity of frequency resources, or a different number of resources elements (REs).

9. The method of claim 6, wherein one PUSCH repetition of the two PUSCH repetitions corresponds to a PUSCH repetition on the uplink resources in the downlink slot, and
wherein the other PUSCH repetition of the two PUSCH repetitions corresponds to a PUSCH repetition on the uplink slot.

10. The method of claim 9, wherein the PUSCH repetition on the uplink resources in the downlink slot and the PUSCH repetition on the uplink slot correspond to at least one of a same orthogonal frequency division multiplexing (OFDM)s symbol length, a same quantity of frequency resources, or a same number of resource elements (REs).

11. A terminal in a communication system, the terminal comprising:
transceivers; and
a controller, including processors, configured to:
receive, from a base station, uplink subband configuration information including resource information indicating uplink resources in a downlink slot,
receive, from the base station, physical uplink shared channel (PUSCH) configuration information including information on a PUSCH repetition,
receive, from the base station, downlink control information (DCI) for scheduling the PUSCH repetition, the DCI including aperiodic channel state information (CSI) request indicator,
identify two PUSCH repetitions for multiplexing aperiodic CSI, and
transmit, to the base station, uplink data multiplexed with the aperiodic CSI on the two PUSCH repetitions on at least one of the uplink resources in the downlink slot or an uplink slot.

12. The terminal of claim 11, wherein a first PUSCH repetition of the two PUSCH repetitions corresponds to an earliest PUSCH repetition on the uplink resources in the downlink slot, and
wherein a second PUSCH repetition of the two PUSCH repetitions corresponds to a second earliest PUSCH repetition on the uplink resources in the downlink slot.

13. The terminal of claim 12, wherein the earliest PUSCH repetition and the second earliest PUSCH repetition have different orthogonal frequency division multiplexing (OFDM) symbol lengths, a different quantity of frequency resources, or a different number of resources elements (REs).

14. The terminal of claim 11, wherein one PUSCH repetition of the two PUSCH repetitions corresponds to a PUSCH repetition on the uplink resources in the downlink slot, and
wherein the other PUSCH repetition of the two PUSCH repetitions corresponds to a PUSCH repetition on the uplink slot.

15. The terminal of claim 14, wherein the PUSCH repetition on the uplink resources in the downlink slot and the PUSCH repetition on the uplink slot correspond to at least one of a same orthogonal frequency division multiplexing (OFDM)s symbol length, a same quantity of frequency resources, or a same number of resource elements (REs).

16. Abase station in a communication system, the base station comprising:
transceivers; and
a controller, including processors, configured to:
transmit, to a terminal, uplink subband configuration information including resource information indicating uplink resources in a downlink slot,
transmit, to the terminal, physical uplink shared channel (PUSCH) configuration information including information on a PUSCH repetition,
transmit, to the terminal, downlink control information (DCI) for scheduling the PUSCH repetition, the DCI including aperiodic channel state information (CSI) request indicator, and
receive, from the terminal, uplink data multiplexed with aperiodic CSI on two PUSCH repetitions on at least one of the uplink resources in the downlink slot or an uplink slot.

17. The base station of claim 16, wherein a first PUSCH repetition of the two PUSCH repetitions corresponds to an earliest PUSCH repetition on the uplink resources in the downlink slot, and
wherein a second PUSCH repetition of the two PUSCH repetitions corresponds to a second earliest PUSCH repetition on the uplink resources in the downlink slot.

18. The base station of claim 17, wherein the earliest PUSCH repetition and the second earliest PUSCH repetition have different orthogonal frequency division multiplexing (OFDM) symbol lengths, a different quantity of frequency resources, or a different number of resources elements (REs).

19. The base station of claim 16, wherein one PUSCH repetition of the two PUSCH repetitions corresponds to a PUSCH repetition on the uplink resources in the downlink slot, and
wherein the other PUSCH repetition of the two PUSCH repetitions corresponds to a PUSCH repetition on the uplink slot.

20. The base station of claim 19, wherein the PUSCH repetition on the uplink resources in the downlink slot and the PUSCH repetition on the uplink slot correspond to at least one of a same orthogonal frequency division multiplexing (OFDM)s symbol length, a same quantity of frequency resources, or a same number of resource elements (REs).
